(19) United States
(12) Patent Application Publication
(10) Pub. No.: US 2013/0215618 A1
(43) Pub. Date: Aug. 22, 2013

(54) LIGHT SOURCE

(71) Applicant: Shigeki Matsuura, Hamamatsu-shi (JP)

(72) Inventor: Shigeki Matsuura, Hamamatsu-shi (JP)

(73) Assignee: HAMAMATSU PHOTONICS K.K., Hamamatsu-shi, Shizuoka (JP)

(21) Appl. No.: 13/877,361

(22) PCT Filed: Aug. 17, 2011
(86) PCT No.: PCT/JP2011/068601

§ 371 Date: May 7, 2013

(30) Foreign Application Priority Data
Oct. 4, 2010 (JP) 2010-224850
Oct. 4, 2010 (JP) 2010-224852
Oct. 4, 2010 (JP) 2010-224853
Oct. 4, 2010 (JP) 2010-224859

(51) Int. Cl. F21V 7/04

(52) U.S. Cl. CPC F21V 7/043
USPC 362/264; 362/296.01; 362/263

(57) ABSTRACT

This light source 1 is provided with a luminescent cylinder 3A housing a luminescent part 2 to generate light; a light guide cylinder 3B connected to the luminescent cylinder 3A on a one end side, and configured to guide the light generated by the luminescent part 2, to an exit window 4 provided on the other end side; and a cylindrical reflective cylinder 9 inserted and fixed between the exit window 4 of the light guide cylinder 3B and a portion connecting the luminescent cylinder 3A and the exit window 4, and having an inner wall surface as a reflective surface 9a to reflect the light.

### TECHNICAL FIELD

The present invention relates to a light source to emit light generated inside.

### BACKGROUND ART

Research has been conducted heretofore on structures to efficiently emit light from a light source. For example, the deuterium lamp described in Patent Literature 1 below has a shield cover arranged so as to surround an anode and a cathode in a discharge container and the Patent Literature proposes a structure in which a light reflector is provided in part of the shield cover.

### CITATION LIST

### Patent Literatures

Patent Literature 1: Japanese Patent Application Laid-open No. H07-6737
Patent Literature 2: Japanese Patent Application Laid-open No. 2008-311068
Patent Literature 3: Japanese Patent Application Laid-open No. 2010-27268
Patent Literature 4: Japanese Utility Model Application Laid-open No. H05-17918
Patent Literature 5: Japanese Patent Publication No. H04-57066

### SUMMARY OF INVENTION

### Technical Problem

In the foregoing conventional deuterium lamp, however, loss of light is likely to occur between the discharge part including the anode and the cathode, and a light extraction window, resulting in insufficient extraction efficiency of light.

The present invention has been accomplished in view of this problem and it is therefore an object of the present invention to provide a light source capable of achieving stable improvement in extraction efficiency of light from an exit window.

### Solution to Problem

In order to solve the above problem, a light source according to an aspect of the present invention comprises: a first housing which houses a luminescent part to generate light; a second housing which is connected to the first housing on a one end side and configured to guide the light generated from the luminescent part, to an exit window provided on the other end side; and a cylindrical member which is inserted and fixed between the exit window of the second housing and a portion connecting the first housing and the second housing, and which has an inner wall surface formed as a reflective surface to reflect the light.

In the light source of this configuration, the light emitted from the luminescent part in the first housing is guided into the cylindrical member inserted in the second housing connected to the first housing, and is then emitted from the exit window provided in the second housing. Since the inner wall surface of the cylindrical member is formed as the reflective surface herein, the light emitted from the luminescent part is guided from the one end side to the other end side of the second housing while being totally reflected by the reflective surface inside the cylindrical member, so that the light emitted from the luminescent part can be guided to the exit window of the second housing, without loss. Since the inner wall itself of the cylindrical member is the reflective surface, it is feasible to prevent degradation of performance and generation of foreign matter due to delamination or dropout or the like of the reflective surface, thereby achieving extension of service life. This allows the extraction efficiency of the light from the exit window to be improved on a stable basis.

### Advantageous Effect of Invention

The present invention has achieved stable improvement in extraction efficiency of light from the exit window.

### BRIEF DESCRIPTION OF DRAWINGS

FIG. 1 is a sectional view showing a configuration of a light source according to the first embodiment of the present invention.

FIG. 2 is a sectional view of a reflective cylinder in FIG. 1.

FIG. 3 is a side view showing an assembling state of the reflective cylinder in the light source in FIG. 1.

FIG. 4 is a sectional view showing a configuration of a light source according to the second embodiment of the present invention.

FIG. 5(a) is a side view of a reflective cylinder in FIG. 4 and FIG. 5(b) a front view of the reflective cylinder in FIG. 4.

FIG. 6 is a sectional view showing a configuration of a light source according to the third embodiment of the present invention.

FIG. 7 is a sectional view showing a configuration of a light source according to the fourth embodiment of the present invention.

FIG. 8 is a sectional view showing a configuration of a light source according to the fifth embodiment of the present invention.

FIG. 9 is a sectional view showing a configuration of a light source according to the sixth embodiment of the present invention.

FIG. 10 is a sectional view showing a configuration of a light source according to a modification example of the present invention.

FIG. 11(a) is a side view of a reflective cylinder according to a modification example of the present invention, FIG. 11(b) an end view of the reflective cylinder in FIG. 11(a), and FIG. 11(c) a perspective view of the reflective cylinder in FIG. 11(a).

FIG. 12(a) is a side view of a reflective cylinder according to a modification example of the present invention, FIG. 12(b) an end view of the reflective cylinder in FIG. 12(a), and FIG. 12(c) a perspective view of the reflective cylinder in FIG. 12(a).

FIG. 13 is a side view showing a configuration of a light source according to a modification example of the present invention.

FIG. 14 is a sectional view showing a configuration of a deuterium lamp according to the seventh embodiment of the present invention.

FIG. 15(a) is a sectional view of a reflective cylinder in FIG. 14 and FIG. 15(b) an end view of the reflective cylinder in FIG. 14.

FIG. 16 is a side view showing an assembling state of the reflective cylinder in the deuterium lamp in FIG. 14.

FIG. 17 is a drawing showing optical paths of light components in various light emission directions from a luminescent center in the deuterium lamp in FIG. 14.

FIG. 18 is a sectional view showing a configuration of a deuterium lamp according to the eighth embodiment of the present invention.

FIG. 19(a) is a side view of a reflective cylinder in FIG. 18 and FIG. 19(b) an end view of the reflective cylinder in FIG. 18.

FIG. 20 is a sectional view showing a configuration of a deuterium lamp according to the ninth embodiment of the present invention.

FIG. 21(a) is a side view of a reflective cylinder in FIG. 20, FIG. 21(b) an end view of the reflective cylinder in FIG. 20, and FIG. 21(c) a perspective view showing a state in which the reflective cylinder in FIG. 20 is fixed to a housing case.

FIG. 22 is a sectional view showing a configuration of a deuterium lamp according to a modification example of the present invention.

FIG. 23(a) is a side view of a reflective cylinder according to a modification example of the present invention, FIG. 23(b) an end view of the reflective cylinder in FIG. 23(a), and FIG. 23(c) a perspective view of the reflective cylinder in FIG. 23(a).

FIG. 24(a) is a side view of a reflective cylinder according to a modification example of the present invention, FIG. 24(b) an end view of the reflective cylinder in FIG. 24(a), and FIG. 24(c) a perspective view of the reflective cylinder in FIG. 24(a).

FIG. 25 is a side view showing a configuration of a deuterium lamp according to a modification example of the present invention.

FIG. 26 is a sectional view showing a configuration of a deuterium lamp according to a modification example of the present invention.

FIG. 27(a) is a sectional view of a reflective cylinder in FIG. 26 and FIG. 27(b) an end view of the reflective cylinder in FIG. 26.

FIG. 28 is a side view showing an assembling state of the reflective cylinder in the deuterium lamp in FIG. 26.

FIG. 29 is a drawing showing optical paths of light components in various light emission directions from a luminescent center in a deuterium lamp according to a comparative example of the present invention.

FIG. 30 is a sectional view showing a configuration of a light source according to the tenth embodiment of the present invention.

FIG. 31(a) is a sectional view of a reflective cylinder in FIG. 30 and FIG. 31(b) an end view of the reflective cylinder in FIG. 30.

FIG. 32 is a side view showing a fixed state of the reflective cylinder to a cathode in the light source in FIG. 30.

FIG. 33 is a side view showing another fixed state of the reflective cylinder to the cathode in the light source in FIG. 30.

FIG. 34 is a drawing showing optical paths of light components in various light emission directions from a luminescent center in the light source in FIG. 30.

FIG. 35 is a sectional view showing a configuration of a light source according to the eleventh embodiment of the present invention.

FIG. 36(a) is a side view of a reflective cylinder in FIG. 35 and FIG. 36(b) an end view of the reflective cylinder in FIG. 35.

FIG. 37 is a side view showing a fixed state of the reflective cylinder to the cathode according to a modification example of the present invention.

FIG. 38 is a side view showing a fixed state of the reflective cylinder to the cathode according to a modification example of the present invention.

FIG. 39(a) is a side view of a reflective cylinder according to a modification example of the present invention, FIG. 39(b) an end view of the reflective cylinder in FIG. 39(a), and FIG. 39(c) a perspective view of the reflective cylinder in FIG. 39(a).

FIG. 40(a) is a side view of a reflective cylinder according to a modification example of the present invention, FIG. 40(b) an end view of the reflective cylinder in FIG. 40(a), and FIG. 40(c) a perspective view of the reflective cylinder in FIG. 40(a).

FIG. 41 is a sectional view showing a configuration of a light source according to a modification example of the present invention.

FIG. 42 is a perspective view of a reflective cylinder in FIG. 41.

FIG. 43 is a drawing showing optical paths of light components in various light emission directions from a luminescent center in a light source according to a comparative example of the present invention.

FIG. 44 is a sectional view showing a configuration of a light source according to the twelfth embodiment of the present invention.

FIG. 45(a) is a sectional view of a reflective cylinder in FIG. 44 and FIG. 45(b) an end view of the reflective cylinder in FIG. 44.

FIG. 46 is a side view showing an assembling state of the reflective cylinder in the light source in FIG. 44.

FIG. 47 is a sectional view showing a configuration of a light source according to the thirteenth embodiment of the present invention.

FIG. 48(a) is a side view of a reflective cylinder in FIG. 47 and FIG. 48(b) an end view of the reflective cylinder in FIG. 47.

FIG. 49 is a sectional view showing a configuration of a light source according to the fourteenth embodiment of the present invention.

FIG. 50(a) is a sectional view of a reflective cylinder according to a modification example of the present invention and FIG. 50(b) an end view of the reflective cylinder in FIG. 50(a).

FIG. 51 is a sectional view showing a configuration of a light source according to a modification example of the present invention.

FIG. 52(a) is a side view showing a part of a reflective cylinder according to a modification example of the present invention, FIG. 52(b) an end view of the reflective cylinder in FIG. 52(a), and FIG. 52(c) a perspective view of the reflective cylinder in FIG. 52(a).

FIG. 53(a) is a side view showing a part of a reflective cylinder according to a modification example of the present invention, FIG. 53(b) an end view of the reflective cylinder in FIG. 53(a), and FIG. 53(c) a perspective view of the reflective cylinder in FIG. 53(a).

FIG. 54(a) is a side view showing a part of a reflective cylinder according to a modification example of the present invention, FIG. 54(b) an end view of the reflective cylinder in FIG. 54(a), and FIG. 54(c) a perspective view of the reflective cylinder in FIG. 54(a).

FIG. 55(a) is a side view showing a part of a reflective cylinder according to a modification example of the present invention, FIG. 55(b) an end view of the reflective cylinder in FIG. 55(a), and FIG. 55(c) a perspective view of the reflective cylinder in FIG. 55(a).

FIG. 56(a) is a side view showing a part of a reflective cylinder according to a modification example of the present invention, FIG. 56(b) an end view of the reflective cylinder in FIG. 56(a), and FIG. 56(c) a perspective view of the reflective cylinder in FIG. 56(a).

### DESCRIPTION OF EMBODIMENTS

The preferred embodiments of the light source according to the present invention will be described below in detail with reference to the drawings. Identical or equivalent portions will be denoted by the same reference signs in the description of the drawings, without redundant description. Each drawing was prepared for the description and depicted so as to emphasize an object to be described, in particular.

For this reason, it should be noted that a dimensional ratio of each member in the drawings does not always agree with an actual one.

### First Embodiment

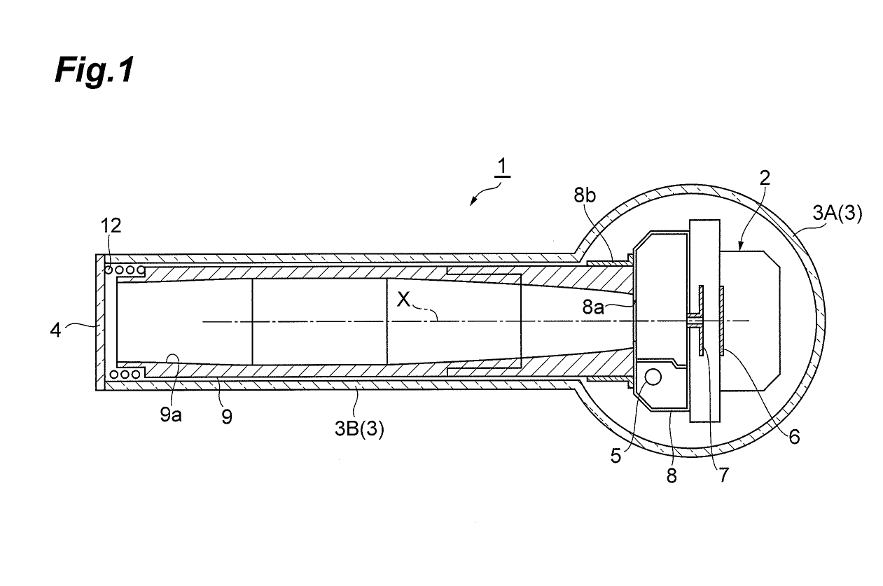

FIG. 1 is a sectional view showing a configuration of a light source according to the first embodiment of the present invention. The light source 1 shown in the same drawing is a so-called deuterium lamp used as a light source for analytical equipment such as a photoionization source of a mass spectrometer or as a light source for vacuum electricity removal.

This light source 1 is provided with a hermetic container 3 of glass in which a luminescent cylinder (first housing) 3A of a substantially cylindrical shape housing a luminescent part 2 to induce discharge of deuterium gas to generate light, is integrally connected to a light guide cylinder (second housing) 3B of a substantially cylindrical shape kept in communication with the luminescent cylinder 3A and projecting along the optical axis X of light generated by the luminescent part 2, from the side wall of the luminescent cylinder 3A. In this hermetic container 3 deuterium gas is enclosed under the pressure of about several hundred Pa. More specifically, the light guide cylinder 3B is integrated in communication with the luminescent cylinder 3A on a one end side in the direction along the optical axis X and is sealed on the other end side by an exit window 4 to emit the light generated from the luminescent part 2, to the outside. A material of this exit window 4 is, for example, MgF₂ (magnesium fluoride), LiF (lithium fluoride), silica glass, or sapphire glass.

The luminescent part 2 housed in the luminescent cylinder 3A is composed of a cathode 5, an anode 6, a discharge path limiter 7 arranged between the anode 6 and the cathode 5 and having an aperture formed in a central region, and a housing case 8 arranged so as to surround these. In a surface of this housing case 8 on the light guide cylinder 3B side, a light passage port 8a of a rectangular shape for extraction of the light generated by the luminescent part 2 is formed so as to face the exit window 4 of the light guide cylinder 3B and, a fixing ring (fixing member) 8b consisting of a wall part extending in a circular shape along the side wall of the light guide cylinder 3B is fixed so as to surround the light passage port 8a. When a voltage is applied between the cathode 5 and the anode 6, the luminescent part 2 induces ionization and discharge of the deuterium gas existing between them, to form a plasma state and the discharge path limiter 7 narrows it into a high-density plasma state, thereby to generate light (ultraviolet light), which is emitted from the light passage port 8a of the housing case 8 into the direction along the optical axis X.

The foregoing luminescent part 2 is held in the luminescent cylinder 3A by a stem pin (not shown) standing on a stem part disposed on an end face of the luminescent cylinder 3A. Namely, this light source 1 is a side-on type light source in which the optical axis X intersects with the tube axis of the luminescent cylinder 3A.

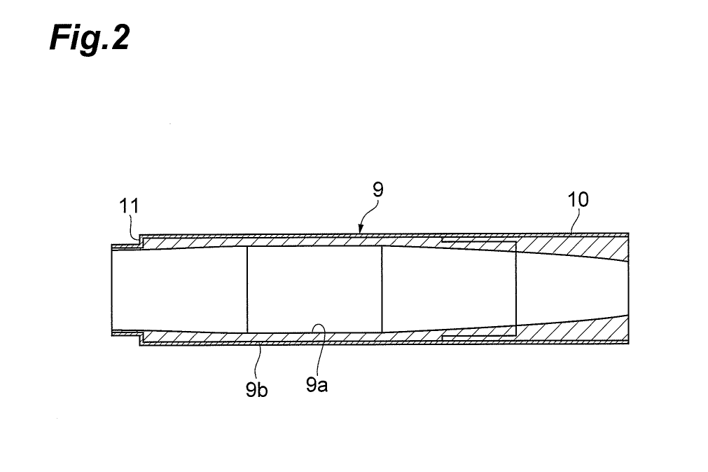

An aluminum reflective cylinder (metal member) 9 of a substantially cylindrical shape is inserted and fixed between the exit window 4 in the hermetic container 3 of this configuration and a portion connecting the luminescent cylinder 3A and the light guide cylinder 3B. This reflective cylinder 9 is, as shown in FIG. 2, a combination of metal block members of aluminum and is formed in a substantially cylindrical shape having an outside diameter smaller than an inside diameter of the light guide cylinder 3B.

An inner wall surface of the reflective cylinder 9 itself is formed as a reflective surface 9a which is a curved surface or a multistep surface with inclination angles varying stepwise, along the central axis of the reflective cylinder 9. Namely, this reflective surface 9a is formed so that the two ends of the reflective cylinder 9 in the central-axis direction are tapered so as to be able to converge the light at a desired surface or point outside the exit window 4. More specifically, the reflective surface 9a is formed as inclined with respect to the central axis of the reflective cylinder 9, i.e., with respect to the optical axis X so that the diameter of the space surrounded by the reflective surface 9a gradually decreases from a longitudinal central region of the reflective cylinder 9 toward the end on the luminescent cylinder 3A side. Furthermore, the reflective surface 9a is formed as inclined with respect to the central axis of the reflective cylinder 9 so that the diameter of the space surrounded by the reflective surface 9a gradually decreases from the longitudinal central region of the reflective cylinder 9 toward the end on the exit window 4 side. The tapered structure of the reflective surface 9a may be provided at either one of the two ends of the reflective cylinder 9 in the central-axis direction, instead of that at the two ends; for example, the reflective surface 9a may be formed in the tapered shape as described above, only on the luminescent part 2 side (one end side), while the reflective surface 9a is formed in parallel to the central axis of the reflective cylinder 9 on the exit window 4 side (the other end side). This reflective surface 9a is set so as to be able to converge the light at the desired surface or point or diverge the light. This reflective surface 9a is processed in a mirror surface state capable of regularly reflecting the light generated by the luminescent part 2 and is formed, for example, by cutting the metal block members, polishing an inner wall thereof by a polishing method such as buffing, chemical polishing, electropolishing, or a derivative thereof, or by a polishing method as a complex thereof, and thereafter subjecting the surface to a washing treatment or a vacuum treatment or the like to remove an impurity gas component. In the present embodiment the reflective cylinder 9 is composed of a combination of two members and, when the reflective surface 9a is formed of a plurality of metal block members as in this configuration, a ratio of length and inside diameter (aspect ratio) of each metal block member can be set smaller, so as to facilitate achievement of desired flatness during processing and shaping, thereby enhancing mirror accuracy of the reflective surface 9a.

Furthermore, a thermal radiation film 10 containing a material with high thermal emissivity is formed over almost the entire area of an outer wall surface 9b of the reflective cylinder 9. The material of this thermal radiation film 10 to be used is one with the thermal emissivity higher than that of the material of the reflective cylinder 9, e.g., aluminum oxide. The thermal radiation film 10 herein is formed over almost the entire surface of the reflective cylinder 9, but it may be formed in part of the outer wall surface 9b of the reflective cylinder 9 on the one end side. The thermal radiation film 10 is formed, for example, by depositing the material forming the thermal radiation film 10, on the outer wall surface 9b of the reflective cylinder 9 by evaporation, coating, or the like, but, particularly, in the case where the reflective cylinder 9 is made of aluminum as in the present embodiment, a layer of aluminum oxide as the thermal radiation film 10 may be formed by oxidizing the outer wall surface 9b of the reflective cylinder 9.

A cut portion 11 cut in a circular shape so as to form a stepped projection is formed along the outer wall surface 9b, in a peripheral edge region on the longitudinal other end side of the outer wall surface 9b of the reflective cylinder 9. This cut portion 11 is provided for positioning the reflective cylinder 9 in the hermetic container 3.

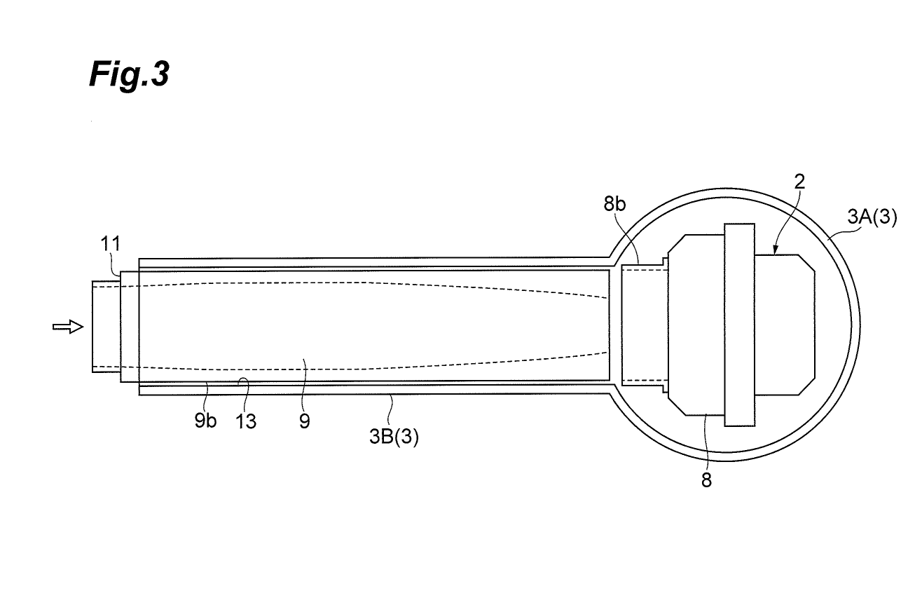

The reflective cylinder 9 of this configuration is inserted along the tube axis (optical axis X) of the light guide cylinder 3B from the edge region opposite to the edge region with the cut portion 11 therein until the edge region comes into contact with the housing case 8 of the luminescent part 2 and, after a spring member 12 is attached along the outer wall surface 9b to the cut portion 11, the light guide cylinder 3B is sealed by the exit window 4 (FIG. 1 and FIG. 3). At this time, the reflective cylinder 9 is fitted into the fixing ring 8b of the housing case 8 in a state in which the outer wall surface 9b thereof is separated from the inner wall surface 13 of the light guide cylinder 3B (FIG. 3). This spring member 12 is a member for positioning of the reflective cylinder 9, which is comprised of a metal member, e.g., stainless steel or an Inconel material with high thermal resistance, and which is arranged between the cut portion 11 and the exit window 4, with a function to urge the reflective cylinder 9 from the exit window 4 side toward the luminescent part 2 along the optical axis X, thereby to press the reflective cylinder 9 against the housing case 8. By this, the reflective cylinder 9 is positioned in the direction along the optical axis X and in the direction perpendicular to the optical axis X, in a state in which the reflective cylinder 9 is separated from the light guide cylinder 3B between the exit window 4 and the luminescent part 2 in the hermetic container 3 and located in close proximity to the luminescent part 2.

In the light source 1 described above, the light emitted from the luminescent part 2 in the luminescent cylinder 3A is guided to the interior of the cylindrical reflective cylinder 9 inserted in the light guide cylinder 3B connected to the luminescent cylinder 3A, thereby to be emitted from the exit window 4 provided in the light guide cylinder 3B. Since the inner wall surface of the reflective cylinder 9 is formed as the reflective surface 9a herein, the light emitted from the luminescent part 2 is guided from the one end side to the other end side of the light guide cylinder 3B while being totally reflected by the reflective surface 9a inside the reflective cylinder 9, so that the light emitted from the luminescent part 2 can be guided to the exit window 4 of the light guide cylinder 3B, without loss. At this time, by properly setting the inclination angles of the reflective surface 9a, the output light outside the exit window 4 can be distributed as any of parallel light, diverging light, and converging light and uniformity of light intensity can be enhanced on a predetermined illumination target surface. In conjunction therewith, the efficiency of extraction of the light from the exit window 4 improves, so as to increase a total light amount of the output light and a light amount on the illumination target surface. In the case of the conventional deuterium lamps, a light radiation pattern from the exit window tends to vary according to the distance from the exit window to cause an omission where radiant light is weak, whereas the light source 1 achieves reduction in occurrence of such an omission of the light radiation pattern. Since the reflective cylinder 9 itself is comprised of the metal members of aluminum blocks or the like, for example, unlike the case where a reflective film of metal or the like is formed inside the reflective cylinder 9, it is feasible to prevent degradation of performance and generation of foreign matter due to delamination or dropout or the like of the reflective surface 9a caused by a difference between coefficients of expansion of the constituent materials with repetitions of increase and decrease of temperature, and thereby to achieve extension of service life. Since it becomes easier to process the reflective surface with high mirror accuracy, the generated light can be effectively converged and, in addition, the generated ultraviolet light is not transmitted, so as not to cause deterioration due to the ultraviolet light, thereby achieving more efficient extraction of the generated light.

Furthermore, since the outer wall surface 9b of the reflective cylinder 9 is separated from the inner wall surface 13 of the light guide cylinder 3B, it is feasible to prevent positional deviation of the reflective cylinder 9 and breakage of the reflective cylinder 9 or the light guide cylinder 3B, because of a difference of coefficients of thermal expansion between the reflective cylinder 9 and the light guide cylinder 3B.

Since the two ends of the reflective surface 9a of the reflective cylinder 9 are formed in the taper shape, angles of reflection of light on the reflective surface 9a become large, so as to reduce the number of reflections, which can ensure stable improvement in extraction efficiency of light from the exit window 4.

Since the reflective cylinder 9 is urged by the spring member 12 as the positioning member of the metal member to be fitted into the fixing ring 8b of the housing case 8 so as to be positioned in the hermetic container 3, it is not deteriorated by the generated ultraviolet light, whereby the position of the reflective cylinder 9 is kept stable relative to the hermetic container 3, so as to maintain the extraction efficiency of light from the exit window 4. By adopting the structure to push the reflective cylinder against the housing case 8 by the spring member 12, it is feasible to stably fix the reflective cylinder 9 relative to the hermetic container 3 and to absorb positional deviation thereof relative to the luminescent cylinder 3A by the spring member 12 even with occurrence of thermal expansion along the central-axis direction of the reflective cylinder 9.

Furthermore, since the thermal radiation film 10 is formed over almost the entire area of the outer wall surface 9b of the reflective cylinder 9, a region at lower temperature than the surroundings and the enclosed gas can be formed on the inner surface of the reflective cylinder 9, and the lower-temperature region can capture the foreign matter such as sputtered substance from the luminescent cylinder 3A, so as to prevent the foreign matter from diffusing and attaching to the exit window 4 and prevent reduction of optical transmittance caused thereby. In the case where the thermal radiation film 10 is formed in part of the outer wall surface 9b near the luminescent cylinder 3A, the thermal emissivity on the one end side of the outer wall surface 9b becomes larger than that on the other end side of the outer wall surface 9b, and as a result, the sputtered substance becomes likely to be deposited at positions away from the exit window 4, which reduces contamination of the exit window 4.

When the light source 1 of this configuration is applied as a photoionization source to a mass spectrometer (MS) such as a gas chromatography mass spectrometer (GC/MS) or a liquid chromatography mass spectrometer (LC/MS), it ensures enhancement of converging performance and increase of light amount, which eliminates a need for locating the window of the light source 1 close to a sample discharge port, reducing the following demerits. Namely, if there is no optical system in the light source, the position of the window will need to be set closer to the sample discharge port in order to improve sensitivity, and high sample temperature can cause such demerits as adverse effect on a sealant of the window material and infeasibility of proximity arrangement. If the position of the window is set closer to the sample discharge port, the window material and an optical system installed in close proximity thereto outside the window of the light source can be contaminated with a sample and/or a solvent, so as to result in degradation of measurement sensitivity.

### Second Embodiment

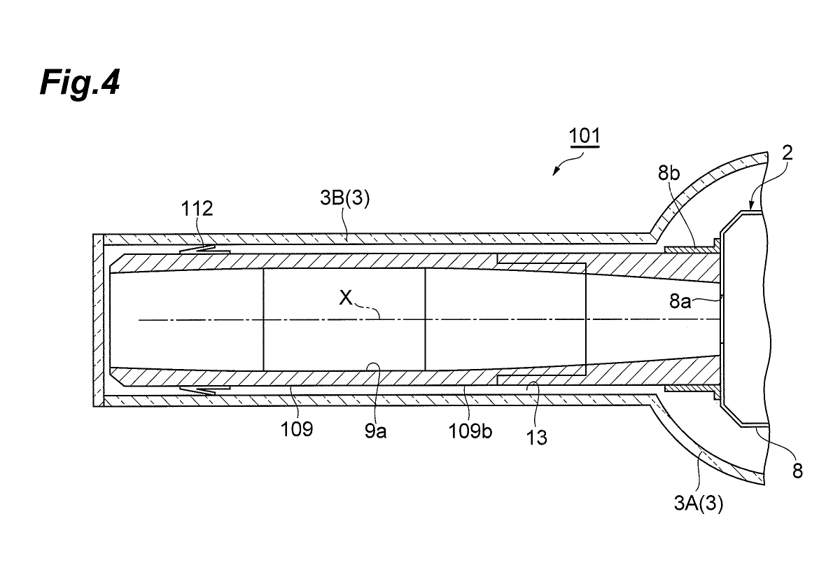

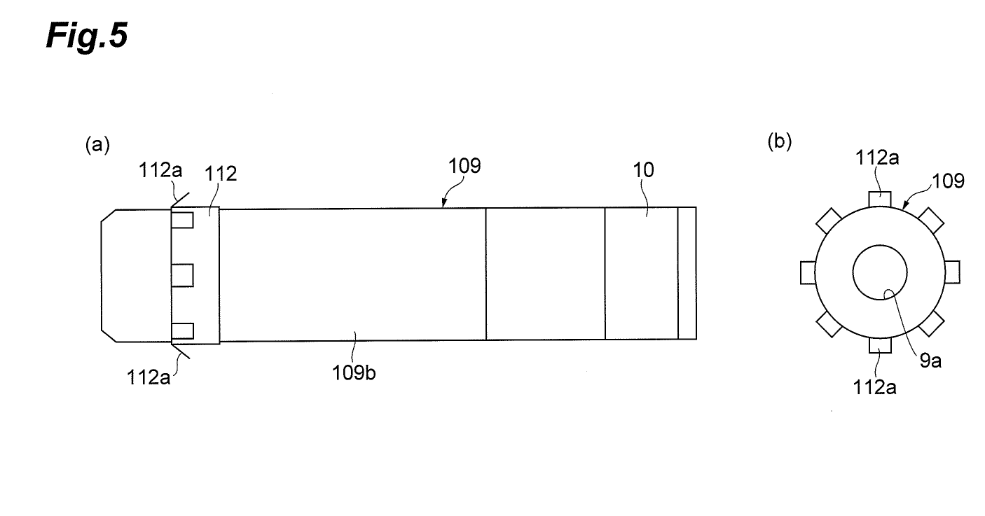

FIG. 4 is a sectional view showing a configuration of a light source according to the second embodiment of the present invention, FIG. 5(a) a side view of a reflective cylinder in FIG. 4, and FIG. 5(b) a front view of the reflective cylinder in FIG. 4. The light source 101 shown in the same drawings is different in the positioning structure of the reflective cylinder 9 from that in the first embodiment.

Specifically, a metal band 112 as a positioning member is fixed to the reflective cylinder 109 set inside the light source 101, at an end of its outer wall surface 109b on the exit window 4 side. In this metal band 112, a plurality of claws 112a with spring action are formed along the outer periphery of the reflective cylinder 109, and the metal band 112 is welded at its end by lap welding to be fixed on the outer wall surface 109b. The reflective cylinder 109 of this configuration is inserted into the hermetic container 3 along the inner wall surface 13 of the light guide cylinder 3B and is fixed so that the outer wall surface 109b is separated from the inner wall surface 13 except for the metal band 112. By this structure, the reflective cylinder 109 is urged at its end against the fixing ring 8b of the housing case 8 by spring forces of the claws 112a of the metal band 112, to be positioned in the direction along the optical axis X in the hermetic container 3. In conjunction therewith, the reflective cylinder 109 is also positioned in the directions perpendicular to the optical axis X in a state in which the outer wall surface 109b thereof and the inner wall surface 13 of the light guide cylinder 3B are separated from each other at a fixed distance, by the claws 112a of the metal band 112. If a groove is formed in the width of the metal band in the region of the reflective cylinder 109 where the metal band 112 is mounted, the distance from the metal band 112 to the inner wall surface 13 of the light guide cylinder 3B can be set larger without increase in the inside diameter of the light guide cylinder 3B and angles of the claws 112a can be increased, with the result of increase in the spring forces of the claws 112a.

The light source 101 of this configuration can also prevent the positional deviation of the reflective cylinder 109 and the breakage of the reflective cylinder 109 or the light guide cylinder 3B because of the difference of coefficients of thermal expansion between the reflective cylinder 109 and the light guide cylinder 3B. Since the reflective cylinder 109 is urged into the fixing ring 8b of the housing case 8 by the metal band 112 as the positioning member to be positioned in the hermetic container 3, it is feasible to stabilize the position of the reflective cylinder 109 relative to the hermetic container 3 and ensure sufficient extraction efficiency of light from the exit window 4.

### Third Embodiment

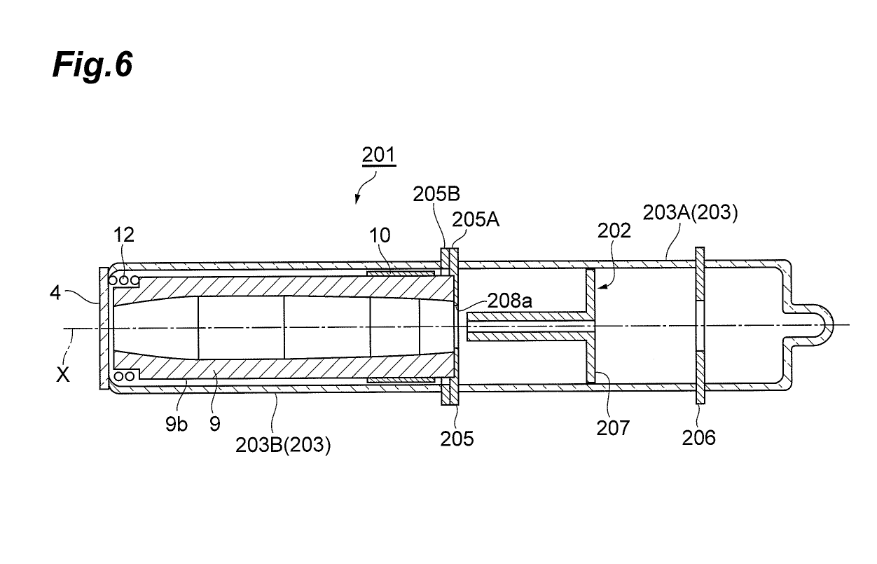

FIG. 6 is a sectional view showing a configuration of a light source according to the third embodiment of the present invention. The light source 201 shown in the same drawing is an example of application of the present invention to a capillary discharge tube.

The light source 201 is provided with a hermetic container 203 in which a luminescent cylinder 203A and a light guide cylinder 203B are connected. Enclosed in this luminescent cylinder 203A is a luminescent part 202 composed of a cathode 205, an anode 206, and a capillary 207 arranged between the anode 206 and the cathode 205. A gas such as hydrogen (H₂), xenon (Xe), argon (Ar), or krypton (Kr) is enclosed in the hermetic container 203. When a voltage is applied between the cathode 205 and the anode 206, the luminescent part 202 of this configuration induces ionization and discharge of the gas existing between them, and resultant electrons are converged in the capillary 207 to form a plasma state, whereby light is emitted along the optical axis X toward the light guide cylinder 203B. For example, in the case where the enclosed gas is Kr and the material of the exit window 4 used is MgF₂, the light can be emitted at the wavelength of 117/122 nm; in the case where the enclosed gas is Ar and the material of the exit window 4 used is LiF, the light can be emitted at the wavelength of 105 nm.

This cathode 205 also functions as a connection member arranged at the part to separate the luminescent cylinder 203A and the light guide cylinder 203B from each other. Particularly, the cathode 205 has a light passage port 208a of a circular shape provided for extraction of light generated by the luminescent part 202, and consists of a double structure of a fixing ring member 205A serving as a fixing member for positioning of the reflective cylinder 9 inserted so that the outer wall surface 9b thereof is separated from the inner wall surface of the light guide cylinder 203B, and a ring member 205B joined to the light guide cylinder 203B and the ring member 205A. Another member may be attached as a member for positioning of the reflective cylinder 9, to the cathode 205.

For incorporating the reflective cylinder 9 into the hermetic container 203 of the light source 201 as described above, the fixing ring member 205A and the ring member 205B of the cathode 205 are bonded by sealing to the luminescent cylinder 203A and to the light guide cylinder 203B, respectively. Then the reflective cylinder 9 is inserted so as to be separated from the inner wall surface of the light guide cylinder 203B while being fitted into a step portion of the fixing ring member 205A, and thereafter the fixing ring member 205A and the ring member 205B are stacked and vacuum-welded to be assembled. Another available assembly method is such that after the reflective cylinder 9 is welded and fixed to the cathode 205, the light guide cylinder 203B is joined in a vacuum-retainable state to the cathode 205.

The light source 201 of this configuration can also prevent the positional deviation of the reflective cylinder 9 and the breakage of the reflective cylinder 9 or the light guide cylinder 203B, because of the difference of coefficients of thermal expansion between the reflective cylinder 9 and the light guide cylinder 203B. Since the reflective cylinder 9 is urged into the fixing ring member 205A of the cathode 205 by the spring member 12 as the positioning member to be positioned in the hermetic container 203, it is feasible to stabilize the position of the reflective cylinder 9 relative to the hermetic container 203 and ensure sufficient extraction efficiency of light from the exit window 4 on a stable basis.

Since the thermal radiation film 10 is formed on the outer wall surface 9b on the one end side near the luminescent cylinder 203A, in the reflective cylinder 9, a portion at lower temperature than the surroundings and the enclosed gas can be formed inside the reflective cylinder 9 in close proximity to the luminescent part 202 and the lower-temperature portion can capture the foreign matter such as the sputtered substance from the luminescent cylinder 203A, so as to prevent the diffusion of the foreign matter to the exit window 4 and the reduction of optical transmittance caused thereby.

### Fourth Embodiment

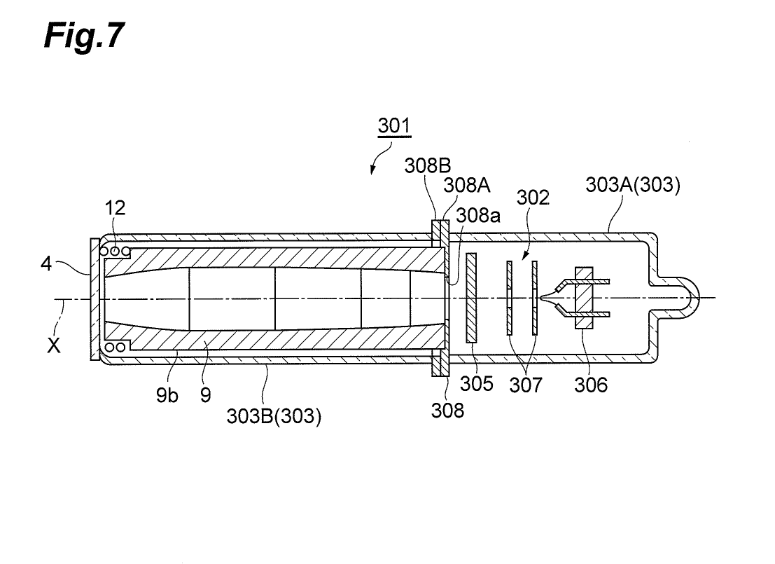

FIG. 7 is a sectional view showing a configuration of a light source according to the fourth embodiment of the present invention. The light source 301 shown in the same drawing is an example of application of the present invention to an electron excitation light source.

The light source 301 is provided with a hermetic container 303 in which a luminescent cylinder 303A and a light guide cylinder 303B are connected, and the interior thereof is maintained in high vacuum. Enclosed in this luminescent cylinder 303A is a luminescent part 302 composed of a solid-state luminescent target 305 having a crystal thin film such as AlGaN, an electron gun 306, and an electron lens part 307 arranged between the solid-state luminescent target 305 and the electron gun 306. In the luminescent part 302 of this configuration, an electron current created by the electron gun 306 is controlled by the electron lens part 307 to be accelerated toward the solid-state luminescent target 305 and then collided therewith. By this, the luminescent part 302 can emit light in the direction along the optical axis X toward the light guide cylinder 203B. For example, in the case where AlGaN is used as a crystal thin film material of the solid-state luminescent target 305, the light can be emitted in the wavelength region of about 200 to 300 nm.

The luminescent cylinder 303A and the light guide cylinder 303B forming the hermetic container 203 are coupled by a sealing ring member 308 with electrical conductivity and contact portions of the sealing ring member 308 with the luminescent cylinder 303A and the light guide cylinder 303B are joined in a vacuum-retainable state. This sealing ring member 308 has a light passage port 308a of a circular shape formed for extraction of light generated by the luminescent part 302 and consists of a double structure of a fixing ring member 308A as a fixing member for positioning of the reflective cylinder 9 inserted so that the outer wall surface 9b thereof is separated from the inner wall surface of the light guide cylinder 303B, and a ring member 308B joined to the light guide cylinder 303B and to the fixing ring member 308A. Another member may be attached as a member for positioning of the reflective cylinder 9, to the sealing ring member 308. The solid-state luminescent target 305 is kept in contact with and fixed to the fixing ring member 308A of this sealing ring member 308 and a potential is applied from the outside to the fixing ring member 308A to set the potential of the solid-state luminescent target 305. Since the solid-state luminescent target 305 is kept in contact with and fixed to the fixing ring member 308A, heat generated with incidence of electrons can be dissipated to the outside from the sealing ring member 308 and the reflective cylinder 9, so as to improve luminescent efficiency and device life. The potential of the solid-state luminescent target 305 may be set by another electrode which is separately provided.

The light source 301 of this configuration can also prevent the positional deviation of the reflective cylinder 9 and the breakage of the reflective cylinder 9 or the light guide cylinder 303B, because of the difference of coefficients of thermal expansion between the reflective cylinder 9 and the light guide cylinder 303B. Since the reflective cylinder 9 is urged into a step portion of the fixing ring member 308A of the sealing ring member 308 by the spring member 12 as the positioning member to be positioned in the hermetic container 303, it is feasible to stabilize the position of the reflective cylinder 9 relative to the hermetic container 303 and ensure sufficient extraction efficiency of light from the exit window 4 on a stable basis.

### Fifth Embodiment

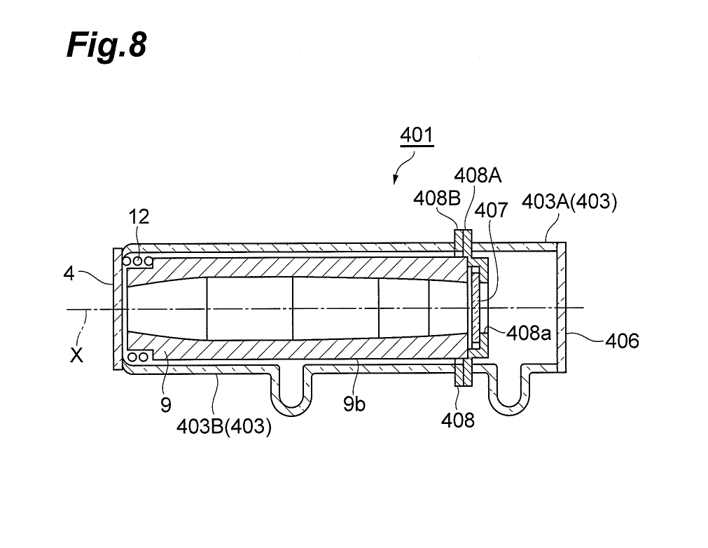

FIG. 8 is a sectional view showing a configuration of a light source according to the fifth embodiment of the present invention. The light source 401 shown in the same drawing is an example of application of the present invention to a laser excitation light source.

The light source 401 is provided with a hermetic container 403 in which a luminescent cylinder 403A and a light guide cylinder 403B are bonded as sealed with a bulkhead in between, a rare gas is enclosed inside the luminescent cylinder 403A, and an inert gas is enclosed inside the light guide cylinder 403B or the interior of the light guide cylinder 403B is kept in vacuum. An entrance window 406 is bonded as sealed to this luminescent cylinder 403A on the side opposite to the light guide cylinder 403B and the bulkhead on the light guide cylinder 403B side is provided with an exit window 407. The luminescent cylinder 403A itself with the entrance window 406 and the exit window 407 constitutes a luminescent part. Specifically, when a laser beam is injected from a laser light source not shown, along the optical axis X into the entrance window 406 of the luminescent cylinder 403A as described above, light is excited by the rare gas inside and the light is emitted along the optical axis X from the exit window 407. For example, in the case where the rare gas used is Xe and the injected beam is a third harmonic (355 nm) of Nd:YAG laser, the light can be emitted at the wavelength of 118 nm by third harmonic generation of Xe.

The bulkhead between the luminescent cylinder 403A and the light guide cylinder 403B is composed of a sealing ring member 408 and contact portions of the sealing ring member 408 with the luminescent cylinder 403A and the light guide cylinder 403B are joined in a vacuum-retainable state. This sealing ring member 408 has a light passage port 408a of a circular shape formed for extraction of the light generated in the luminescent cylinder 403A, through the exit window 407, and consists of a double structure of a fixing ring member 408A serving as a fixing member for positioning of the reflective cylinder 9 inserted so that the outer wall surface 9b thereof is separated from the inner wall surface of the light guide cylinder 403B, and a ring member 408B joined to the light guide cylinder 403B and to the fixing ring member 408A. Another member may be attached as a member for positioning of the reflective cylinder 9, to the sealing ring member 408.

The light source 401 of this configuration can also prevent the positional deviation of the reflective cylinder 9 and the breakage of the reflective cylinder 9 or the light guide cylinder 403B, because of the difference of coefficients of thermal expansion between the reflective cylinder 9 and the light guide cylinder 403B. Since the reflective cylinder 9 is urged into a step portion of the fixing ring member 408A of the sealing ring member 408 by the spring member 12 as the positioning member to be positioned in the hermetic container 403, it is feasible to stabilize the position of the reflective cylinder 9 relative to the hermetic container 403 and ensure sufficient extraction efficiency of light from the exit window 4 on a stable basis.

The structure of the light source 401 can dissipate heat generated by laser beam excitation to the outside from the sealing ring member 408 and the reflective cylinder 9, so as to improve the luminescent efficiency and device life.

The luminescent cylinder 403A may be constructed without the exit window 407 so as to keep the luminescent cylinder 403A and the light guide cylinder 403B at the same gas pressure.

### Sixth Embodiment

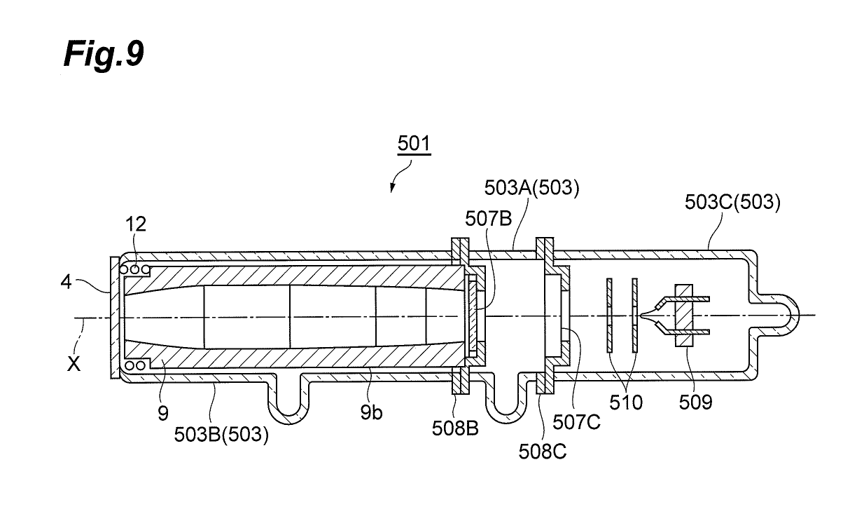

FIG. 9 is a sectional view showing a configuration of a light source according to the sixth embodiment of the present invention. The light source 501 shown in the same drawing, when compared to the fifth embodiment, is an example of application of the present invention to an electron excitation gas light source configured to excite the rare gas with electrons instead of the laser beam, so as to generate light.

The light source 501 is provided with a hermetic container 503 in which a light guide cylinder 503B and an electron generation cylinder 503C are connected to the two ends of a luminescent cylinder 503A. This luminescent cylinder 503A is bonded as sealed to the light guide cylinder 503B in which the reflective cylinder 9 is inserted and fixed so that the outer wall surface 9b of the reflective cylinder 9 is separated from an inner wall surface of the light guide cylinder 503B, through a sealing ring member 508B as a bulkhead, and is bonded as sealed to the electron generation cylinder 503C through a sealing ring member 508C as a bulkhead. A rare gas is enclosed inside the luminescent cylinder 503A, an inert gas is enclosed inside the light guide cylinder 503B or the interior thereof is kept in vacuum, and the interior of the electron generation cylinder 503C is kept in vacuum. This sealing ring member 508C is provided with an electron transmission window 507C made of a material with electron transmitting nature such as Si or SiN, and the sealing ring member 508B is provided with an exit window 507B. The structure of the sealing ring member 508B is the same as that of the sealing ring member 408 according to the fifth embodiment.

Enclosed inside the electron generation cylinder 503 forming a part of the hermetic container 503 is an electron gun 509 and an electron lens part 510 arranged between the electron transmission window 507C and the electron gun 306. In the electron generation cylinder 503 of this configuration, an electron current created by the electron gun 509 can be controlled by the electron lens part 510 to be accelerated along the optical axis X toward the electron transmission window 507C. When the electron current is then injected along the optical axis X into the luminescent cylinder 503A, light is excited by the rare gas inside, and the light is emitted along the optical axis X from the exit window 507B to be guided into the light guide cylinder 503B.

The light source 501 of this configuration can also prevent the positional deviation of the reflective cylinder 9 and the breakage of the reflective cylinder 9 or the light guide cylinder 503B, because of the difference of coefficients of thermal expansion between the reflective cylinder 9 and the light guide cylinder 503B. Since the reflective cylinder 9 is urged into a step portion of the sealing ring member 508B by the spring member 12 as the positioning member to be positioned in the hermetic container 503, it is feasible to stabilize the position of the reflective cylinder 9 relative to the hermetic container 503 and ensure sufficient extraction efficiency of light from the exit window 4 on a stable basis.

The structure of the light source 501 can dissipate heat generated by electron excitation, to the outside from the sealing ring member 508B and the reflective cylinder 9, so as to improve the luminescent efficiency and device life.

The luminescent cylinder 503A may be constructed without the exit window 507B so as to keep the luminescent cylinder 503A and the light guide cylinder 503B at the same gas pressure.

The present invention does not have to be limited to the above-described embodiments. For example, the foregoing embodiments showed the configuration wherein the reflective cylinder 9 was fixed as pressed against the positioning member disposed on the luminescent cylinder 3A, 203A, 303A, 403A, or 503A side, but it may be fixed directly to the positioning member by laser welding or the like.

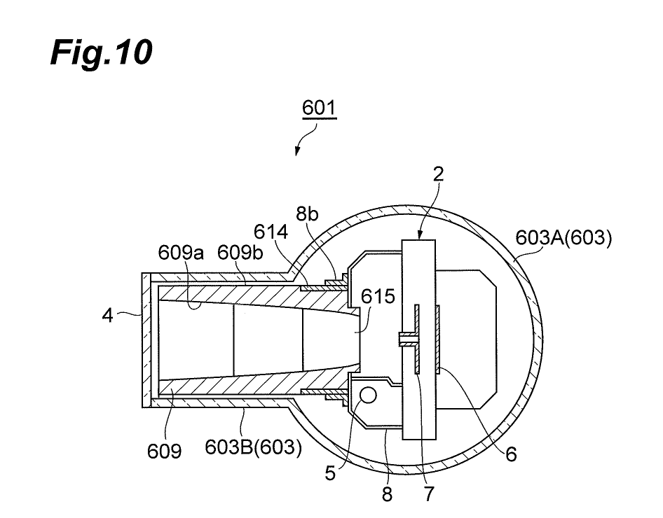

FIG. 10 shows a structure in which a reflective cylinder 609 is fixed to the housing case 8 of the luminescent part 2 by laser welding or spot welding, as light source 601 which is a modification example of the present invention. Particularly, a stainless steel ring 614 is fixed to an end of an external wall surface 609b of the reflective cylinder 609 and contact portions between the stainless steel ring 614 at the end and the fixing ring 8b of the housing case 8 are fused and secured to each other by laser welding or spot welding. In the light source 601 shown in the same drawing, a light guide cylinder 603B is formed in a short length and the reflective cylinder 609 is designed so as to match it, thereby to allow the distribution of emitted light to be parallel light or diffusion light and to enhance uniformity of light intensity on an illumination target surface. As in the light source 601, a projecting part 615 may be provided at the end of the reflective cylinder 609 on the luminescent cylinder 603A side so that the projecting part 615 is arranged to extend inside the housing case 8 and become closer to the discharge path limiter 7, in the range not to impede a current of charged particles. This configuration can increase the light amount from the exit window 4 and allows the capture of foreign matter such as the sputtered substance by the reflective cylinder 609, from the interior of the luminescent part 2, further preventing the adhesion of the sputtered substance onto the exit window 4 of low-temperature part.

The laser welding or spot welding shown in FIG. 10 may also be applied to the fixing of the reflective cylinder 9 in the third to sixth embodiments shown in FIGS. 6 to 9. In that case, it is preferable to fix a stainless steel ring to the end of the reflective cylinder 9 and weld the stainless steel ring to the fixing member, in the same manner as in FIG. 10.

A variety of shapes can be adopted for the structure for welding to be fixed at the tip of the reflective cylinder 609.

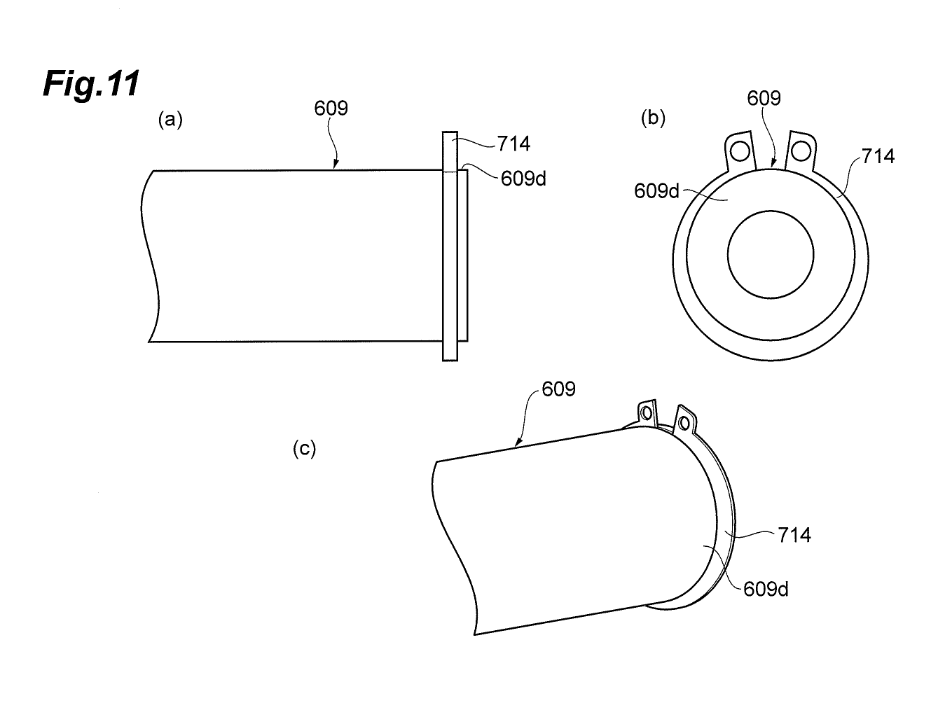

For example, as shown in FIG. 11, the reflective cylinder 609 may be fixed to the luminescent part 2 by fixing a retaining ring 714 such as a stainless steel C-shaped retaining ring to the outer periphery of the end 609d of the reflective cylinder 609 and welding the retaining ring 714 to a fixing member for the reflective cylinder which is provided in the housing case 8.

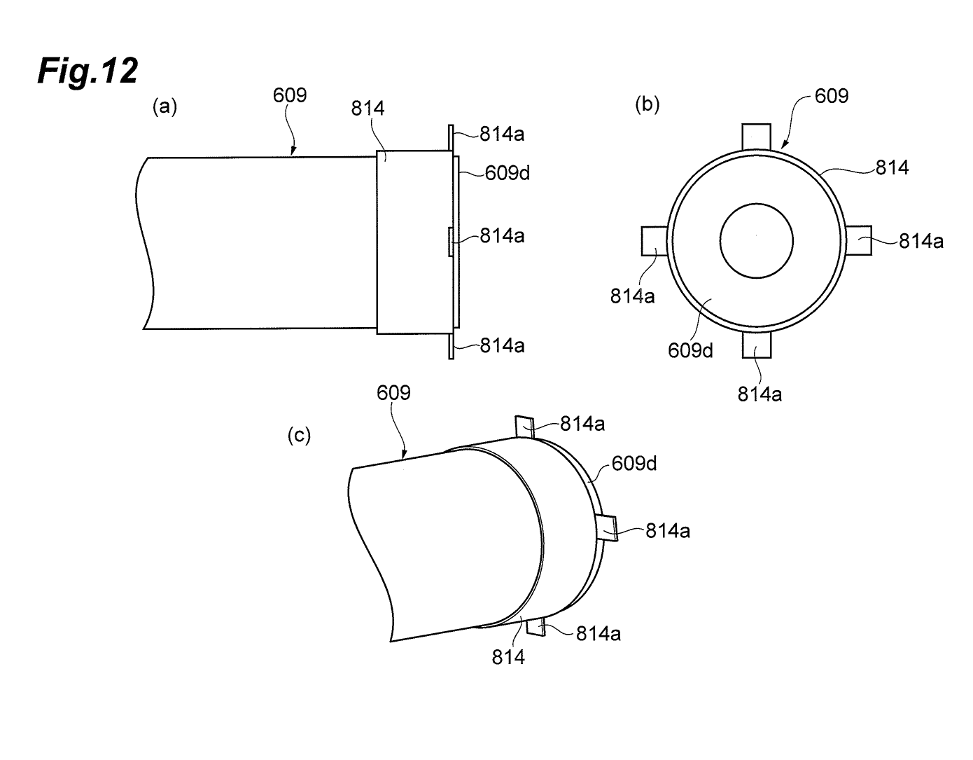

Furthermore, as shown in FIG. 12, it is also possible to adopt a configuration wherein a stainless steel sheet material 814 is wound in a belt shape around the outer periphery of the end 609d of the reflective cylinder 609 and their terminal ends are stacked and welded to be fixed. A plurality of flange portions 814a extending perpendicularly to the central axis of the reflective cylinder 609 are provided on the end 9d side of this sheet material 814 and the flange portions 814a and the fixing member are welded to fix the reflective cylinder 609. It is also possible to fix the reflective cylinder 609 by welding proximate portions between the sheet material 814 and the fixing member, without provision of the flange portions 814a.

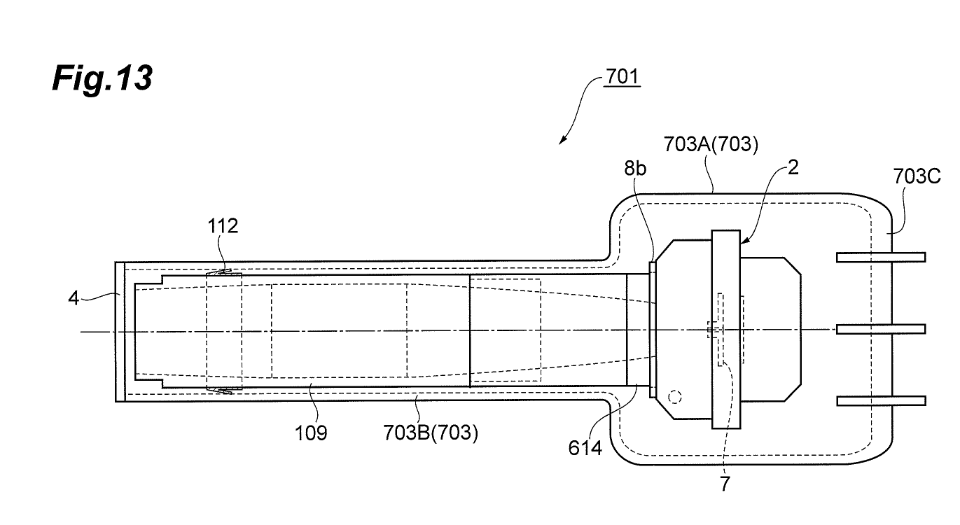

FIG. 13 shows a light source 701 as a deuterium lamp in which a stem 703C, a luminescent cylinder 703A, and a light guide cylinder 703B are arranged coaxially with the optical axis, as a modification example of the present invention. The light source 701 of this configuration can be assembled from the same axial direction. Particularly, the light source can be manufactured by fixing the reflective cylinder 109 to the fixing ring 8b of the luminescent part 2 to form an integrated combination, thereafter inserting the reflective cylinder 109 into a hermetic container 703 in which the light guide cylinder 703B and the luminescent cylinder 703A are integrated, and sealing the hermetic container 703 by the stem 703C. As in the case of the light source 601, the end ring 614 is forced onto this reflective cylinder 109 and fixed thereto and this end ring 614 and the fixing ring 8b are welded to fix the reflective cylinder 109. At the same time, the metal band 112 is fixed to the reflective cylinder 109 at the end of the outer wall surface 109b on the exit window 4 side, as in the case of the light source 101. This metal band 112 enhances the coaxiality of the light guide cylinder 703B and the reflective cylinder 109. Besides this fixing method, another fixing method may be adopted, e.g., a method of increasing the height of the fixing ring 8b and screw cutting the inserted part of the reflective cylinder 109 and the fixing ring 8b to fix them, or a method of forming tapped holes in the fixing ring 8b, inserting the reflective cylinder 109 into the fixing ring 8b, and then fixing them with screws or the like.

The thermal radiation film 10 is formed in part or in whole of the outer wall surface 9b of the reflective cylinder 9 in the light source 1, 101, or 201, but, conversely, a material with the thermal emissivity lower than that of the material of the reflective cylinder 9 may be formed on the portion of the outer wall surface 9b except for the end on the luminescent cylinder 3A or 203A side. This configuration relatively enhances heat radiation on the one end side and is expected to provide the same effect as the thermal radiation film 10. The material of the metal block member forming the one end side of the reflective cylinder 9 or 109 may be comprised of a material with the thermal emissivity larger than that of the material of the metal block member forming the other end side. The luminescent cylinder 3A, 203A, 303A, 403A, or 503A may be one having another luminescent form; e.g., it may use an excimer lamp.

### Seventh Embodiment

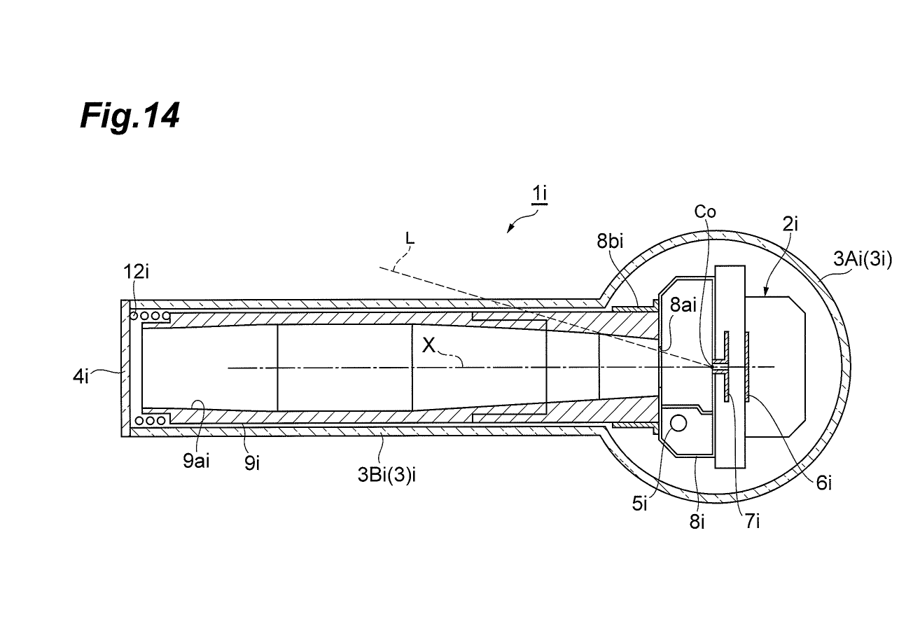

FIG. 14 is a sectional view showing a configuration of a deuterium lamp according to the seventh embodiment of the present invention.

This deuterium lamp 1i is provided with a hermetic container 3i of glass in which a luminescent cylinder (first housing) 3Ai of a substantially cylindrical shape housing a luminescent part 2i to induce discharge of deuterium gas to generate light, is integrally connected to a light guide cylinder (second housing) 3Bi of a substantially cylindrical shape kept in communication with the luminescent cylinder 3Ai and projecting along the optical axis X of light generated by the luminescent part 2i, from the side wall of the luminescent cylinder 3Ai. In this hermetic container 3i deuterium gas is enclosed under the pressure of about several hundred Pa. More specifically, the light guide cylinder 3Bi is integrated in communication with the luminescent cylinder 3Ai on a one end side in the direction along the optical axis X and is sealed on the other end side by an exit window 4i to emit the light generated from the luminescent part 2i, to the outside. A material of this exit window 4i is, for example, MgF₂ (magnesium fluoride), LiF (lithium fluoride), silica glass, or sapphire glass.

The luminescent part 2i housed in the luminescent cylinder 3Ai is composed of a cathode 5i, an anode 6i, a discharge path limiter 7i arranged between the anode 6i and the cathode 5i, formed of an electrically-conductive high-melting-point metal in a central region, and having an aperture to limit a discharge path, and a housing case 8i arranged so as to surround these. In a surface of this housing case 8i on the light guide cylinder 3Bi side, a light passage port (aperture) 8ai of a rectangular shape for extraction of the light generated by the luminescent part 2i is formed so as to face the exit window 4i of the light guide cylinder 3Bi and, a fixing ring (fixing member) 8bi consisting of a wall part extending in a circular shape along the side wall of the light guide cylinder 3Bi is fixed so as to surround the light passage port 8ai. When a voltage is applied between the cathode 5i and the anode 6i, the luminescent part 2i induces ionization and discharge of the deuterium gas existing between them, to form a plasma state and the discharge path limiter 7i narrows it into a high-density plasma state, thereby to generate light (ultraviolet light), which is emitted from the light passage port 8ai of the housing case 8i into the direction along the optical axis X.

The foregoing luminescent part 2i is held in the luminescent cylinder 3Ai by a stem pin (not shown) standing on a stem part disposed on an end face of the luminescent cylinder 3Ai. Namely, this deuterium lamp 1i is a side-on type deuterium lamp in which the optical axis X intersects with the tube axis of the luminescent cylinder 3Ai.

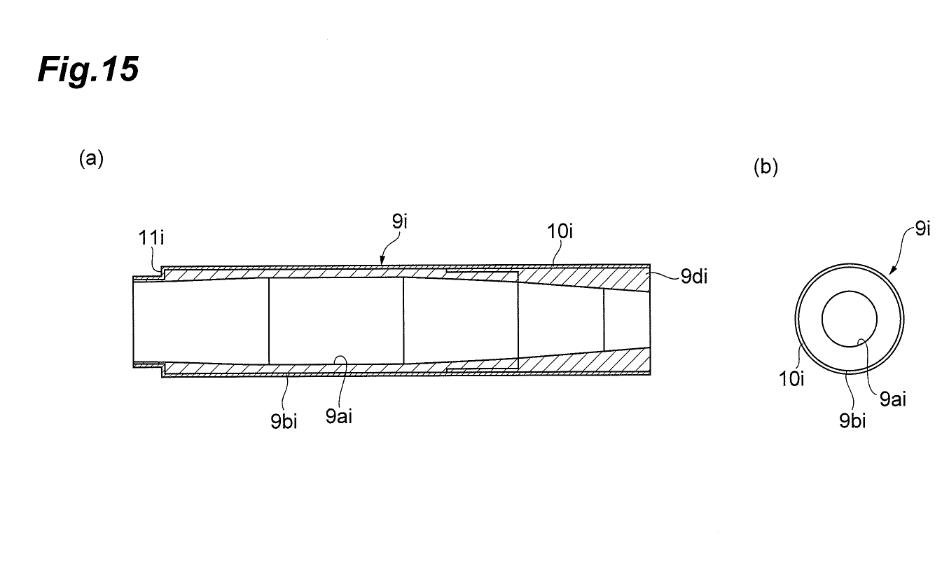

A reflective cylinder (cylindrical member) 9i of a substantially cylindrical shape is inserted and fixed between the exit window 4i in the hermetic container 3i of this configuration and a portion connecting the luminescent cylinder 3Ai and the light guide cylinder 3Bi. This reflective cylinder 9i is, as shown in FIG. 15, a combination of metal block members of aluminum and is formed in a substantially cylindrical shape having an outside diameter smaller than an inside diameter of the light guide cylinder 3Bi.

An inner wall surface of the reflective cylinder 9i itself is formed as a reflective surface 9ai which is a curved surface along the central axis of the reflective cylinder 9i, or a multistep surface with inclination angles varying stepwise. Namely, this reflective surface 9ai is formed so that the two ends of the reflective cylinder 9i in the central-axis direction are tapered so as to be able to converge the light at a desired surface or point outside the exit window 4i. More specifically, the reflective surface 9ai is formed as inclined with respect to the central axis of the reflective cylinder 9i, i.e., with respect to the optical axis X so that the diameter of the space surrounded by the reflective surface 9ai gradually decreases from a longitudinal central region of the reflective cylinder 9i toward the end on the luminescent cylinder 3Ai side. Furthermore, the reflective surface 9ai is formed as inclined with respect to the central axis of the reflective cylinder 9i so that the diameter of the space surrounded by the reflective surface 9ai gradually decreases from the longitudinal central region of the reflective cylinder 9i toward the end on the exit window 4i side. The reflective surface 9ai is set at smaller angles of inclination to the optical axis X of the reflective surface 9ai than a line L connecting a luminescent center C₀ located at the center of the aperture of the discharge path limiter 7i of the luminescent part 2i, and the end on the luminescent part 2i side of the reflective surface 9ai. For example, the inclination angle of the reflective surface 9ai in the stage closest to the luminescent center C₀ side is set in the range of 2 to 15°, while the inclination angle of the line L to the optical axis X is in the range of 10 to 30°. The tapered structure of the reflective surface 9ai may be provided at either one of the two ends of the reflective cylinder 9i in the central-axis direction, instead of that at the two ends; for example, the reflective surface 9ai may be formed in the tapered shape as described above, only on the luminescent part 2i side (one end side), while the reflective surface 9ai is formed in parallel to the central axis of the reflective cylinder 9i on the exit window 4i side (the other end side).

This reflective surface 9ai is processed in a mirror surface state capable of regularly reflecting the light generated by the luminescent part 2i and is formed, for example, by cutting the metal block members, polishing an inner wall thereof by a polishing method such as buffing, chemical polishing, electropolishing, or a derivative thereof, or by a polishing method as a complex thereof, and thereafter subjecting the surface to a washing treatment or a vacuum treatment or the like to remove an impurity gas component. In the present embodiment the reflective cylinder 9i is composed of a combination of two members and, when the reflective surface 9ai is formed of a plurality of metal block members as in this configuration, a ratio of length and inside diameter (aspect ratio) of the reflective surface 9ai of each metal block member can be set smaller, so as to facilitate achievement of desired flatness during processing and shaping, thereby enhancing the mirror accuracy of the reflective surface 9ai.

Furthermore, a thermal radiation film 10i containing a material with high thermal emissivity is formed over almost the entire area of an outer wall surface 9bi of the reflective cylinder 9i. The material of this thermal radiation film 10i to be used is one with the thermal emissivity higher than that of the material of the reflective cylinder 9i, e.g., aluminum oxide. The thermal radiation film 10i is formed, for example, by depositing the material forming the thermal radiation film 10i, on the outer wall surface 9bi of the reflective cylinder 9i by evaporation, coating, or the like, but, particularly, in the case where the reflective cylinder 9i is made of aluminum as in the present embodiment, a layer of aluminum oxide as the thermal radiation film 10i may be formed by oxidizing the outer wall surface 9bi of the reflective cylinder 9i.

A cut portion 111 cut in a circular shape so as to form a stepped projection is formed along the outer wall surface 9bi, in a peripheral edge region on the longitudinal other end side of the outer wall surface 9bi of the reflective cylinder 9i. This cut portion 11i is provided for positioning the reflective cylinder 9i in the hermetic container 3i.

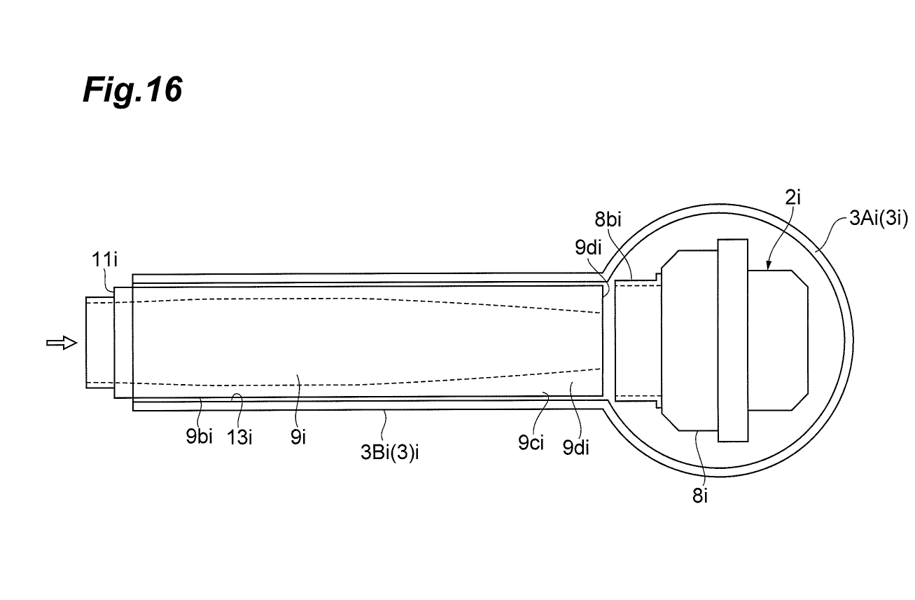

The reflective cylinder 9i of this configuration is inserted along the tube axis (optical axis X) of the light guide cylinder 3Bi from the edge region 9di side until the edge region 9di on the one end side comes into contact with the housing case 8i of the luminescent part 2i and, after a spring member 12i is attached along the outer wall surface 9bi to the cut portion 111, the other end side of the light guide cylinder 3Bi is sealed by the exit window 4i (FIG. 14 and FIG. 16). At this time, the reflective cylinder 9i is fitted into the fixing ring 8bi of the housing case 8i in a state in which the outer wall surface 9bi thereof is separated from the inner wall surface 13i of the light guide cylinder 3Bi (FIG. 16). This spring member 12i is a member for positioning of the reflective cylinder 9i, which is comprised of a metal member, e.g., stainless steel or an Inconel material with high thermal resistance, and which is arranged between the cut portion 111 and the exit window 4i, with a function to urge the reflective cylinder 9i from the exit window 4i side toward the luminescent part 2i along the optical axis X, thereby to press the reflective cylinder 9i against the housing case 8i. By this, the reflective cylinder 9i is positioned in a state in which the edge region 9di on the one end side is in contact with the housing container 8i of the luminescent part 2i and the other end side is inserted in the light guide cylinder 3Bi to be in close proximity to the exit window 4i, between the exit window 4i and the luminescent part 2i in the hermetic container 3i.

In the deuterium lamp 1i described above, the discharge path limiter 7i narrows the discharge caused between the cathode 5i and the anode 6i of the luminescent part 2i in the luminescent cylinder 3Ai to generate light, and the light generated by the luminescent part 2i is guided to the interior of the reflective cylinder 9i inserted from the exit window 4i of the light guide cylinder 3Bi in communication with the luminescent cylinder 3Ai to the luminescent part 2i, thereby to be emitted from the exit window 4i. Since the reflective surface 9ai is formed on the inner wall surface of the reflective cylinder 9i herein, the light emitted from the luminescent part 2i is guided from the one end side to the other end side of the light guide cylinder 3Bi while being reflected by the reflective surface 9ai inside the reflective cylinder 9i, so that the light emitted from the luminescent part 2i can be guided to the exit window 4i of the light guide cylinder 3Bi, without loss. In addition, since the two ends of the reflective surface 9ai are formed in the taper shape, the light can be converged at the predetermined position outside the exit window 4i. Furthermore, the efficiency of extraction of the light from the exit window 4i improves, so as to increase a total light amount of the output light and a light amount on the illumination target surface. In the case of the conventional deuterium lamps, a light radiation pattern from the exit window tends to vary according to the distance from the exit window to cause an omission where radiant light is weak, whereas the deuterium lamp 1i achieves reduction in occurrence of such an omission of the light radiation pattern. As a result, the generated light can be extracted efficiently.

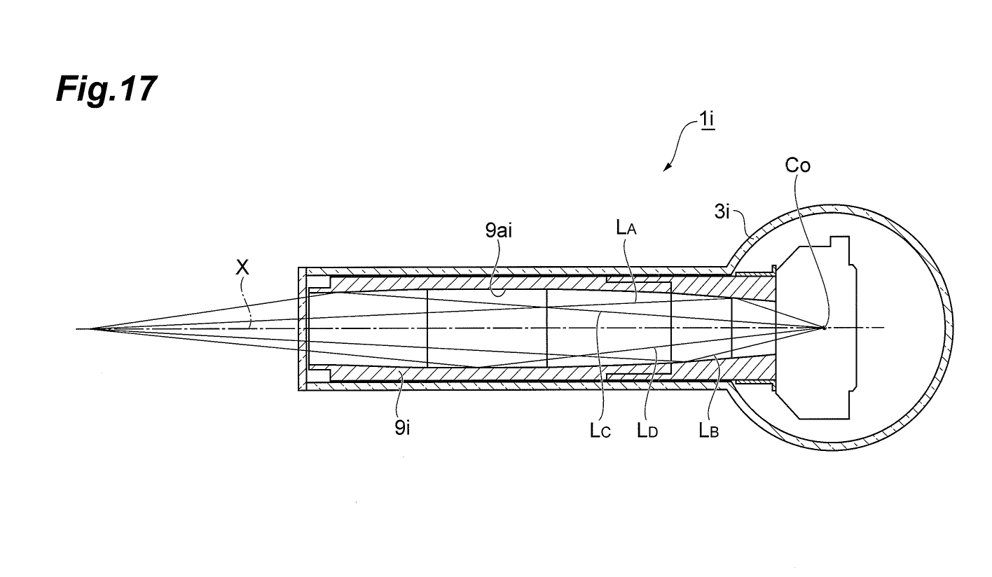

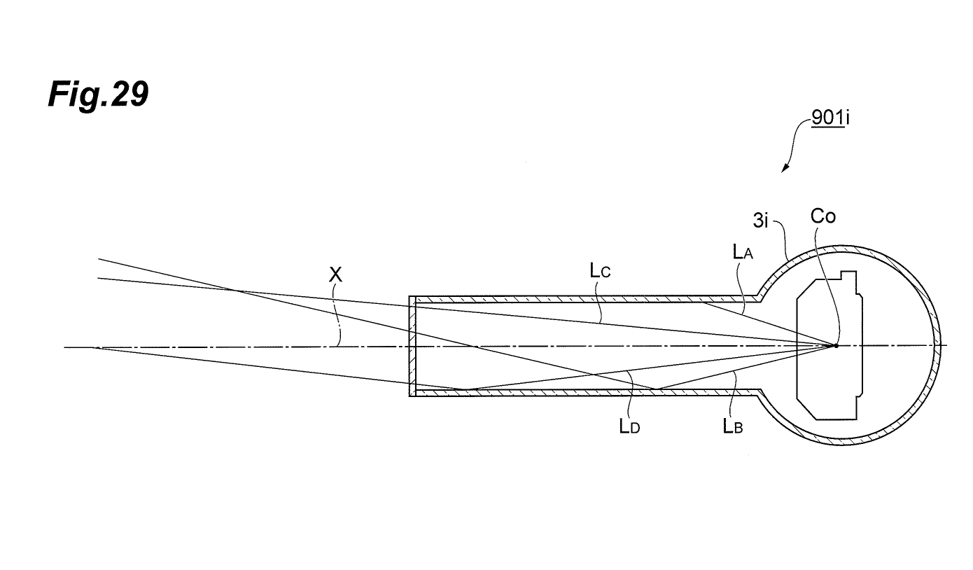

FIG. 17 is a drawing showing optical paths of light components in various light emission directions from the luminescent center C₀ in the deuterium lamp 1i and FIG. 29 a drawing showing optical paths of light components in various light emission directions from the luminescent center C₀ in a deuterium lamp 901i obtained by removing the reflective cylinder 9i from the deuterium lamp 1i.

As shown in FIG. 29, the light component L_{A} with a large emission angle relative to the optical axis X is not totally reflected in the deuterium lamp 901i but is transmitted or absorbed by the hermetic container 3i. In contrast to it, in the deuterium lamp 1i as shown in FIG. 17, this light component L_{A} is also totally reflected by the reflective surface 9ai to function as a forward irradiation component, increasing an amount of radiant light. Furthermore, since the reflective surface 9ai on the luminescent center C₀ side is tapered, reflected light can be converged around a desired position from the exit window 4i without forming diverging components.

The light components L_{B}, L_{D}, which are reflected by the hermetic container 3i to become diverging light in the case of the deuterium lamp 901i, can also be converged around the desired position in the case of the deuterium lamp 1i. Furthermore, since the reflective surface 9ai is tapered on the exit window 4i side in the deuterium lamp 1i, the light component L_{C}, which diverges from the exit window 4i in the case of the deuterium lamp 901i because of a small emission angle relative to the optical axis X, can be used as a converging component and the light component L_{D} can be converged at an appropriate position around the desired position. As a result, the reflective surface 9ai of the reflective cylinder 9i can be formed in the structure capable of using many components of radiant light as converging components.

By adjusting the shape of the tapered portions in the reflective surface 9ai of the reflective cylinder 9i, the emitted light from the exit window 4i can also have a distribution with many parallel light components or a divergent distribution on the contrary, instead of the convergent distribution.

Since the reflective cylinder 9i itself is comprised of the metal members such as the metal block members of aluminum to facilitate processing of the reflective surface with high mirror accuracy, the generated light can be effectively converged. Furthermore, for example, unlike the case where the reflective film of metal or the like is formed inside the reflective cylinder 9i, it is feasible to prevent the degradation of performance and generation of foreign matter due to delamination or dropout or the like of the reflective surface 9ai caused by the difference between coefficients of expansion of the constituent materials with repetitions of increase and decrease of temperature, and thereby to achieve extension of service life. In addition, the generated ultraviolet light is not transmitted and the ultraviolet light does not cause deterioration, whereby the generated light can be extracted more efficiently.

Furthermore, since the outer wall surface 9bi of the reflective cylinder 9i is separated from the inner wall surface 13i of the light guide cylinder 3Bi, it is feasible to prevent the positional deviation of the reflective cylinder 9i and the breakage of the reflective cylinder 9i or the light guide cylinder 3Bi, because of the difference of coefficients of thermal expansion between the reflective cylinder 9i and the light guide cylinder 3Bi.

Since the reflective cylinder 9i is urged into the fixing ring 8bi of the housing case 8i by the spring member 12i as the positioning member of the metal member to be positioned in the hermetic container 3i, it is prevented from being deteriorated by the generated ultraviolet light, and it becomes easier to achieve positioning and axial alignment of the reflective cylinder 9i relative to the aperture of the discharge path limiter 7i of the luminescent part 2i, so as to improve position accuracy, which can ensure sufficient extraction efficiency of light from the exit window 4i. Furthermore, by adopting the structure to push the reflective cylinder against the housing case 8i by the spring member 12i, it is feasible to stably fix the reflective cylinder 9i to the hermetic container 3i and to absorb positional deviation thereof relative to the luminescent cylinder 3Ai by the spring member 12i even with occurrence of thermal expansion along the central-axis direction of the reflective cylinder 9i. It can also be contemplated herein that the radiant light distribution is adjusted by aligning the positional and angular relations between the light guide cylinder 3Bi and the aperture of the discharge path limiter 7i during sealing of the deuterium lamp, but it becomes difficult in this case to achieve position adjustment because of the large difference between depth positions of the exit window 4i and the aperture. In the present embodiment, the reflective cylinder 9i is introduced to stably determine the positional relationship between the light guide cylinder 3Bi and the reflective cylinder 9i and the alignment between the reflective cylinder 9i and the fixing ring 8bi results in also achieving the positional and angular relations between the reflective cylinder 9i and the aperture. Therefore, accurate alignment is achieved as to the positional relationship between the light guide cylinder 3Bi and the aperture.

Furthermore, since the thermal radiation film 10i is formed over almost the entire area of the outer wall surface 9bi of the reflective cylinder 9i, as shown in FIG. 15, a region at lower temperature than the surroundings and the enclosed gas can be formed on the inner surface of the reflective cylinder 9i in close proximity to the luminescent part 2i and the lower-temperature region can capture the foreign matter such as the sputtered substance from the luminescent cylinder 3Ai, so as to prevent diffusion of the foreign matter to the exit window 4i and reduction of optical transmittance caused thereby.

When the deuterium lamp 1i of this configuration is used a photoionization source in a mass spectrometer (MS) such as a gas chromatography mass spectrometer (GC/MS) or a liquid chromatography mass spectrometer (LC/MS), it is feasible to achieve high sensitivity, prevent contamination of the window material, and achieve a good time response characteristic. Firstly, the light amount on the irradiation target surface can be drastically increased so as to improve a probability of contact with a sample, whereby the sensitivity can be improved to a large extent (nearly ten times) in comparison to the conventional photoionization sources. It also becomes feasible to achieve convergence of light suitable for a variety of MSs, and the measurement sensitivity is enhanced on the following points. Specifically, in the case of MS, the light can be focused on an effective portion of an electric field distribution for introducing ions to a discriminator in an ionization chamber. In the case of GC/MS, the light can be effectively focused and introduced through an aperture of about several mm of the ionization chamber. In the case of LC/MS, the light can be focused around an aperture to introduce ions into the discriminator, to enhance an ion density, and the window of the photoionization source can be located away from a sample ejection port to prevent contamination of the window, while avoiding degradation of sensitivity even at the distant location from the ionization source because of the enhancement of light convergence more than before. Namely, the high-density light is guided onto a high-density sample part to enhance ionization efficiency, thereby achieving high sensitivity; the window of the photoionization source is located away from the sample ejection port, thereby preventing contamination of the window; the light is focused on the sample ejection port, thereby increasing the response speed.

### Eighth Embodiment

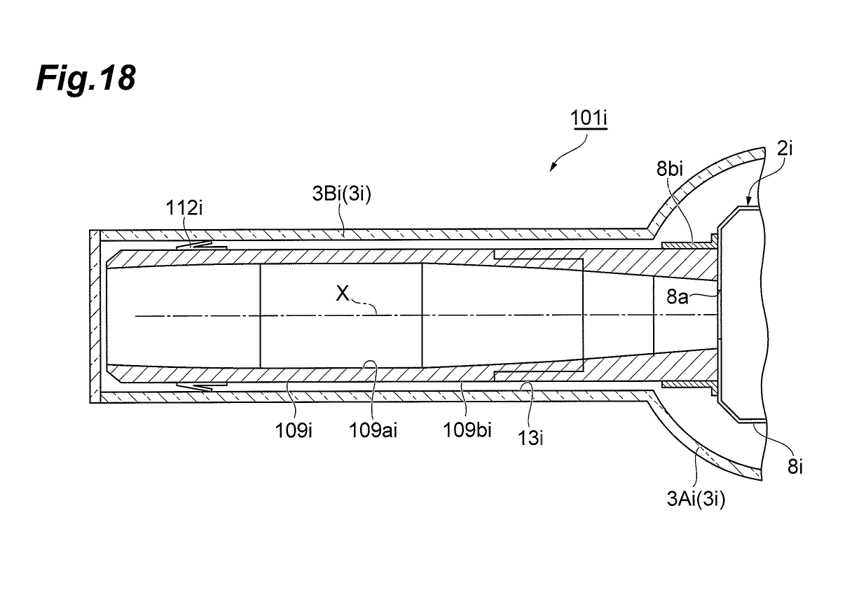

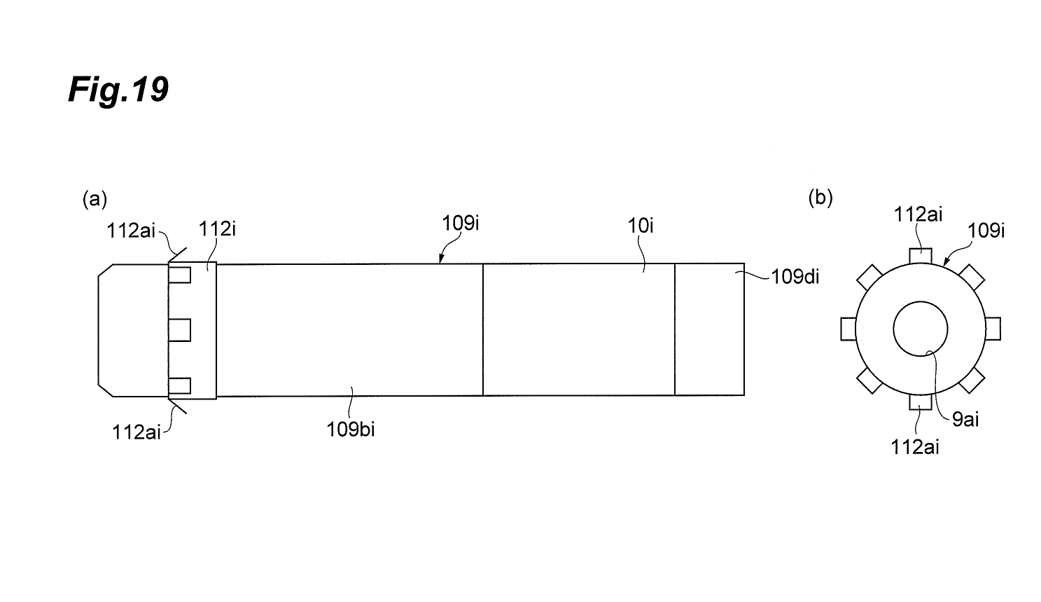

FIG. 18 is a sectional view showing a configuration of a deuterium lamp according to the eighth embodiment of the present invention, FIG. 19(a) a side view of a reflective cylinder in FIG. 18, and FIG. 19(b) an end view of the reflective cylinder in FIG. 18. The deuterium lamp 101i shown in the same drawings is different mainly in the positioning structure of the reflective cylinder 109i from that in the seventh embodiment.

Specifically, a metal band 112i as a positioning member is fixed to the reflective cylinder 109i set inside the deuterium lamp 101i, at an end of its outer wall surface 109bi on the exit window 4i side. In this metal band 112i, a plurality of claws 112ai with spring action are formed along the outer periphery of the reflective cylinder 109i, and the metal band 112i is welded at its end by lap welding to be fixed on the outer wall surface 109bi. The reflective cylinder 109i of this configuration is inserted into the hermetic container 3i along the inner wall surface 13i of the light guide cylinder 3Bi and is fixed so that the outer wall surface 109bi is separated from the inner wall surface 13i except for the metal band 112i.

In this structure, the reflective cylinder 109i is urged at its edge region 109di on the one end side thereof against the fixing ring 8bi of the housing case 8i by spring forces of the claws 112ai of the metal band 112i, to be positioned in the direction along the optical axis X in the hermetic container 3i. In conjunction therewith, the reflective cylinder 109i is also positioned in the directions perpendicular to the optical axis X in a state in which the outer wall surface 109bi thereof and the inner wall surface 13i of the light guide cylinder 3Bi are separated from each other at a fixed distance, by the claws 112ai of the metal band 112i. If a groove is formed in the width of the metal band in the region of the reflective cylinder 109i where the metal band 112i is mounted, the distance from the metal band 112i to the inner wall surface 13i of the light guide cylinder 3Bi can be set larger without increase in the inside diameter of the light guide cylinder 3Bi and angles of the claws 112ai can be increased, with the result of increase in the spring forces of the claws 112ai.

The deuterium lamp 101i of this configuration can also prevent the positional deviation of the reflective cylinder 109i and the breakage of the reflective cylinder 109i or the light guide cylinder 3Bi, because of the difference of coefficients of thermal expansion between the reflective cylinder 109i and the light guide cylinder 3Bi. Since the reflective cylinder 109i is urged into the fixing ring 8bi of the housing case 8i by the metal band 112i as the positioning member to be positioned in the hermetic container 3i, it becomes easier to achieve the positioning and axial alignment of the reflective cylinder 9i relative to the aperture of the discharge path limiter 7i of the luminescent part 2i, so as to improve the position accuracy, which can ensure sufficient extraction efficiency of light from the exit window 4i. Particularly, in the present embodiment, the coaxiality of the reflective cylinder 9i and the light guide cylinder 3Bi can be maintained on a stable basis.

Since the two ends of the reflective surface 9ai are formed in the taper shape, the light can be efficiently extracted from the exit window 4i so as to converge the light at the predetermined position outside the exit window 4i, and the light amount of emitted light can be increased on the irradiation target surface.

### Ninth Embodiment

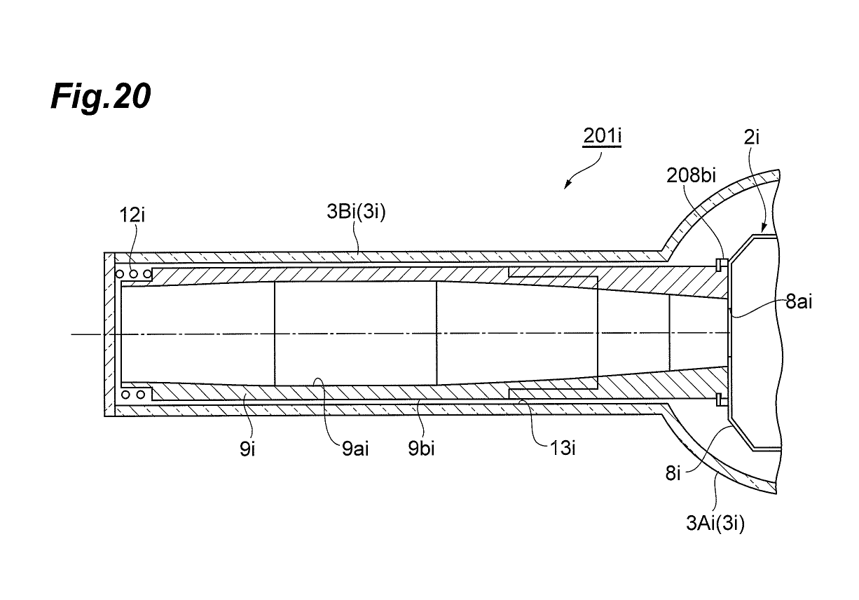

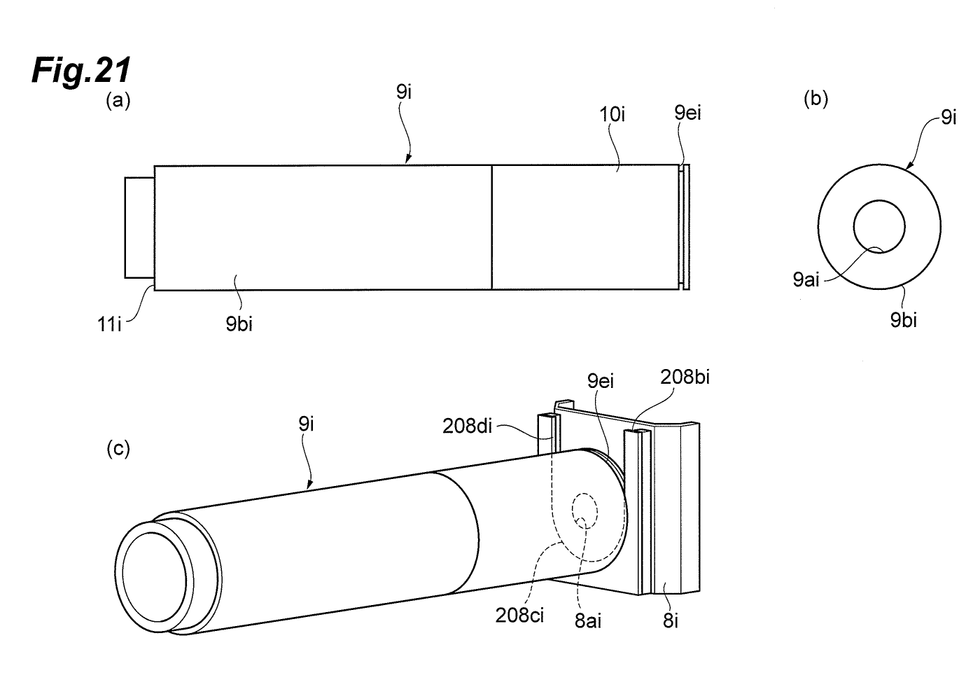

FIG. 20 is a sectional view showing a configuration of a deuterium lamp according to the ninth embodiment of the present invention, FIG. 21(a) a side view of a reflective cylinder in FIG. 20, FIG. 21(b) an end view of the reflective cylinder in FIG. 20, and FIG. 21(c) a perspective view of the reflective cylinder in FIG. 20. The deuterium lamp 201i shown in the same drawings is different in the positioning structure on the luminescent part side of the reflective cylinder from that in the seventh embodiment.

Specifically, a groove 9ei is formed along the outer periphery of the reflective cylinder 9i, on the longitudinal one end side of the outer wall surface 9bi of the reflective cylinder 9i in the deuterium lamp 201i. Fixed to a surface of the housing case 8i of the luminescent part 2i on the light guide cylinder 3Bi side is a claw portion (fixing member) 208bi to fix the end of the reflective cylinder 9i by engagement of the groove 9ei of the reflective cylinder 9i therewith. This claw portion 208bi has a semicircular portion 208ci arranged so as to surround the light passage port 8ai of the housing case 8i, and opening ends 208di formed in a linear shape so as to extend from the semicircular portion 208ci, which are provided for insertion of the reflective cylinder 9i therein (FIG. 21(c)).

In this structure, the reflective cylinder 9i is inserted in a direction perpendicular to the central axis with the projection of the claw portion 208bi sliding along the groove 9ei, from the opening ends 208di of the claw portion 208bi, and is positioned relative to the housing case 8i after it is moved to the deep end of the semicircular portion 208ci. Optionally, a stopper for keeping the reflective cylinder 9i from returning to the opening ends 208di upon the insertion to the deep end of the semicircular portion 208ci may be provided at a part close to the outer periphery of the reflective cylinder 9i in the claw portion 208bi. Since the width of the groove 9ei has some margin for the claw portion 208bi, the reflective cylinder 9i is urged by the spring member 12i to be pushed against the housing case 8i, whereby it is positioned in the direction along the optical axis X in the hermetic container 3i. In conjunction therewith, as the reflective cylinder 9i is inserted into the semicircular portion 208ci of the claw portion 208bi, the reflective cylinder 9i is also positioned in the direction perpendicular to the optical axis X in a state in which the outer wall surface 9bi thereof is separated at a fixed distance from the inner wall surface 13i of the light guide cylinder 3Bi. In this case, if a spring member to urge the reflective cylinder 9i toward the housing case 8i is incorporated in the claw portion 208bi, the spring member 12i can be omitted.

The deuterium lamp 201i of this configuration can also prevent the positional deviation of the reflective cylinder 9i and the breakage of the reflective cylinder 9i or the light guide cylinder 3Bi, because of the difference of coefficients of thermal expansion between the reflective cylinder 9i and the light guide cylinder 3Bi. Since the longitudinal other end face of the reflective cylinder 9i, i.e., the surface opposed to the exit window 4i is separated from the exit window 4i, the glass material and the window material are prevented from breaking even with the difference of expansion of the materials due to temperature during assembly and manufacture and during operation.

The reflective cylinder 9i is urged by the spring member 12i as the positioning member to come into contact with the housing case 8i and is inserted into the claw portion 208bi to be positioned in the hermetic container 3i. This facilitates the positioning and axial alignment of the reflective cylinder 9i relative to the aperture of the discharge path limiter 7i of the luminescent part 2i, so as to improve the position accuracy, whereby the light can be efficiently extracted from the exit window 4i. Particularly, in the present embodiment, the coaxiality of the reflective cylinder 9i and the light guide cylinder 3Bi can also be maintained on a stable basis.

Since the two ends of the reflective surface 9ai are formed in the taper shape, the light can be extracted more efficiently from the exit window 4i while being converged at the predetermined position outside the exit window 4i, which can increase the light amount of the emitted light on the illumination target surface.

The present invention does not have to be limited to the above-described embodiments. For example, the reflective surface 9ai or 109ai was formed on the reflective cylinder 9i or 109i by polishing the inner wall of the metal members, but the reflective surface may be formed by evaporation or sputtering. Particularly, the reflective surface can be formed by preparing a base by cutting or molding of a metal member such as aluminum, or a member of glass, ceramic, or the like, polishing the base if necessary, and thereafter depositing an aluminum, rhodium, or dielectric multilayer film or the like on a mirror surface of the base by evaporation or sputtering. The reflective cylinder 9i or 109i was formed of a plurality of metal block members, but it may be formed as an integral body.

In the foregoing embodiments, the reflective cylinder 9i or 109i was fixed by pressing it against the fixing member provided on the luminescent cylinder 3Ai side, but it may be fixed directly to the fixing member by laser welding, spot welding, or the like. In this case, if it is difficult to weld the reflective cylinder directly to the fixing member, it is possible to adopt a method of fixing a weldable structure to the reflective cylinder by engagement or the like and welding the structure to the fixing member. In the case of the laser welding, it is also possible to perform the welding through the glass member of the luminescent cylinder 3Ai.

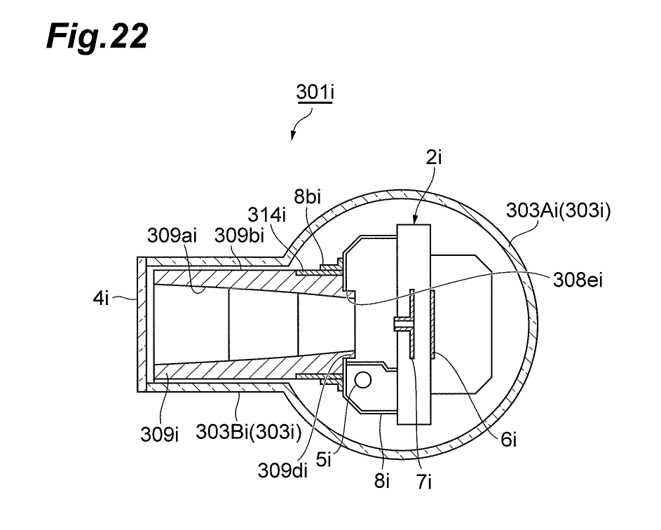

FIG. 22 shows a structure in which a reflective cylinder 309i comprised of metal members of two different materials is fixed to the housing case 8i of the luminescent part 2i by laser welding or spot welding, as a deuterium lamp 301i which is a modification example of the present invention. Particularly, an end ring 314i of stainless steel is fixed to the outer periphery of an end 309di on the one end side of the reflective cylinder 309i of aluminum and contact portions between the end ring 314i and the fixing ring 8bi of the housing case 8i are fused and secured to each other by laser welding or spot welding. In the deuterium lamp 301i shown in the same drawing, the light guide cylinder 303Bi is set shorter, but the distribution of emitted light can also be parallel light or diverging light by designing the reflective cylinder 309i so as to match it, and the uniformity of light intensity on the illumination target surface can also be enhanced. As shown in the same drawing, a hole 308ei may be provided inside the fixing ring 8bi on the housing case 8i and the tip of the end 309di of the reflective cylinder 309i may be set in the hole 308ei so as to be located near the discharge path limiter 7i within the range not to impede the current of charged particles. In this configuration, the reflective cylinder 9i (reflective surface 9ai) is arranged in close proximity to the interior of the luminescent part 2i, whereby the light can be extracted more efficiently from the exit window 4i.

A variety of shapes can be adopted for the structure for welding to be fixed at the tip of the reflective cylinder 309i.

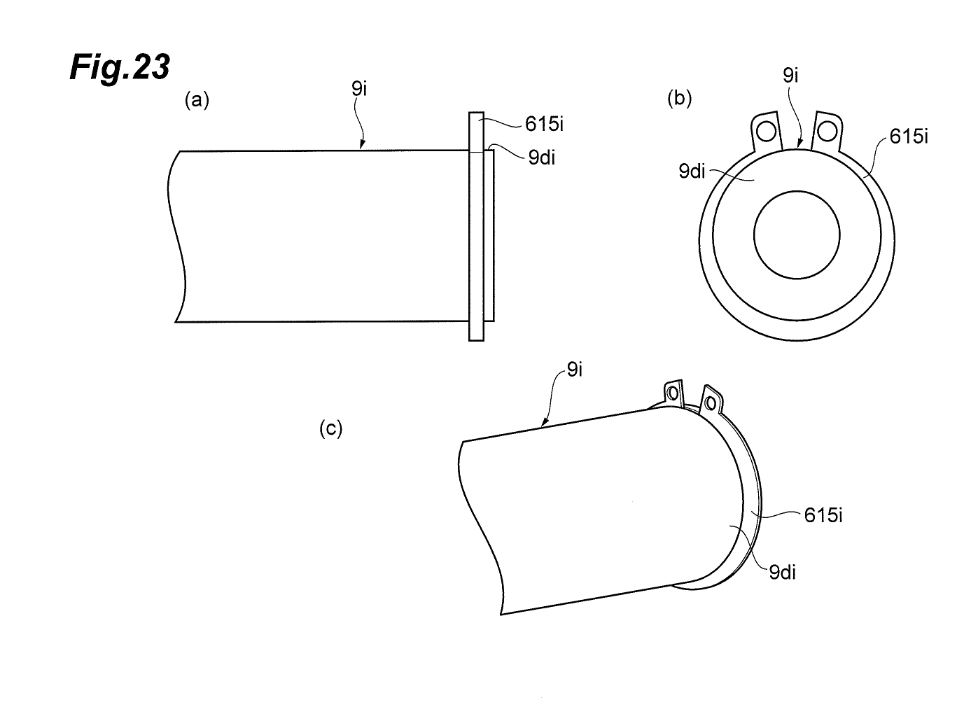

For example, as shown in FIG. 23, the reflective cylinder 9i may be fixed to the luminescent part 2i by fixing a retaining ring 615i such as a stainless steel C-shaped retaining ring to the outer periphery of the end 9di of the reflective cylinder 9i and welding the retaining ring 615i to a fixing member for the reflective cylinder which is provided in the housing case 8i.

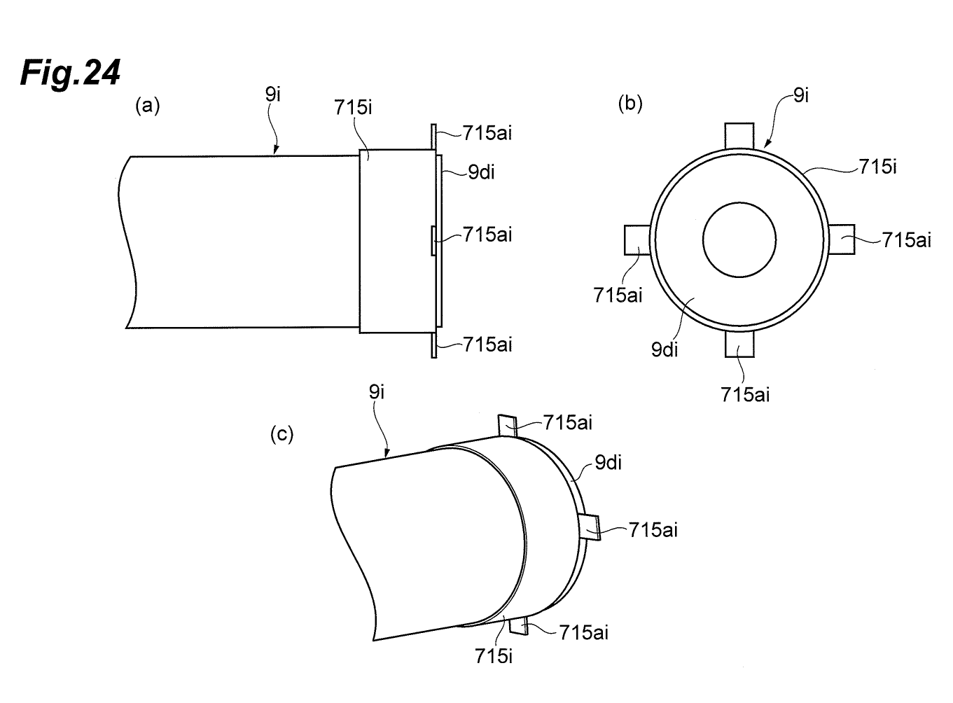

Furthermore, as shown in FIG. 24, it is also possible to adopt a configuration wherein a stainless steel sheet material 715i is wound in a belt shape around the outer periphery of the end 9di of the reflective cylinder 9i and their terminal ends are stacked and welded to be fixed. A plurality of flange portions 715ai extending perpendicularly to the central axis of the reflective cylinder 9i are provided on the end 9di side of this sheet material 715i and the flange portions 715ai and the fixing member are welded to fix the reflective cylinder 9i. It is also possible to fix the reflective cylinder 9i by welding proximate portions between the sheet material 715i and the fixing member, without provision of the flange portions 715i.

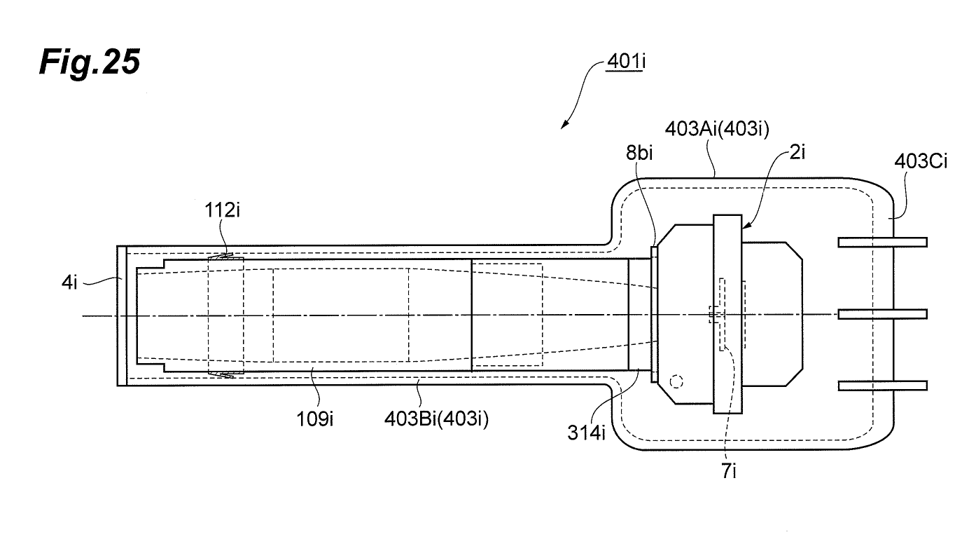

FIG. 25 shows a deuterium lamp 401i in which a stem 403Ci, a luminescent cylinder 403Ai, and a light guide cylinder 403Bi are arranged coaxially with the optical axis, as a modification example of the present invention. The deuterium lamp 401i of this configuration can be assembled from the same axial direction. Particularly, the deuterium lamp can be manufactured by fixing the reflective cylinder 109i to the fixing ring 8bi of the luminescent part 2i to be integrated therewith, thereafter inserting the reflective cylinder 109i into a hermetic container 403i in which the light guide cylinder 403Bi and the luminescent cylinder 403Ai are integrated, and sealing the hermetic container 403i by the stem 403Ci. As in the case of the deuterium lamp 301i, the end ring 314i is forced onto this reflective cylinder 109i and fixed thereto and this end ring 314i and the fixing ring 8bi are welded to fix the reflective cylinder 109i. At the same time, the metal band 112i is fixed to the reflective cylinder 109i at the end of the outer wall surface 109bi on the exit window 4i side, as in the case of the deuterium lamp 101i. This metal band 112i enhances the coaxiality of the light guide cylinder 403Bi and the reflective cylinder 109i. Besides this fixing method, another fixing method may be adopted, e.g., a method of increasing the height of the fixing ring 8bi and screw cutting the inserted part of the reflective cylinder 109i and the fixing ring 8bi to fix them, or a method of forming tapped holes in the fixing ring 8bi, inserting the reflective cylinder 109i into the fixing ring 8bi, and then fixing them with screws or the like.

In the deuterium lamp 1i, 101i, 201i, 301i, or 401i, an aperture to penetrate to the reflective surface 9ai, 109ai, or 309ai may be formed in the outer wall surface 9bi, 109bi, or 309bi of the reflective cylinder 9i, 109i, or 309i on the luminescent cylinder 3Ai or 303Ai side (one end side) in the longitudinal direction.

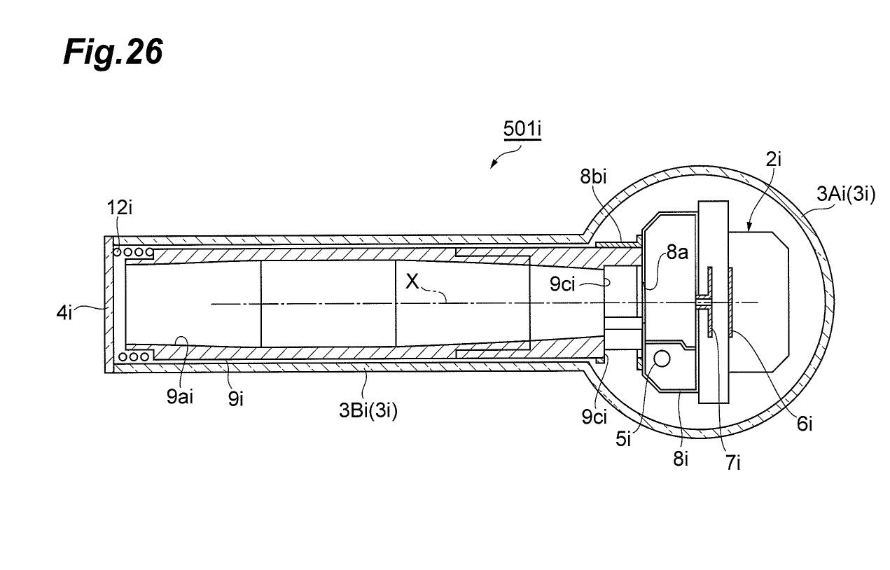

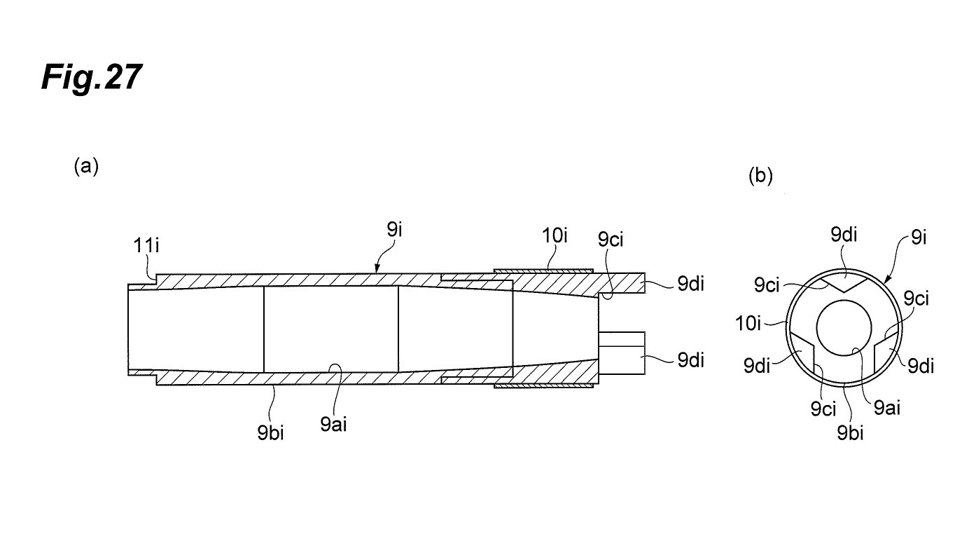

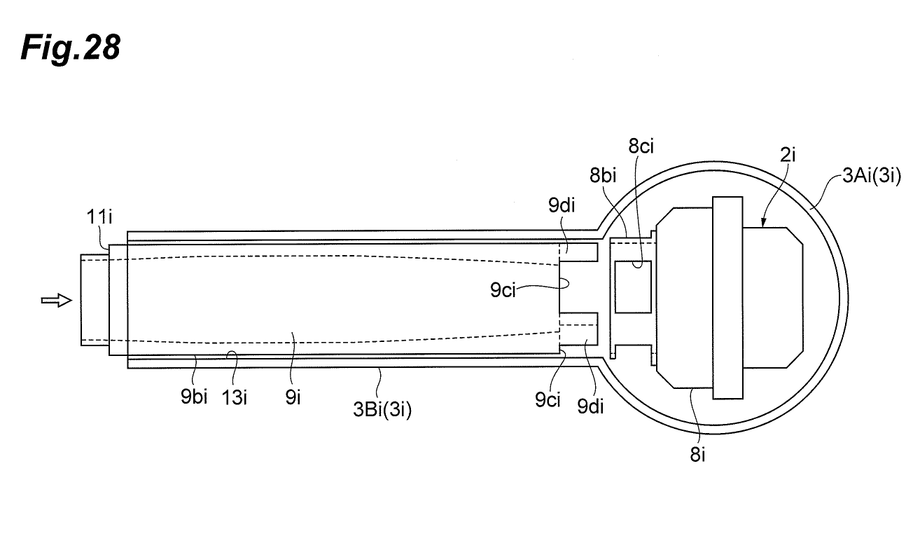

For example, in a deuterium lamp 501i shown in FIGS. 26 to 28, apertures 9ci cut along the central axis of the reflective cylinder 9i are formed toward the exit window 4i side (the other end side) of the outer wall surface 9bi, in the edge region on the one end side of the outer wall surface 9bi of the reflective cylinder 9i. Particularly, the apertures 9ci are formed in three portions at equal intervals along the circumference on the one end side of the reflective cylinder 9i, and projections 9di to be fitted in the fixing ring 8bi of the luminescent part 2i are formed in three portions between the neighboring apertures 9ci. Furthermore, apertures 8ci are formed at positions corresponding to the apertures 9ci of the reflective cylinder 9i, in the fixing ring 8bi of the housing case 8i. In this structure, when the reflective cylinder 9i is fitted into the fixing ring 8bi of the housing case 8i, the plurality of apertures 9ci to penetrate to the reflective surface 9ai are arranged in communication with the interior space of the luminescent cylinder 3Ai through the apertures 8ci, at the end of the outer wall surface 9bi of the reflective cylinder 9i located in the luminescent cylinder 3Ai (FIG. 28).

In this deuterium lamp 501i, the sputtered substance generated in the luminescent part 2i can be discharged to the outside of the reflective cylinder 9i, whereby the sputtered substance can be prevented from adhering to the reflective surface 9ai of the reflective cylinder 9i or to the exit window 4i which is a part at low temperature. As a result, the optical transmittance is improved at the exit window 4i, while achieving extension of service life. Since the apertures 9ci are located in the luminescent cylinder 3Ai, the sputtered substance generated in the luminescent part 2i is more likely to be discharged in the luminescent cylinder 3Ai and captured in the luminescent cylinder 3Ai. As a result, it is feasible to further prevent scattering of the sputtered substance to the exit window 4i and thereby to more extend the service life. The apertures may also be formed in the end ring 314i in the structure in which the end ring 314i is forced onto the reflective cylinder 309i as shown in FIG. 22. In the structure in which the sheet material 715i is wound around the reflective cylinder 9i as shown in FIG. 24, the apertures may also be formed at the positions corresponding to the apertures 9ci of the reflective cylinder 9i in the sheet material 715i.

In the deuterium lamp 501i shown in FIGS. 26 to 28, the thermal radiation film 10i is formed on the longitudinal one end side of the outer wall surface 9bi of the reflective cylinder 9i. For this reason, a portion at lower temperature than the surroundings and the enclosed gas can be formed inside the reflective cylinder 9i in close proximity to the luminescent part 2i and the lower-temperature portion can capture the foreign matter such as the sputtered substance from the luminescent cylinder 3Ai, so as to prevent the diffusion of the foreign matter to the exit window 4i and the reduction of optical transmittance caused thereby. To the contrary, a material with the thermal emissivity lower than that of the material of the reflective cylinder 9i may be formed on the other end side of the outer wall surface 9bi. This configuration relatively enhances heat radiation on the one end side and is expected to achieve the same effect as the thermal radiation film 10i. Furthermore, the material of the metal block member forming the one end side of the reflective cylinder 9i may be comprised of a material with the thermal emissivity larger than that of the material of the metal block member forming the other end side.

### Tenth Embodiment

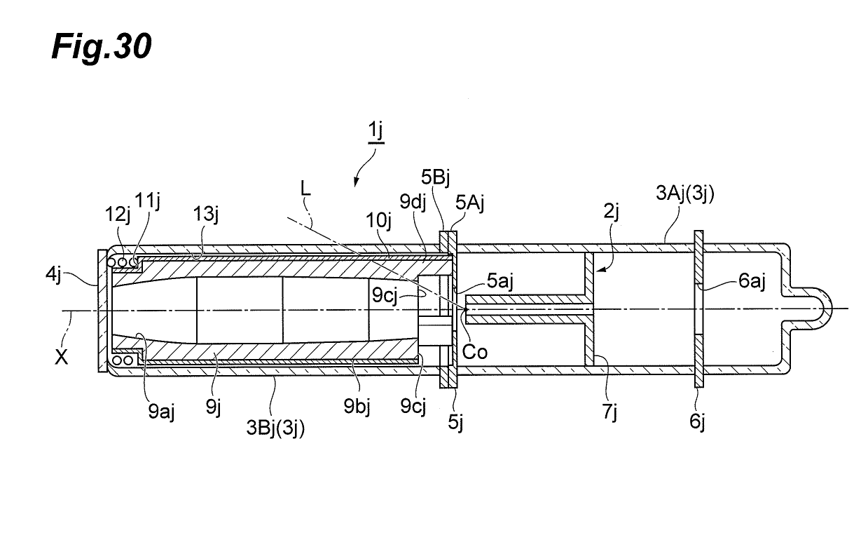

FIG. 30 is a sectional view showing a configuration of a light source according to the tenth embodiment of the present invention. The light source 1j shown in the same drawing is a so-called capillary discharge tube used as a light source for analytical equipment such as a photoionization source of a mass spectrometer or as a light source for vacuum electricity removal.

This light source 1j is provided with a hermetic container 3j of glass in which a luminescent cylinder (first housing) 3Aj of a substantially cylindrical shape housing a luminescent part 2j to induce discharge of gas to generate light, is integrally connected to a light guide cylinder (second housing) 3Bj of a substantially cylindrical shape kept in communication with the luminescent cylinder 3Aj and extending along the optical axis X of light emitted from the luminescent part 2j in the luminescent cylinder 3Aj. More particularly, the light guide cylinder 3Bj is connected to and kept in communication with the luminescent cylinder 3Aj on a one end side in the direction along the optical axis X and is sealed on the other end side by an exit window 4j to emit the light generated from the luminescent part 2j, to the outside. A material of this exit window 4j is, for example, MgF₂ (magnesium fluoride), LiF (lithium fluoride), or sapphire glass.

The luminescent part 2j housed in the luminescent cylinder 3Aj is composed of a cathode 5j, an anode 6j, and a capillary part 7j arranged between the anode 6j and the cathode 5j. An aperture 5aj and an aperture 6aj are formed in these cathode 5j and anode 6j, respectively. Then the cathode 5j, anode 6j, and capillary part 7j are held inside the luminescent cylinder 3Aj so that the central axes of these apertures 5aj, 6aj and the tube axis of the capillary part 7j agree with the tube axis of the luminescent cylinder 3Aj, i.e., with the optical axis X. Namely, the cathode 5j, anode 6j, and capillary part 7j are held so as to be arranged coaxially with each other by the luminescent cylinder 3Aj.

The cathode 5j also functions as a connection member as arranged at the position to separate the luminescent cylinder 3Aj and the light guide cylinder 3Bj from each other. Particularly, the cathode 5j has a double structure of a metal ring member 5Aj having the aperture 5aj formed therein and bonded as sealed to the luminescent cylinder 3Aj, and a metal ring member 5Bj bonded as sealed to the light guide cylinder 3Bj. This ring member 5Aj is provided with a receiving structure for positioning of reflective cylinder 9j by contact with an end of the reflective cylinder 9j as described below. The aperture 5aj of the ring member 5Aj herein serves as an exit port for extraction of the light generated in the luminescent part 2j, toward the light guide cylinder 3Bj and is provided so as to be opposed to the exit window 4j of the light guide cylinder 3Bj.

A gas such as hydrogen (H₂), xenon (Xe), argon (Ar), or krypton (Kr) is enclosed in the hermetic container 3j in which the luminescent cylinder 3Aj and the light guide cylinder 3Bj are connected. When a voltage is applied between the cathode 5j and the anode 6j in the luminescent part 2j, it induces ionization and discharge of the gas existing between them and resultant electrons are converged in the capillary part 7j to form a plasma state. This results in emitting light in the direction along the optical axis X toward the light guide cylinder 3Bj through the aperture 5aj from the interior of the capillary part 7j. For example, in the case where the enclosed gas is Kr and the material of the exit window 4j used is MgF₂, the light can be emitted at the wavelength of 117/122 nm; in the case where the enclosed gas is Ar and the material of the exit window 4j used is LiF, the light can be emitted at the wavelength of 105 nm.

A reflective cylinder (cylindrical member) 9j of a substantially cylindrical shape is inserted and fixed between the exit window 4j in the hermetic container 3j of this configuration and the cathode 5j connecting the luminescent cylinder 3Aj and the light guide cylinder 3Bj. This reflective cylinder 9j is a combination of metal block members of aluminum and is formed in a substantially cylindrical shape having an outside diameter smaller than an inside diameter of the light guide cylinder 3Bj.

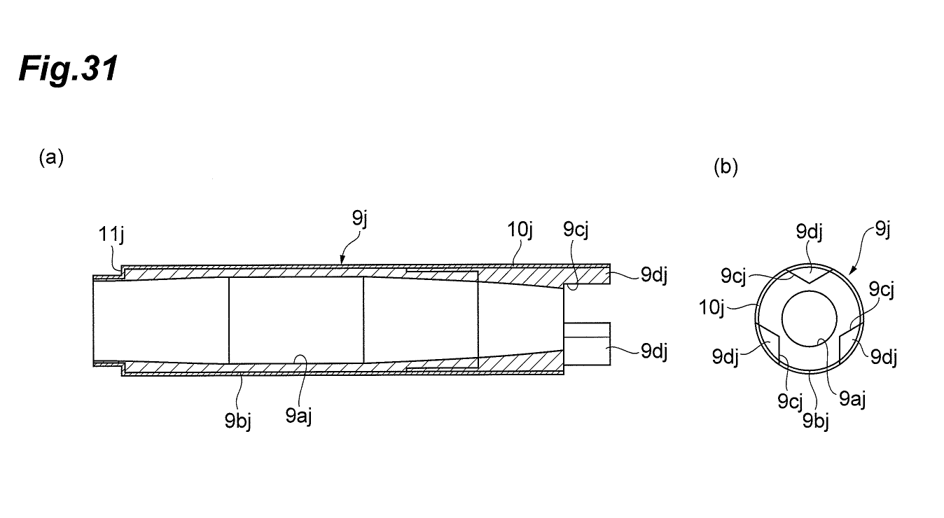

With reference to FIG. 31, an inner wall surface of the reflective cylinder 9j itself is formed as a reflective surface 9aj which is a curved surface along the central axis of the reflective cylinder 9j, or a multistep surface with inclination angles varying stepwise. Namely, this reflective surface 9aj is formed so that the two ends of the reflective cylinder 9j in the central-axis direction are tapered so as to be able to converge the light at a desired surface or point outside the exit window 4j. More specifically, the reflective surface 9aj is formed as inclined with respect to the central axis of the reflective cylinder 9j, i.e., with respect to the optical axis X so that the diameter of the space surrounded by the reflective surface 9aj gradually decreases from a longitudinal central region of the reflective cylinder 9j toward the end on the luminescent cylinder 3Aj side. Furthermore, the reflective surface 9aj is formed as inclined with respect to the central axis of the reflective cylinder 9j so that the diameter of the space surrounded by the reflective surface 9aj gradually decreases from the longitudinal central region of the reflective cylinder 9j toward the end on the exit window 4j side. The reflective surface 9aj is set at smaller angles of inclination to the optical axis X of the reflective surface 9aj than a line L connecting a luminescent center C₀ located at the center of the exit port of the capillary part 7j of the luminescent part 2j, and the end on the luminescent part 2j side of the reflective surface 9aj (FIG. 30). For example, the inclination angle of the reflective surface 9aj in the stage closest to the luminescent center C₀ side is set in the range of 2 to 15°, while the inclination angle of the line L to the optical axis X is in the range of 20 to 60°. The tapered structure of the reflective surface 9aj may be provided at either one of the two ends of the reflective cylinder 9j in the central-axis direction, instead of that at the two ends; for example, the reflective surface 9aj may be formed in the tapered shape as described above, only on the luminescent part 2j side (one end side), while the reflective surface 9aj is formed in parallel to the central axis of the reflective cylinder 9j on the exit window 4j side (the other end side).

This reflective surface 9aj is processed in a mirror surface state capable of regularly reflecting the light generated by the luminescent part 2j and is formed, for example, by cutting the metal block members, polishing an inner wall thereof by a polishing method such as buffing, chemical polishing, electropolishing, or a derivative thereof, or by a polishing method as a complex thereof, and thereafter subjecting the surface to a washing treatment or a vacuum treatment or the like to remove an impurity gas component. In the present embodiment the reflective cylinder 9j is composed of a combination of two members and, when the reflective surface 9aj is formed of a plurality of metal block members as in this configuration, a ratio of length and inside diameter (aspect ratio) of the reflective surface 9aj of each metal block member can be set smaller, so as to facilitate achievement of desired flatness during processing and shaping, thereby enhancing the mirror accuracy of the reflective surface 9aj.

Apertures 9cj cut along the central axis of the reflective cylinder 9j are formed toward the exit window 4j side (the other end side) of the outer wall surface 9bj, in the edge region on the luminescent cylinder 3Aj side (one end side) in the longitudinal direction of the outer wall surface 9bj of the reflective cylinder 9j. Particularly, the apertures 9cj are formed in three portions at equal intervals along the circumference on the one end side of the reflective cylinder 9j, and projections 9dj to be fitted in the receiving structure (which will be detailed later) provided in the cathode 5j of the luminescent part 2j are formed in three portions between the neighboring apertures 9cj.

Furthermore, a thermal radiation film 10j containing a material with high thermal emissivity is formed over almost the entire area of the outer wall surface 9bj of the reflective cylinder 9j. The material of this thermal radiation film 10j to be used is one with the thermal emissivity higher than that of the material of the reflective cylinder 9j, e.g., aluminum oxide. The thermal radiation film 10j is formed, for example, by depositing the material forming the thermal radiation film 10j, on the outer wall surface 9bj of the reflective cylinder 9j by evaporation, coating, or the like, but, particularly, in the case where the reflective cylinder 9j is made of aluminum as in the present embodiment, a layer of aluminum oxide as the thermal radiation film 10j may be formed by oxidizing the outer wall surface 9bj of the reflective cylinder 9j.

A cut portion 11j cut in a circular shape so as to form a stepped projection is formed along the outer wall surface 9bj, in a peripheral edge region on the longitudinal other end side of the outer wall surface 9bj of the reflective cylinder 9j. This cut portion 11j is provided for positioning the reflective cylinder 9j in the hermetic container 3j.

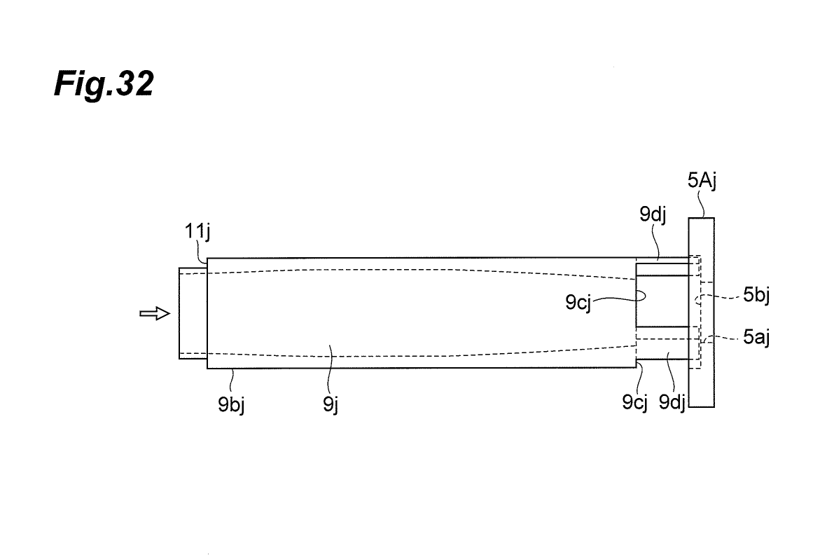

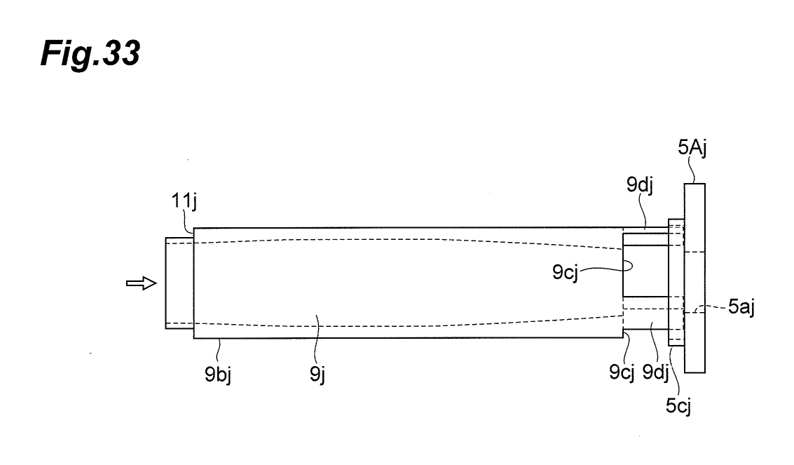

Returning to FIG. 30, the reflective cylinder 9j of this configuration is inserted along the tube axis (optical axis X) into the light guide cylinder 3Bj in a state in which the projections 9dj are in contact with the ring member 5Aj of the cathode 5j, and a spring member 12j is attached along the outer wall surface 9bj between the cut portion 11j and the exit window 4j. This spring member 12j is a member for positioning of the reflective cylinder 9j, which is comprised of a metal member, e.g., stainless steel or an Inconel material with high heat resistance. The reflective cylinder 9j is fitted in the receiving structure of the ring member 5Aj in a state in which the outer wall surface 9bj thereof is separated from the inner wall surface 13j of the light guide cylinder 3Bj. FIGS. 32 and 33 show examples of the receiving structure of the ring member 5Aj. As shown, the ring member 5Aj can be provided with a hole 5bj having the same diameter as the outside diameter of the reflective cylinder 9j so as to be coaxial with the aperture 5aj, or another ring fixing member 5cj having the same inside diameter as the outside diameter of the reflective cylinder 9j can be fixed so as to be coaxial with the aperture 5aj on the surface of the ring member 5Aj.

In the positioning structure of the reflective cylinder 9j as described above, the reflective cylinder 9j is urged along the optical axis X from the exit window 4j side toward the luminescent part 2j side by the spring member 12j to be pressed against the receiving structure of the cathode 5j. This results in positioning the reflective cylinder 9j in a state in which the projections 9dj on the one end side are in contact with the ring member 5Aj of the cathode 5j and the other end side is set in the light guide cylinder 3Bj to be located in proximity to the exit window 4j, between the exit window 4j and the cathode 5j in the hermetic container 3j. When the reflective cylinder 9j is fitted in the receiving structure of the ring member 5Aj, the plurality of apertures 9cj to penetrate to the reflective surface 9aj are arranged at the end of the outer wall surface 9bj of the reflective cylinder 9j located inside the luminescent cylinder 3Aj.

In assembly of the light source 1j, the ring member 5Aj and the ring member 5Bj of the cathode 5j are bonded as sealed to the luminescent cylinder 3Aj and to the light guide cylinder 3Bj, respectively. Then the reflective cylinder 9j is fitted into the receiving structure of the ring member 5Aj and the spring member 12j is attached to the cut portion 11j; thereafter, the reflective cylinder 9j is inserted into the light guide cylinder 3Bj, and the ring member 5Aj and the ring member 5Bj are stacked and vacuum-welded, thereby assembling the light source 1j.

In the light source 1j described above, discharge caused between the cathode 5j and the anode 6j of the luminescent part 2j in the luminescent cylinder 3Aj is narrowed by the capillary part 7j to generate light, and the light emitted through the aperture 5aj of the cathode 5j from the luminescent part 2j is guided to the interior of the reflective cylinder 9j inserted from the exit window 4j of the light guide cylinder 3Bj in communication with the luminescent cylinder 3Aj, to the luminescent part 2j, to be emitted from the exit window 4j. Since the reflective surface 9aj is formed on the inner wall surface of the reflective cylinder 9j, the light emitted from the luminescent part 2j is guided from the one end side to the other end side of the light guide cylinder 3Bj while being reflected by the reflective surface 9aj inside the reflective cylinder 9j; as a result, the light emitted from the luminescent part 2j can be guided to the exit window 4j of the light guide cylinder 3Bj, without loss. In conjunction therewith, since the two ends of the reflective surface 9aj are formed in the taper shape, the light can be converged at the predetermined position outside the exit window 4j. Furthermore, it is feasible to increase the extraction efficiency of light from the exit window 4j and thereby to increase the total light amount of emitted light and the light amount on the illumination target surface. The light radiation pattern from the exit window in the conventional discharge tubes varies according to the distance from the exit window and tends to cause an omission where the radiant light is weak, whereas the light source 1j can reduce the occurrence of the omission of the light radiation pattern. As a result, it is feasible to efficiently extract the generated light.

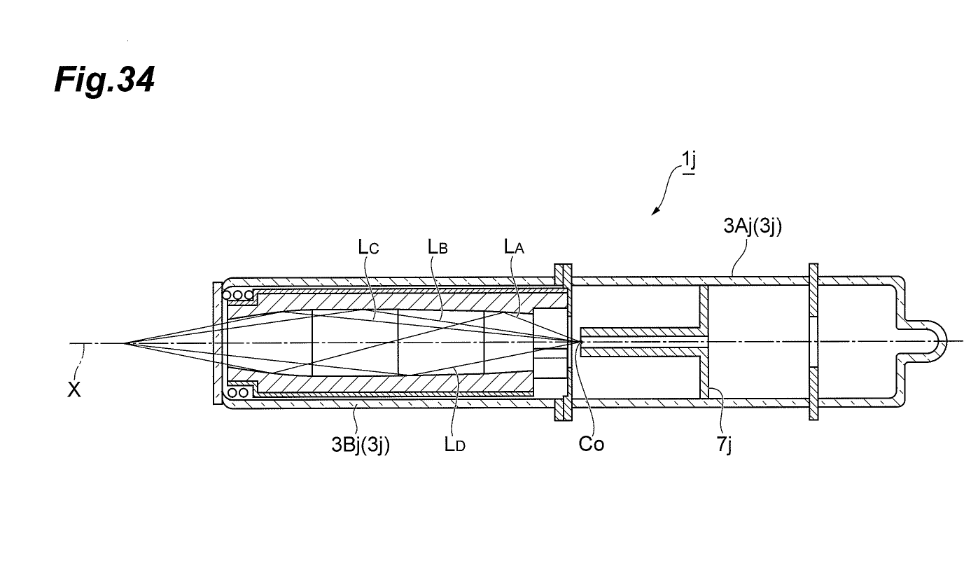

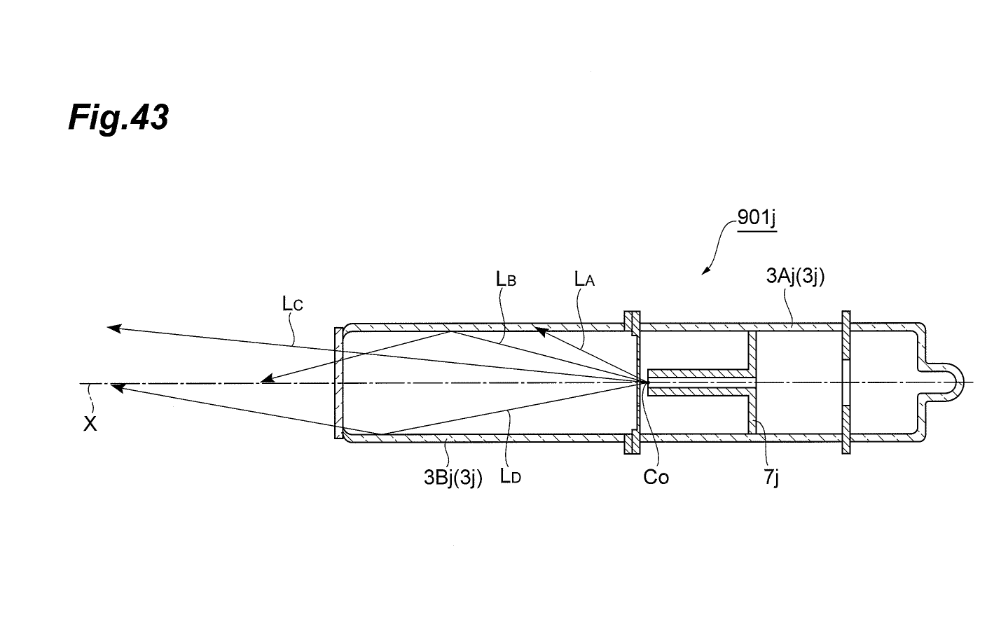

FIG. 34 is a drawing showing optical paths of light components in various light emission directions from the luminescent center C₀ in the light source 1j and FIG. 43 a drawing showing optical paths of light components in various light emission directions from the luminescent center C₀ in a light source 901j obtained by removing the reflective cylinder 9j from the light source 1j.

As shown in FIG. 43, the light component L_{A} with a large emission angle relative to the optical axis X is not totally reflected in the light source 901j but is transmitted or absorbed by the hermetic container 3j. In contrast to it, in the light source 1j as shown in FIG. 34, this light component L_{A} is also totally reflected by the reflective surface 9aj to function as a forward irradiation component, increasing an amount of radiant light. Furthermore, since the reflective surface 9aj on the luminescent center C₀ side is tapered, reflected light can be converged around a desired position from the exit window 4j without forming diverging components.

The light components L_{B}, L_{D}, which are reflected by the hermetic container 3j to become diverging light in the case of the light source 901j, can also be converged around the desired position in the case of the light source 1j. Furthermore, since the reflective surface 9ai is tapered on the exit window 4j side in the light source 1j, the light component L_{C}, which diverges from the exit window 4i in the case of the light source 901j because of a small emission angle relative to the optical axis X, can be used as a converging component and the light component L_{D} can be converged at an appropriate position around the desired position. As a result, the reflective surface 9aj of the reflective cylinder 9j can be formed in the structure capable of using many components of radiant light as converging components.

By adjusting the shape of the tapered portions in the reflective surface 9aj of the reflective cylinder 9j, the emitted light from the exit window 4j can also have a distribution with many parallel light components or a divergent distribution on the contrary, instead of the convergent distribution.

In addition, since the apertures 9cj are formed in the outer wall surface 9bj on the one end side of the reflective cylinder 9j, the sputtered substance generated in the luminescent part 2j can be discharged to the outside of the reflective cylinder 9j, which can prevent the sputtered substance from adhering to the reflective surface 9aj of the reflective cylinder 9j or to the exit window 4j which is a part at low temperature. As a result, the optical transmittance can be enhanced at the exit window 4j, while achieving extension of service life. Since the apertures 9cj are located near the luminescent cylinder 3Aj, the sputtered substance generated in the luminescent cylinder 3Aj becomes more likely to be discharged and captured near the luminescent cylinder 3Aj. As a result, it becomes feasible to further prevent scattering of the sputtered substance to the exit window 4j and thereby to further extend the service life.

Since the reflective cylinder 9j itself is comprised of the metal members such as the metal block members of aluminum to facilitate processing of the reflective surface with high mirror accuracy, the generated light can be effectively converged. Furthermore, for example, unlike the case where the reflective film of metal or the like is formed inside the reflective cylinder 9j, it is feasible to prevent the degradation of performance and the generation of foreign matter due to delamination or dropout or the like of the reflective surface 9aj caused by the difference between coefficients of expansion of the constituent materials with repetitions of increase and decrease of temperature, and thereby to achieve extension of service life.

Furthermore, since the outer wall surface 9bj of the reflective cylinder 9j is separated from the inner wall surface 13j of the light guide cylinder 3Bj and the axial length of the reflective cylinder 9j is shorter than the axial length of the light guide cylinder 3Bj, it is feasible to prevent breakage of the reflective cylinder 9j, the light guide cylinder 3Bj, the glass and window materials, and so on because of the difference of coefficients of thermal expansion between the reflective cylinder 9j and the light guide cylinder 3Bj.

Since the reflective cylinder 9j is urged into the receiving structure of the cathode 5j by the spring member 12j as the positioning member of the metal member to be positioned in the hermetic container 3j, it becomes easier to achieve the positioning and axial alignment of the reflective cylinder 9j relative to the capillary part 7j of the luminescent part 2j, so as to improve the position accuracy, which ensures sufficient extraction efficiency of light from the exit window 4j. Furthermore, by adopting the structure to push the reflective cylinder against the cathode 5j by the spring member 12j, the reflective cylinder 9j can be stably fixed relative to the hermetic container 3j and the spring member 12j can absorb positional deviation thereof relative to the luminescent cylinder 3Aj even with occurrence of thermal expansion along the central-axis direction of the reflective cylinder 9j. It can also be contemplated herein that the radiant light distribution is adjusted by aligning the positional and angular relations between the light guide cylinder 3Bj and the capillary part 7j during the sealing of the discharge tube, but it is difficult in this case to achieve position adjustment because of the large difference between the depth positions of the exit window 4j and the capillary part 7j. In the present embodiment, the reflective cylinder 9j is introduced to stably determine the positional relationship between the light guide cylinder 3Bj and the reflective cylinder 9j and the alignment between the reflective cylinder 9j and the cathode 5j results in also achieving alignment of the positional and angular relations between the reflective cylinder 9j and the capillary part 7j. Therefore, the positional relationship between the light guide cylinder 3Bj and the luminescent center is achieved with good accuracy.

Furthermore, since the thermal radiation film 10j is formed over almost the entire area of the outer wall surface 9bj of the reflective cylinder 9j, a region at lower temperature than the surroundings and the enclosed gas can be formed on the inner surface of the reflective cylinder 9j and the lower-temperature region can capture the foreign matter such as the sputtered substance from the luminescent cylinder 3Aj, so as to prevent the diffusion of the foreign matter to the exit window 4j and the reduction of optical transmittance caused thereby.

When the light source 1j of this configuration is used a photoionization source in a mass spectrometer (MS) such as a gas chromatography mass spectrometer (GC/MS) or a liquid chromatography mass spectrometer (LC/MS), it is feasible to achieve high sensitivity, prevent contamination of the window material, and achieve a good time response characteristic. Firstly, the light amount on the irradiation target surface can be drastically increased so as to improve a probability of contact with a sample, whereby the sensitivity can be improved to a large extent (nearly ten times) in comparison to the conventional photoionization sources. It also becomes feasible to achieve convergence of light suitable for a variety of MSs, and the measurement sensitivity is enhanced on the following points. Specifically, in the case of MS, the light can be focused on an effective portion of an electric field distribution for introducing ions to a discriminator in an ionization chamber. In the case of GC/MS, the light can be effectively focused and introduced through an aperture of about several mm of the ionization chamber. In the case of LC/MS, the light can be focused around an aperture to introduce ions into the discriminator, to enhance an ion density, and the window of the photoionization source can be located away from a sample ejection port to prevent contamination of the window, while avoiding degradation of sensitivity even at the distant location from the ionization source because of the enhancement of light convergence more than before. Namely, the high-density light is guided onto a high-density sample part to enhance ionization efficiency, thereby achieving high sensitivity; the window of the photoionization source is located away from the sample ejection port, thereby preventing contamination of the window; the light is focused on the sample ejection port, thereby increasing the response speed.

### Eleventh Embodiment

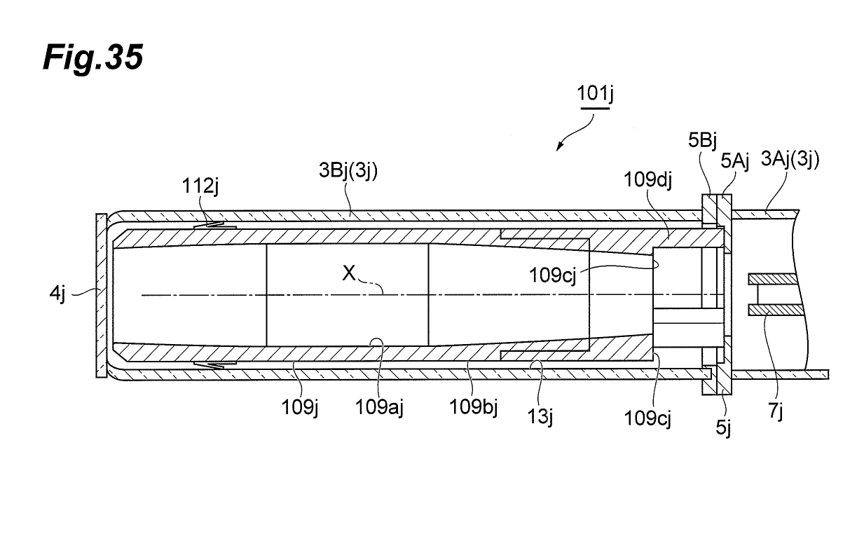

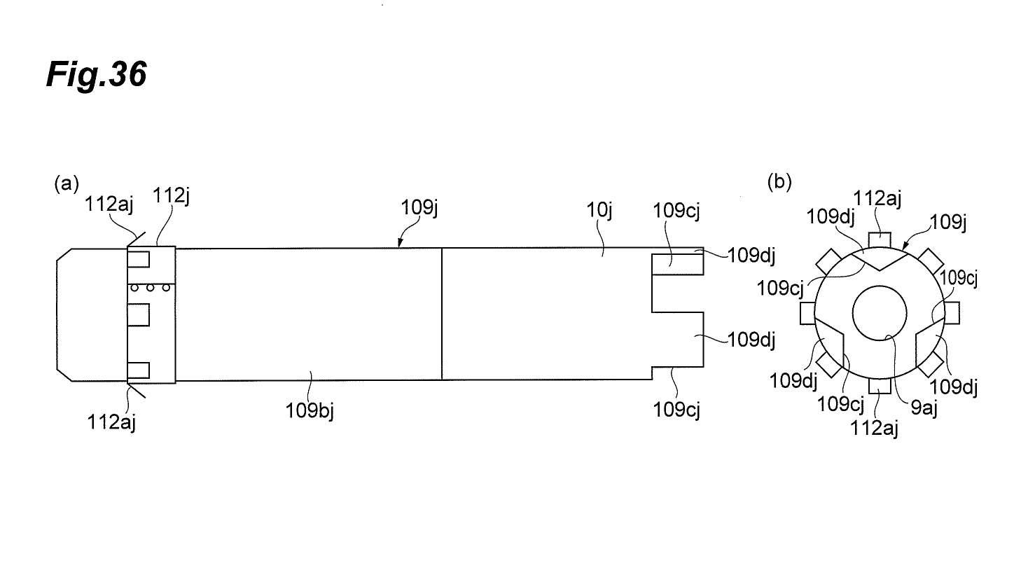

FIG. 35 is a sectional view showing a configuration of a light source according to the eleventh embodiment of the present invention, FIG. 36(a) a side view of a reflective cylinder in FIG. 35, and FIG. 36(b) an end view of the reflective cylinder in FIG. 35. The light source 101j shown in the same drawings is different mainly in the positioning structure of the reflective cylinder 109j from that in the tenth embodiment.

Specifically, a metal band 112j as a positioning member is fixed to the reflective cylinder 109j set inside the light source 101j, at an end of its outer wall surface 109bj on the exit window 4j side. In this metal band 112j, a plurality of claws 112aj with spring action are formed along the outer periphery of the reflective cylinder 109j, and the metal band 112j is welded at its end by lap welding to be fixed on the outer wall surface 109bj. This metal band 112j imparts a spring force along the central axis of the reflective cylinder 109j to the claws 112aj and the claws 112aj themselves also have spring forces in directions perpendicular to the central axis of the reflective cylinder 109j. The reflective cylinder 109j with the metal band 112j fixed thereto in this configuration is inserted into the hermetic container 3j along the inner wall surface 13j of the light guide cylinder 3Bj and is fixed so that the outer wall surface 109bj is separated from the inner wall surface 13j except for the metal band 112j.

In this structure, the reflective cylinder 109j is urged by the spring forces along the optical axis X of the claws 112aj of the metal band 112j so that the projections 109dj formed in its edge region are pressed against the ring member 5Aj of the cathode 5j, to be positioned in the direction along the optical axis X in the hermetic container 3j. In conjunction therewith, the reflective cylinder 109j is also positioned in the directions perpendicular to the optical axis X in a state in which the outer wall surface 109bj thereof and the inner wall surface 13j of the light guide cylinder 3Bj are separated from each other at a fixed distance, by the spring forces in the directions perpendicular to the optical axis X, of the claws 112aj of the metal band 112j. If a groove is formed in the width of the metal band in the region of the reflective cylinder 109j where the metal band 112j is mounted, the distance from the metal band 112j to the inner wall surface 13j of the light guide cylinder 3Bj can be set larger without increase in the inside diameter of the light guide cylinder 3Bj and angles of the claws 112aj can be increased, with the result of increase in the spring forces of the claws 112aj.

The light source 101j of this configuration can also prevent the positional deviation of the reflective cylinder 109j and the breakage of the reflective cylinder 109j or the light guide cylinder 3Bj, because of the difference of coefficients of thermal expansion between the reflective cylinder 109j and the light guide cylinder 3Bj. Since the reflective cylinder 109j is urged into the receiving structure of the cathode 5j by the metal band 112j as the positioning member to be positioned in the hermetic container 3j, it becomes easier to achieve the positioning and axial alignment of the reflective cylinder 9j relative to the capillary part 7j of the luminescent part 2j, so as to improve the position accuracy, which can ensure sufficient extraction efficiency of light from the exit window 4j. Particularly, in the present embodiment, the coaxiality of the reflective cylinder 9j and the light guide cylinder 3Bj can be maintained on a stable basis.

Since the two ends of the reflective surface 9aj are formed in the taper shape, the light can be efficiently extracted from the exit window 4j so as to be converged at the predetermined position outside the exit window 4j, and the light amount of emitted light can be increased on the illumination target surface. Since the thermal radiation film 10j is formed in part on the one end side of the outer wall surface 109bj of the reflective cylinder 109j, a portion at lower temperature than the surroundings and the enclosed gas can be formed inside the reflective cylinder 9j in close proximity to the luminescent part 2j and the lower-temperature portion can capture the foreign matter such as the sputtered substance from the luminescent cylinder 3Aj, so as to prevent the diffusion of the foreign matter to the exit window 4j and the reduction of optical transmittance caused thereby.

The present invention does not have to be limited to the above-described embodiments. For example, the reflective surface 9aj or 109aj was formed on the reflective cylinder 9j or 109j by polishing the inner wall of the metal members, but the reflective surface may be formed by evaporation or sputtering. Particularly, the reflective surface can be formed by preparing a base by cutting or molding of a metal member such as aluminum, or a member of glass, ceramic, or the like, polishing the base if necessary, and thereafter depositing an aluminum, rhodium, or dielectric multilayer film or the like on a mirror surface of the base by evaporation or sputtering. The reflective cylinder 9j or 109j was formed of a plurality of metal block members, but it may be formed as an integral body.

In the foregoing embodiments, the reflective cylinder 9j or 109j was fixed by pressing it against the receiving structure of the cathode 5j, but it may be fixed directly to the receiving structure by laser welding, spot welding, or the like. In this case, if it is difficult to weld the reflective cylinder directly to the fixing member, it is possible to adopt a method of fixing a weldable structure to the reflective cylinder by engagement or the like and welding the structure to the fixing member. In the case of the laser welding, it is also possible to perform the welding through the glass member of the luminescent cylinder 3Aj.

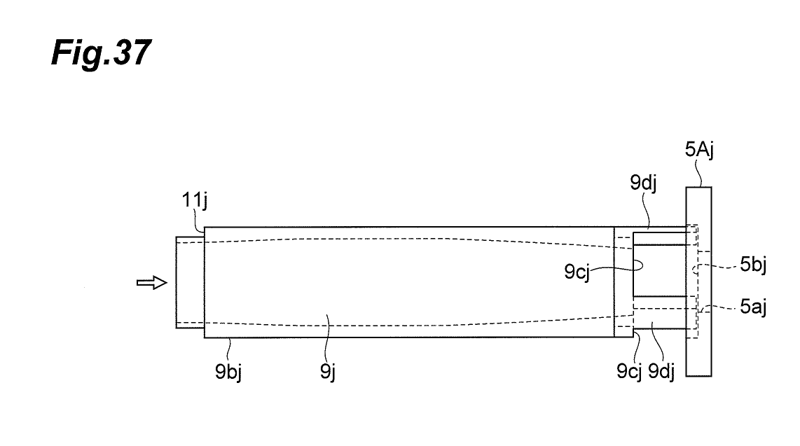

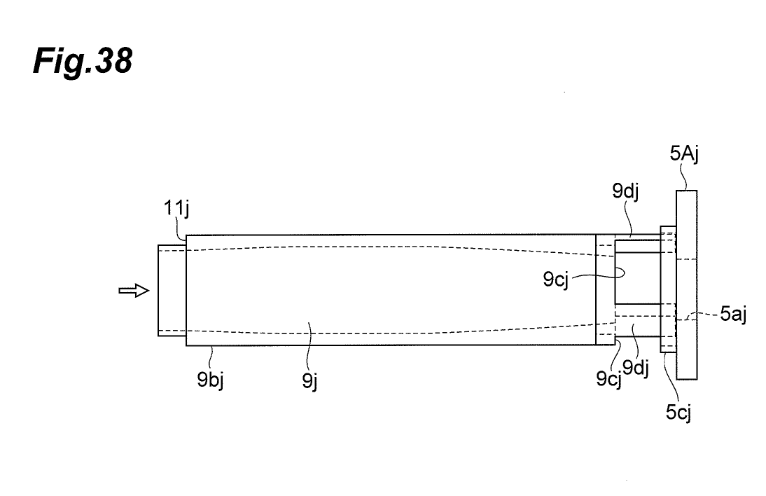

For example, FIGS. 37 and 38 show structures in which the reflective cylinder 9j is fixed to the receiving structure of the cathode 5j by laser welding or spot welding. Particularly, a tubular member of stainless steel with projections 9dj is fixed by press fitting or the like to one end side of the main body of the reflective cylinder 9j of aluminum and contact portions of the tubular member with the hole 5bj of the cathode 5j or with the fixing member 5cj are fused and secured to each other by laser welding or spot welding.

A variety of shapes can be adopted for the structure for welding fixed at the tip of the reflective cylinder 9j.

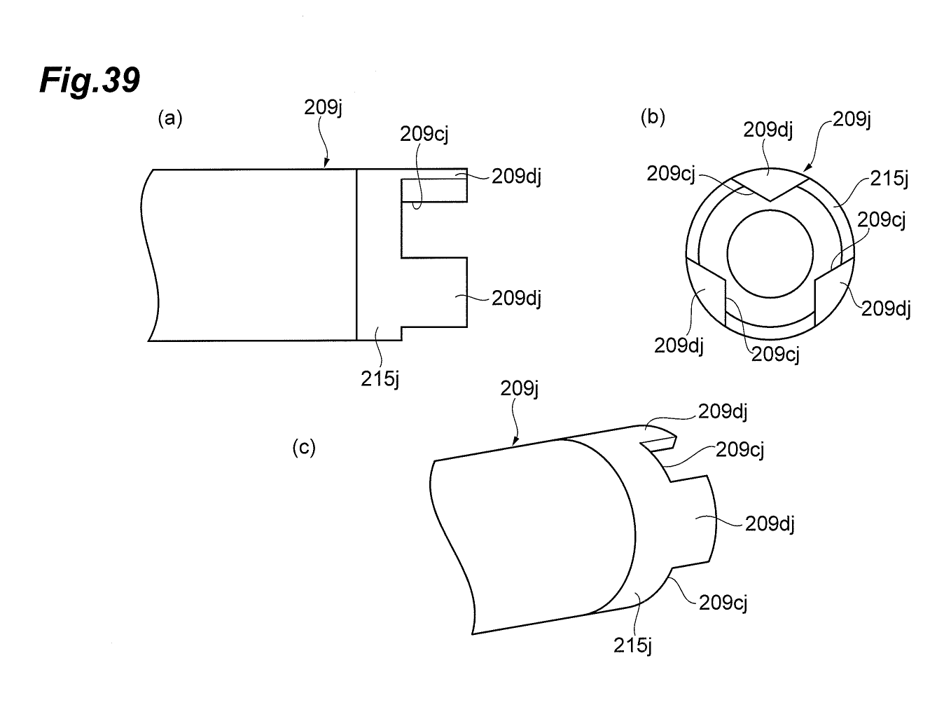

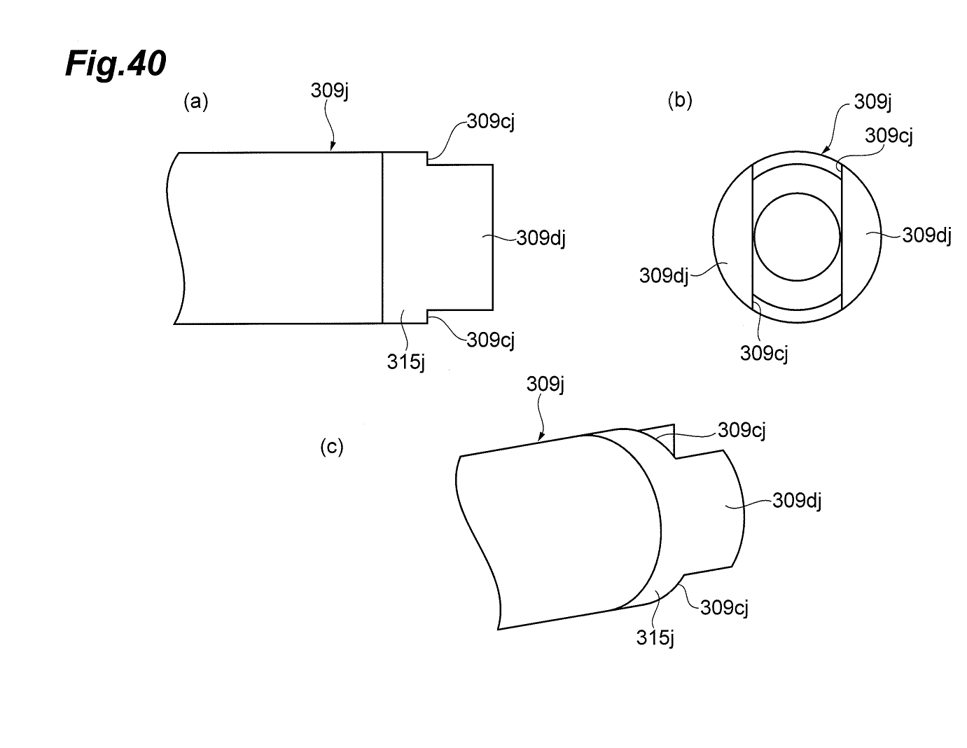

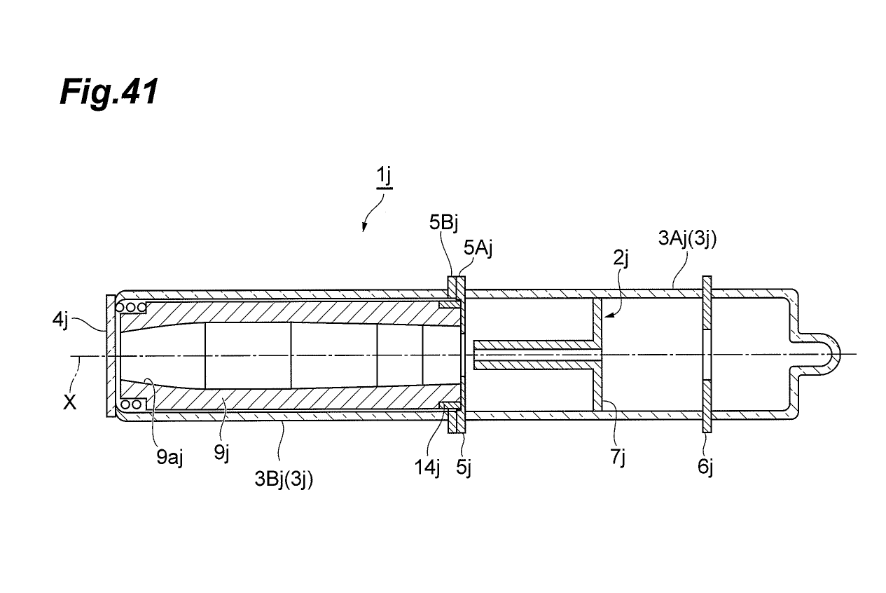

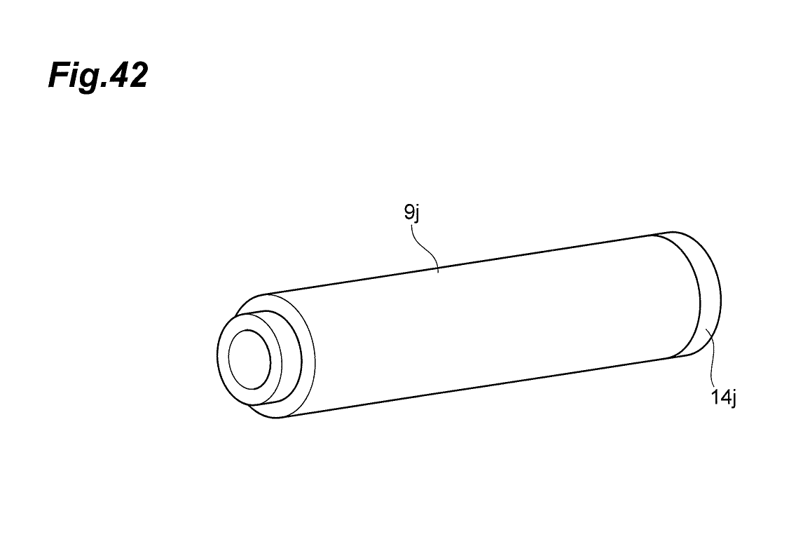

For example, like reflective cylinders 209j, 309j according to modification examples of the present invention shown in FIGS. 39 and 40, a stainless steel structure 215j or 315j with apertures 209cj, 309cj and projections 209dj, 309dj is forced into and fixed to the main body part of the reflective cylinder 209j, 309j and it is welded to the receiving structure of the cathode 5j. In another example, as shown in FIGS. 41 and 42, where the reflective cylinder 9j has no apertures, only an end ring 14j of stainless steel similarly without apertures is pressed thereinto and contact portions between the end ring 14j and the hole 5bj of the cathode 5j or the fixing member 5cj are welded to be fixed.

Instead of the fixing method by the welding between the cathode 5j and the receiving structure as described above, it is also possible to adopt a method of directly tapping the receiving structure and the reflective cylinder and screwing them, a method of tapping the receiving structure in the peripheral direction thereof and fixing them with screws.

The thermal radiation film 10j is formed in part or in whole of the outer wall surface 9bj or 109bj of the reflective cylinder 9j or 109j in the light source 1j or 101j, but, conversely, a material with the thermal emissivity lower than that of the material of the reflective cylinder 9j or 109j may be formed on the other end side of the outer wall surface 9bj or 109bj. This configuration relatively enhances heat radiation on the one end side and is expected to provide the same effect as the thermal radiation film 10j. The material of the metal block member forming the one end side of the reflective cylinder 9j or 109j may be comprised of a material with the thermal emissivity larger than that of the material of the metal block member forming the other end side.

### Twelfth Embodiment

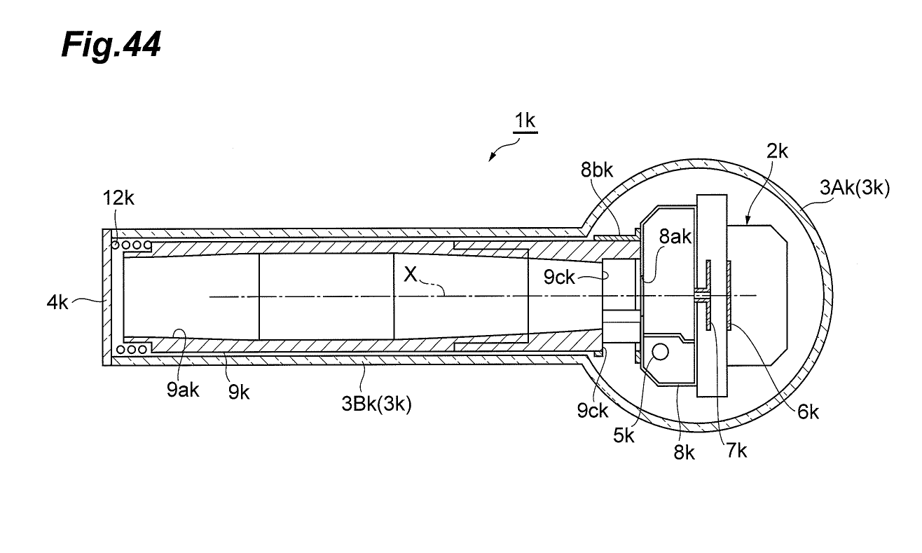

FIG. 44 is a sectional view showing a configuration of a light source according to the twelfth embodiment of the present invention. The light source 1k shown in the same drawing is a so-called deuterium lamp used as a light source for analytical equipment such as a photoionization source of a mass spectrometer or as a light source for vacuum electricity removal.

This light source 1k is provided with a hermetic container 3k of glass in which a luminescent cylinder (first housing) 3Ak of a substantially cylindrical shape housing a luminescent part 2k to induce discharge of deuterium gas to generate light, is integrally connected to a light guide cylinder (second housing) 3Bk of a substantially cylindrical shape kept in communication with the luminescent cylinder 3Ak and projecting along the optical axis X of light generated by the luminescent part 2k, from the side wall of the luminescent cylinder 3Ak. In this hermetic container 3k deuterium gas is enclosed under the pressure of about several hundred Pa. More specifically, the light guide cylinder 3Bk is integrated in communication with the luminescent cylinder 3Ak on a one end side in the direction along the optical axis X and is sealed on the other end side by an exit window 4k to emit the light generated from the luminescent part 2k, to the outside. A material of this exit window 4k is, for example, MgF₂ (magnesium fluoride), LiF (lithium fluoride), silica glass, or sapphire glass.

The luminescent part 2k housed in the luminescent cylinder 3Ak is composed of a cathode 5k, an anode 6k, a discharge path limiter 7k arranged between the anode 6k and the cathode 5k and having an aperture formed in a central region, and a housing case 8k arranged so as to surround these. In a surface of this housing case 8k on the light guide cylinder 3Bk side, a light passage port Bak of a rectangular shape for extraction of the light generated by the luminescent part 2k is formed so as to face the exit window 4k of the light guide cylinder 3Bk and, a fixing ring 8bk consisting of a wall part extending in a circular shape along the side wall of the light guide cylinder 3Bk is fixed so as to surround the light passage port 8ak. When a voltage is applied between the cathode 5k and the anode 6k, the luminescent part 2k induces ionization and discharge of the deuterium gas existing between them, to form a plasma state and the discharge path limiter 7k narrows it into a high-density plasma state, thereby to generate light (ultraviolet light), which is emitted from the light passage port Bak of the housing case 8k into the direction along the optical axis X.

The foregoing luminescent part 2k is held in the luminescent cylinder 3Ak by a stem pin (not shown) standing on a stem part disposed on an end face of the luminescent cylinder 3Ak. Namely, this light source 1k is a side-on type light source in which the optical axis X intersects with the tube axis of the luminescent cylinder 3Ak.

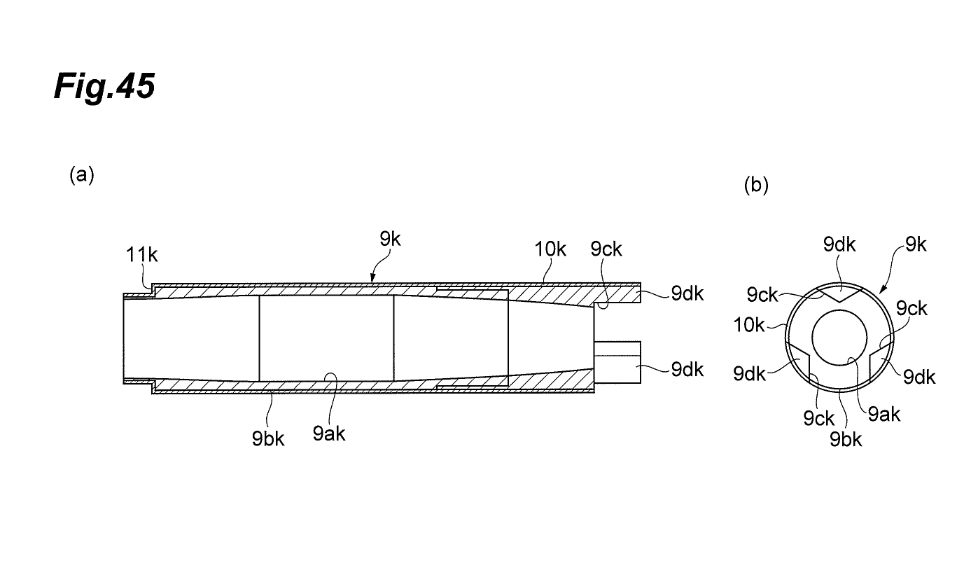

A reflective cylinder (cylindrical member) 9k of a substantially cylindrical shape is inserted and fixed between the exit window 4k in the hermetic container 3k of this configuration and a portion connecting the luminescent cylinder 3Ak and the light guide cylinder 3Bk. This reflective cylinder 9k is, as shown in FIG. 45, a combination of metal block members of aluminum and is formed in a substantially cylindrical shape having an outside diameter smaller than an inside diameter of the light guide cylinder 3Bk.

An inner wall surface of the reflective cylinder 9k itself is formed as a reflective surface 9ak which is a curved surface along the central axis of the reflective cylinder 9k, or a multistep surface with inclination angles varying stepwise. Namely, this reflective surface 9ak is formed so that the two ends of the reflective cylinder 9k in the central-axis direction are tapered so as to be able to converge the light at a desired surface or point outside the exit window 4k. More specifically, the reflective surface 9ak is formed as inclined with respect to the central axis of the reflective cylinder 9k, i.e., with respect to the optical axis X so that the diameter of the space surrounded by the reflective surface 9ak gradually decreases from a longitudinal central region of the reflective cylinder 9k toward the end on the luminescent cylinder 3Ak side. Furthermore, the reflective surface 9ak is formed as inclined with respect to the central axis of the reflective cylinder 9k so that the diameter of the space surrounded by the reflective surface 9ak gradually decreases from the longitudinal central region of the reflective cylinder 9k toward the end on the exit window 4k side. The tapered structure of the reflective surface 9ak may be provided at either one of the two ends of the reflective cylinder 9k in the central-axis direction, instead of that at the two ends; for example, the reflective surface 9ak may be formed in the tapered shape as described above, only on the luminescent part 2k side (one end side), while the reflective surface 9ak is formed in parallel to the central axis of the reflective cylinder 9k on the exit window 4k side (the other end side). This reflective surface 9ak is set so as to be able to converge the light at the desired surface or point or diverge the light. This reflective surface 9ak is processed in a mirror surface state capable of regularly reflecting the light generated by the luminescent part 2k and is formed, for example, by cutting the metal block members, polishing an inner wall thereof by a polishing method such as buffing, chemical polishing, electropolishing, or a derivative thereof, or by a polishing method as a complex thereof, and thereafter subjecting the surface to a washing treatment or a vacuum treatment or the like to remove an impurity gas component. In the present embodiment the reflective cylinder 9k is composed of a combination of two members and, when the reflective surface 9ak is formed of a plurality of metal block members as in this configuration, a ratio of length and inside diameter (aspect ratio) of each metal block member can be set smaller, so as to facilitate achievement of desired flatness during processing and shaping, thereby enhancing the mirror accuracy of the reflective surface 9ak.

Apertures 9ck cut along the central axis of the reflective cylinder 9k are formed toward the other end side of the outer wall surface 9bk, in the edge region on the longitudinal one end side of the outer wall surface (side face) 9bk of the reflective cylinder 9k. Since the apertures 9ck are made by cutting in this manner, it is easy to process the apertures. Particularly, the apertures 9ck are formed in three portions at equal intervals along the peripheral edge on the one end side of the reflective cylinder 9k and projections 9dk to be fitted in the fixing ring 8bk of the luminescent part 2k are formed in three portions between the neighboring apertures 9ck. Since the projections 9dk are also disposed at equal intervals as a result of the formation of the apertures 9ck at equal intervals, it is also feasible to ensure the strength of the projections 9dk themselves and the strength during fixing as well.

Furthermore, a thermal radiation film 10k containing a material with high thermal emissivity is formed over almost the entire area of the outer wall surface 9bk of the reflective cylinder 9k. The material of this thermal radiation film 10k to be used is one with the thermal emissivity higher than that of the material of the reflective cylinder 9k, e.g., aluminum oxide. The thermal radiation film 10k is formed, for example, by depositing the material forming the thermal radiation film 10k, on the outer wall surface 9bk of the reflective cylinder 9k by evaporation, coating, or the like, but, particularly, in the case where the reflective cylinder 9k is made of aluminum as in the present embodiment, a layer of aluminum oxide as the thermal radiation film 10k may be formed by oxidizing the outer wall surface 9bk of the reflective cylinder 9k.

A cut portion 11k cut in a circular shape so as to form a stepped projection is formed along the outer wall surface 9bk, in a peripheral edge region on the longitudinal other end side of the outer wall surface 9bk of the reflective cylinder 9k. This cut portion 11k is provided for positioning the reflective cylinder 9k in the hermetic container 3k.

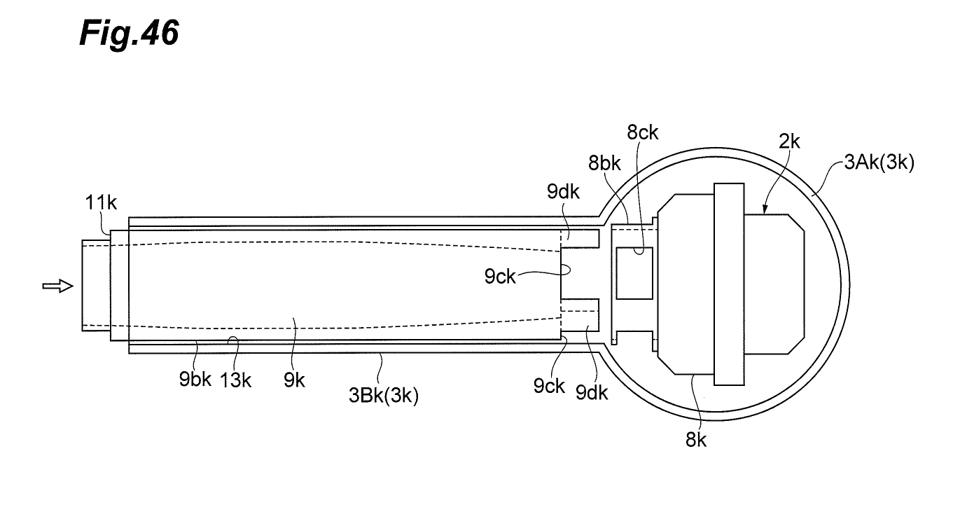

The reflective cylinder 9k of this configuration is inserted along the tube axis (optical axis X) of the light guide cylinder 3Bk from the edge region on the one end side where the apertures 9ck are formed, until the projections 9dk come into contact with the housing case 8k of the luminescent part 2k and, after a spring member 12k is attached along the outer wall surface 9bk to the cut portion 11k, the other end side of the light guide cylinder 3Bk is sealed by the exit window 4k (FIG. 44 and FIG. 46). At this time, the reflective cylinder 9k is fitted into the fixing ring 8bk of the housing case 8k in a state in which the outer wall surface 9bk thereof is separated from the inner wall surface 13k of the light guide cylinder 3Bk (FIG. 46). This spring member 12k is a member for positioning of the reflective cylinder 9k, which is comprised of a metal member, e.g., stainless steel or an Inconel material with high thermal resistance, and which is arranged between the cut portion Ilk and the exit window 4k, with a function to urge the reflective cylinder 9k from the exit window 4k side toward the luminescent part 2k along the optical axis X, thereby to press the reflective cylinder 9k against the housing case 8k. By this, the reflective cylinder 9k is positioned in a state in which the projections 9dk on the one end side are in contact with the housing case 8k of the luminescent part 2k and the other end side is inserted in the light guide cylinder 3Bk and located in close proximity to the exit window 4k, between the exit window 4k and the luminescent part 2k in the hermetic container 3k. Furthermore, apertures 8ck are formed at positions corresponding to the apertures 9ck of the reflective cylinder 9k, in the fixing ring 8bk of the housing case 8k and, when the reflective cylinder 9k is fitted into the fixing ring 8bk of the housing case 8k, the plurality of apertures 9ck to penetrate to the reflective surface 9ak are arranged in communication with the interior space of the luminescent cylinder 3Ak through the apertures 8ck, at the end of the outer wall surface 9bk of the reflective cylinder 9k located in the luminescent cylinder 3Ak.

In the light source 1k described above, the light emitted from the luminescent part 2k in the luminescent cylinder 3Ak is guided to the interior of the cylindrical reflective cylinder 9k inserted from the light guide cylinder 3Bk in communication with the luminescent cylinder 3Ak to the luminescent part 2k, thereby to be emitted from the exit window 4k provided in the light guide cylinder 3Bk. Since the reflective surface 9ak is formed on the inner wall surface of the reflective cylinder 9k herein, the light emitted from the luminescent part 2k is guided from the one end side to the other end side of the light guide cylinder 3Bk while being reflected by the reflective surface 9ak inside the reflective cylinder 9k, so that the light emitted from the luminescent part 2k can be guided to the exit window 4k of the light guide cylinder 3Bk, without loss. At this time, by properly setting the inclination angles of the reflective surface 9ak, the output light outside the exit window 4k can be distributed as any of parallel light, diverging light, and converging light and uniformity of light intensity can be enhanced on a predetermined illumination target surface. In conjunction therewith, the efficiency of extraction of the light from the exit window 4k improves, so as to increase the total light amount of the output light and the light amount on the illumination target surface. In the case of the conventional deuterium lamps, the light radiation pattern from the exit window tends to vary according to the distance from the exit window to cause an omission where radiant light is weak, whereas the light source 1k achieves reduction in occurrence of such an omission of the light radiation pattern.

In addition, since the apertures 9ck are formed in the outer wall surface 9bk (side face) on the one end side of the reflective cylinder 9k and the apertures 8ck are also formed at the corresponding positions in the fixing ring 8bk, the sputtered substance generated in the luminescent part 2k can be discharged to the outside of the reflective cylinder 9k, which can prevent the sputtered substance from adhering to the reflective surface 9ak of the reflective cylinder 9k and to the exit window 4k which is a part at low temperature. As a result, the optical transmittance can be enhanced at the exit window 4k, while achieving extension of service life. Since the apertures 9ck are located in the luminescent cylinder 3Ak, the sputtered substance generated in the luminescent part 2k becomes more likely to be discharged and captured in the luminescent cylinder 3Ak. As a result, it becomes feasible to further prevent scattering of the sputtered substance to the exit window 4k and thereby to further extend the service life.

Since the reflective cylinder 9k itself is comprised of the metal members such as the metal block members of aluminum, it becomes easier to process the reflective surface with high mirror accuracy and thus the generated light can be effectively converged. Furthermore, for example, unlike the case where a reflective film of metal or the like is formed inside the reflective cylinder 9k, it is feasible to prevent degradation of performance and generation of foreign matter due to delamination or dropout or the like of the reflective surface 9ak caused by a difference between coefficients of expansion of the constituent materials with repetitions of increase and decrease of temperature, and thereby to achieve extension of service life. In addition, the generated ultraviolet light is not transmitted, and deterioration due to the ultraviolet light is not caused, thereby achieving more efficient extraction of the generated light.

Furthermore, since the outer wall surface 9bk of the reflective cylinder 9k is separated from the inner wall surface 13k of the light guide cylinder 3Bk, it is feasible to prevent the positional deviation of the reflective cylinder 9k and breakage of the reflective cylinder 9k or the light guide cylinder 3Bk, because of a difference of coefficients of thermal expansion between the reflective cylinder 9k and the light guide cylinder 3Bk.

Since the reflective cylinder 9k is urged by the spring member 12k as the positioning member of the metal member to be fitted into the fixing ring 8bk of the housing case 8k so as to be positioned in the hermetic container 3k, it is not deteriorated by the generated ultraviolet light, whereby the position of the reflective cylinder 9k is kept stable relative to the hermetic container 3k, so as to maintain the extraction efficiency of light from the exit window 4k. By adopting the structure to push the reflective cylinder against the housing case 8k by the spring member 12k, it is feasible to stably fix the reflective cylinder 9k relative to the hermetic container 3k and to absorb positional deviation thereof relative to the luminescent cylinder 3Ak by the spring member 12k even with occurrence of thermal expansion along the central-axis direction of the reflective cylinder 9k.

Furthermore, since the thermal radiation film 10k is formed over almost the entire area of the outer wall surface 9bk of the reflective cylinder 9k, as shown in FIG. 45, a region at lower temperature than the surroundings and the enclosed gas can be formed on the inner surface of the reflective cylinder 9k, and the lower-temperature region can capture the foreign matter such as sputtered substance from the luminescent cylinder 3Ak, so as to prevent the foreign matter from diffusing and attaching to the exit window 4k and prevent reduction of optical transmittance caused thereby.

When the light source 1k of this configuration is used a photoionization source in a mass spectrometer (MS) such as a gas chromatography mass spectrometer (GC/MS) or a liquid chromatography mass spectrometer (LC/MS), it is feasible to achieve high sensitivity, prevent contamination of the window material, and achieve a good time response characteristic. Firstly, the light amount on the irradiation target surface can be drastically increased so as to improve a probability of contact with a sample, whereby the sensitivity can be improved to a large extent (nearly ten times) in comparison to the conventional photoionization sources. It also becomes feasible to achieve convergence of light suitable for a variety of MSs, and the measurement sensitivity is enhanced on the following points. Specifically, in the case of MS, the light can be focused on an effective portion of an electric field distribution for introducing ions to a discriminator in an ionization chamber. In the case of GC/MS, the light can be effectively focused and introduced through an aperture of about several mm of the ionization chamber. In the case of LC/MS, the light can be focused around an aperture to introduce ions into the discriminator, to enhance an ion density, and the window of the photoionization source can be located away from a sample ejection port to prevent contamination of the window, while avoiding degradation of sensitivity even at the distant location from the ionization source because of the enhancement of light convergence more than before. Namely, the high-density light is guided onto a high-density sample part to enhance ionization efficiency, thereby achieving high sensitivity; the window of the photoionization source is located away from the sample ejection port, thereby preventing contamination of the window; the light is focused on the sample ejection port, thereby increasing the response speed.

### Thirteenth Embodiment

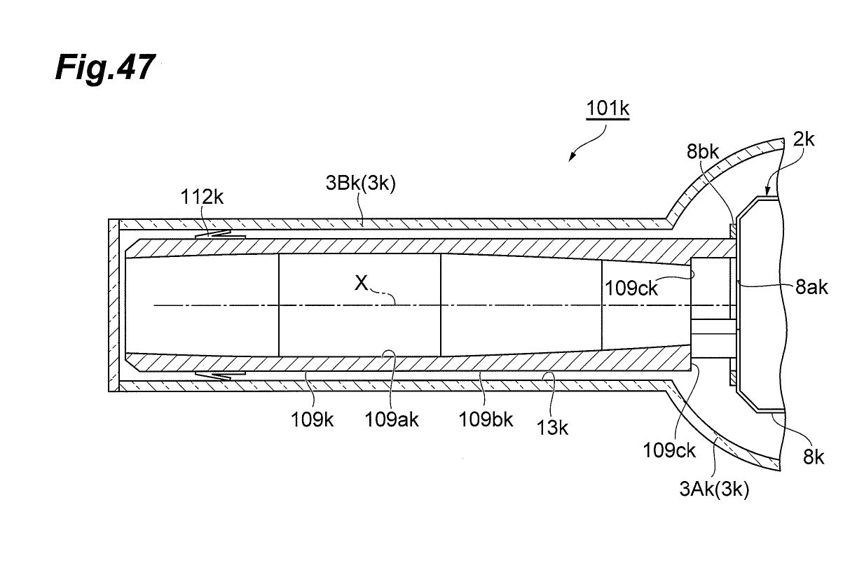

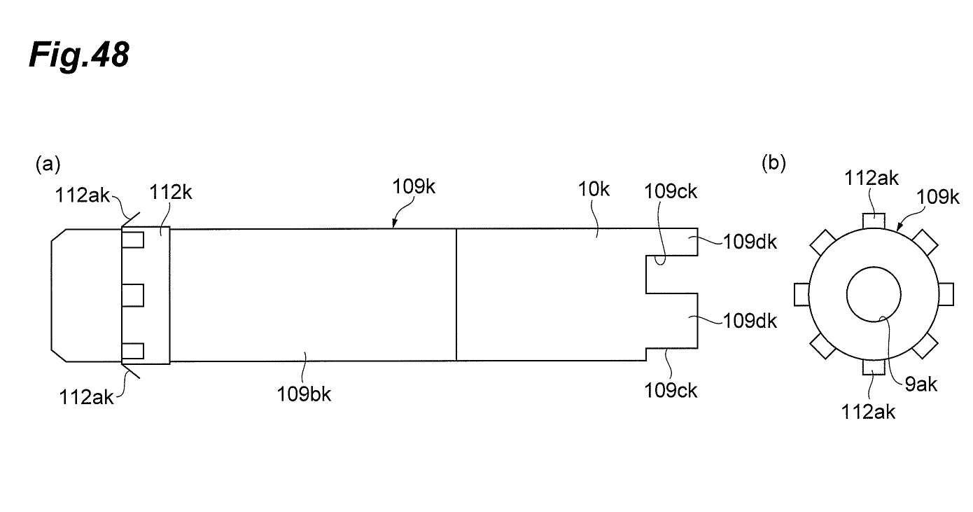

FIG. 47 is a sectional view showing a configuration of a light source according to the thirteenth embodiment of the present invention, FIG. 48(a) a side view of a reflective cylinder in FIG. 47, and FIG. 48(b) an end view of the reflective cylinder in FIG. 47. The light source 101k shown in the same drawings is different mainly in the positioning structure of the reflective cylinder 109k from that in the twelfth embodiment.

Specifically, a metal band 112k as a positioning member is fixed to the reflective cylinder 109k set inside the light source 101k, at an end of its outer wall surface 109bk on the exit window 4k side. In this metal band 112k, a plurality of claws 112ak with spring action are formed along the outer periphery of the reflective cylinder 109k, and the metal band 112k is welded at its end by lap welding to be fixed on the outer wall surface 109bk. The reflective cylinder 109k of this configuration is inserted into the hermetic container 3k along the inner wall surface 13k of the light guide cylinder 3Bk and is fixed so that the outer wall surface 109bk is separated from the inner wall surface 13k except for the metal band 112k. In this structure, the reflective cylinder 109k is urged against the housing case 8k by spring forces of the claws 112ak of the metal band 112k in a state in which the projections 109dk formed at the end thereof are fitted in the aperture of the fixing ring 8bk of the flat plate shape welded to the housing case 8k, to be positioned in the direction along the optical axis X in the hermetic container 3k. In conjunction therewith, the reflective cylinder 109k is also positioned in the directions perpendicular to the optical axis X in a state in which the outer wall surface 109bk thereof and the inner wall surface 13k of the light guide cylinder 3Bk are separated from each other at a fixed distance, by the claws 112ak of the metal band 112k. If a groove is formed in the width of the metal band in the region of the reflective cylinder 109k where the metal band 112k is mounted, the distance from the metal band 112k to the inner wall surface 13k of the light guide cylinder 3Bk can be set larger without increase in the inside diameter of the light guide cylinder 3Bk and angles of the claws 112ak can be increased, with the result of increase in the spring forces of the claws 112ak.

The light source 101k of this configuration can also prevent the positional deviation of the reflective cylinder 109k and the breakage of the reflective cylinder 109k or the light guide cylinder 3Bk, because of the difference of coefficients of thermal expansion between the reflective cylinder 109k and the light guide cylinder 3Bk. Since the reflective cylinder 109k is urged into the fixing ring 8bk of the housing case 8k by the metal band 112k as the positioning member to be positioned in the hermetic container 3k, it becomes feasible to stabilize the position of the reflective cylinder 109k relative to the hermetic container 3k and thereby to ensure sufficient extraction efficiency of light from the exit window 4k.

Moreover, since the apertures 109ck are formed in the outer wall surface 109bk (side face) on the one end side of the reflective cylinder 109k and the apertures are exposed without being blocked by the fixing ring 8bk, the sputtered substance generated in the luminescent cylinder 3Ak can be discharged to the outside of the reflective cylinder 109k, which can prevent the sputtered substance from adhering to the reflective surface 109ak of the reflective cylinder 109k and to the exit window 4k which is a part at low temperature.

### Fourteenth Embodiment

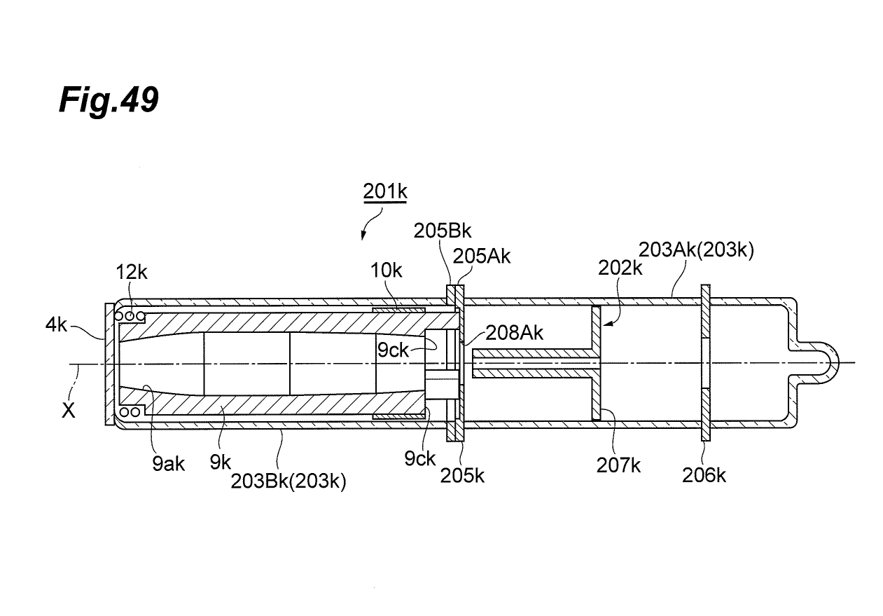

FIG. 49 is a sectional view showing a configuration of a light source according to the fourteenth embodiment of the present invention. The light source 201k shown in the same drawing is an example of application of the present invention to a capillary discharge tube.

The light source 201k is provided with a hermetic container 203k of glass in which a luminescent cylinder 203Ak and a light guide cylinder 203Bk are connected. Enclosed in this luminescent cylinder 203Ak is a luminescent part 202k composed of a cathode 205k, an anode 206k, and a capillary 207k arranged between the anode 206k and the cathode 205k. A gas such as hydrogen (H₂), xenon (Xe), argon (Ar), or krypton (Kr) is enclosed in the hermetic container 203k. When a voltage is applied between the cathode 205k and the anode 206k, the luminescent part 202k of this configuration induces ionization and discharge of the gas existing between them, and electrons are converged in the capillary 207k to form a plasma state, whereby light is emitted along the optical axis X toward the light guide cylinder 203Bk. For example, in the case where the enclosed gas is Kr and the material of the exit window 4k used is MgF₂, the light can be emitted at the wavelength of 117/122 nm; in the case where the enclosed gas is Ar and the material of the exit window 4k used is LiF, the light can be emitted at the wavelength of 105 nm.

This cathode 205k also functions as a connection member arranged at the part to separate the luminescent cylinder 203Ak and the light guide cylinder 203Bk from each other. Particularly, the cathode 205k consists of a double structure of a fixing ring member 205Ak formed so as to be opposed to the exit window 4k of the light guide cylinder 203Bk and provided with a depression of a size matched with the outside diameter shape of the reflective cylinder 9k, for positioning of the reflective cylinder 9k, and a sealing ring 205Bk bonded as sealed to the light guide cylinder 203Bk and engaged with the fixing ring 205Ak to be joined in a vacuum-retainable state. Another member may be attached as a member for positioning of the reflective cylinder 9k, to the cathode 205k.

For incorporating the reflective cylinder 9k into the hermetic container 203k of the light source 201k as described above, the fixing ring member 205Ak and the sealing ring 205Bk of the cathode 205k are joined to the luminescent cylinder 203Ak and to the light guide cylinder 203Bk, respectively. Then the reflective cylinder 9k is inserted so as to be separated from the inner wall surface of the light guide cylinder 203Bk while being fitted into the fixing ring 205Ak, and thereafter the fixing ring member 205Ak and the sealing ring 205Bk are stacked and joined in a vacuum-retainable state to be assembled. Another available assembly method is such that after the reflective cylinder 9k is welded and fixed to the cathode 205k, the light guide cylinder 203Bk is joined in a vacuum-retainable state to the cathode 205k.

The light source 201k of this configuration can also prevent the positional deviation of the reflective cylinder 9k and the breakage of the reflective cylinder 9k or the light guide cylinder 203Bk, because of the difference of coefficients of thermal expansion between the reflective cylinder 9k and the light guide cylinder 203Bk. Since the reflective cylinder 9k is urged into the fixing ring 205Ak of the cathode 205k by the spring member 12k as the positioning member to be positioned in the hermetic container 203k, it is feasible to stabilize the position of the reflective cylinder 9k relative to the hermetic container 203k and ensure sufficient extraction efficiency of light from the exit window 4k.

Furthermore, since the apertures 9ck are formed on the one end side of the reflective cylinder 9k, the sputtered substance generated in the luminescent cylinder 203Ak can be discharged to the outside of the reflective cylinder 9k, which can prevent the sputtered substance from adhering to the reflective surface 9ak of the reflective cylinder 9k and to the exit window 4k which is a part at low temperature.

Moreover, since the thermal radiation film 10k is formed on the longitudinal one end side of the outer wall surface 9bk of the reflective cylinder 9k, a portion at lower temperature than the surroundings and the enclosed gas can be formed inside the reflective cylinder 9k in close proximity to the luminescent part 202k, and the lower-temperature portion can capture the foreign matter such as sputtered substance from the luminescent cylinder 203Ak, so as to prevent the foreign matter from diffusing to the exit window 4k and prevent the reduction of optical transmittance caused thereby. Particularly, when the thermal radiation film 10k is formed in part of the outer wall surface 9bk near the luminescent cylinder 203Ak, the thermal emissivity on the one end side of the outer wall surface 9bk becomes larger than that on the other end side of the outer wall surface 9bk, and as a result, the sputtered substance becomes likely to be deposited on the side nearer the luminescent cylinder 203Ak side, i.e., at positions away from the exit window 4k, which further reduces contamination of the exit window 4k.

The present invention does not have to be limited to the above-described embodiments. For example, the reflective surface 9ak or 109ak was formed on the reflective cylinder 9k or 109k by polishing the inner wall of the metal members, but the reflective surface may be formed by evaporation or sputtering. Particularly, the reflective surface can be formed by preparing a base by cutting or molding of a metal member such as aluminum, or a member of glass, ceramic, or the like, polishing the base if necessary, and thereafter depositing an aluminum, rhodium, or dielectric multilayer film or the like on a mirror surface of the base by evaporation or sputtering. The reflective cylinder 9k or 109k was formed of a plurality of metal block members, but it may be formed as an integral body.

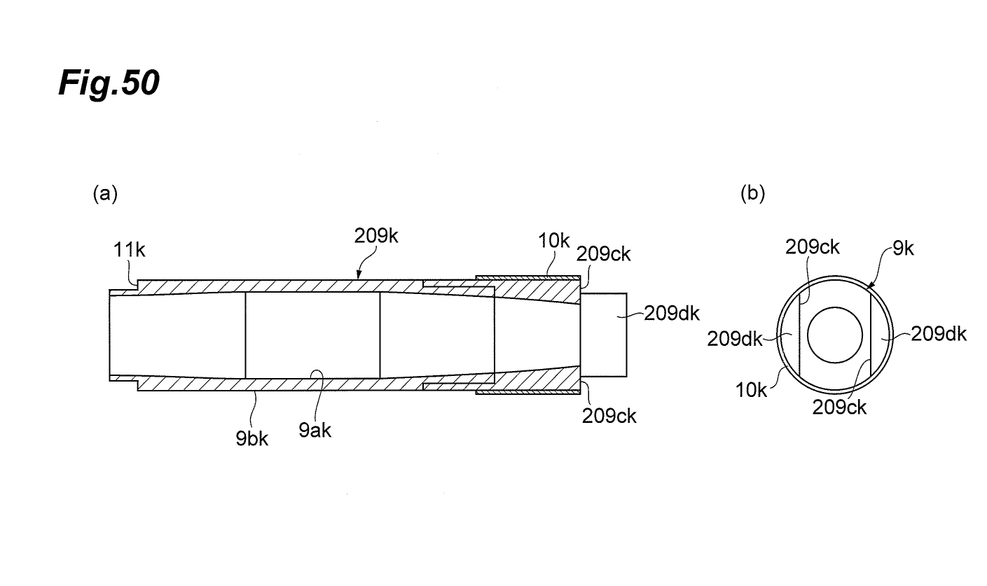

A variety of shapes can be adopted for the shapes of the apertures 9ck, 109ck and the projections 9dk, 109dk of the reflective cylinder 9k, 109k. For example, as in the case of the reflective cylinder 209k according to a modification example of the present invention shown in FIG. 50, it is possible to adopt a configuration wherein there are apertures 209ck formed at two locations along the peripheral edge on the one end side of the outer wall surface 9bk and projections 209dk formed at two locations so as to sandwich the apertures at the two locations in between.

In the foregoing embodiments, the reflective cylinder 9k or 109k was fixed by pressing it against the fixing member provided on the luminescent cylinder 3Ak or 203Ak side, but it may be fixed directly to the fixing member by laser welding, spot welding, or the like. In this case, if it is difficult to weld the reflective cylinder directly to the fixing member, it is possible to adopt a method of fixing a weldable structure to the reflective cylinder by engagement or the like and welding the structure to the fixing member. In the case of the laser welding, it is also possible to perform the welding through the glass member of the luminescent cylinder 3Ak, 203Ak.

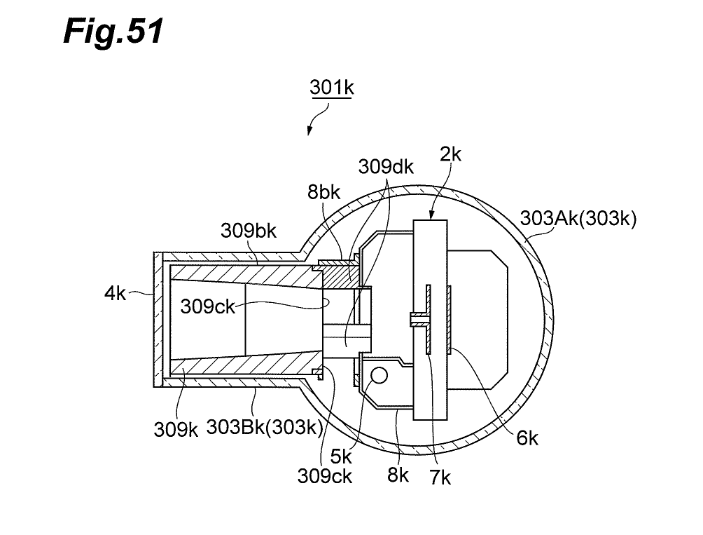

FIG. 51 shows a structure in which a reflective cylinder 309k comprised of metal members of two different materials is fixed to the housing case 8k of the luminescent part 2k by laser welding or spot welding, as a light source 301k which is a modification example of the present invention. Particularly, a fixing part of stainless steel with apertures 309Ck is forced onto and fixed to the end on the luminescent part 2k side of the main body part of the reflective cylinder 309k of aluminum and contact portions between the fixing part and the fixing ring 8bk of the housing case 8k are welded and secured to each other by laser welding or spot welding. In the light source 301k shown in the same drawing, the light guide cylinder 303Bk is set shorter, but the distribution of emitted light can also be parallel light or diverging light by designing the reflective cylinder 309k so as to match it, and the uniformity of light intensity can also be enhanced on the illumination target surface. Furthermore, as in the case of the light source 301k, projections 309dk of the reflective cylinder 309k may be arranged to extend into the housing case 8k so as to be located near the discharge path limiter 7k within the range not to impede the current of charged particles. In this configuration, the reflective cylinder 309k can capture the sputtered substance from the interior of the luminescent part 2k, whereby the sputtered substance can be prevented more from adhering to the exit window 4k as the low-temperature part. Furthermore, when the inner wall surface of the fixing part including the projections 309dk of the reflective cylinder 309k is formed to be a reflective surface, the light emitted from the luminescent part 2k can be guided to the exit window 4k, without loss.

A variety of shapes can be adopted for the structure for welding to be fixed to the one end side of the reflective cylinder 309k.

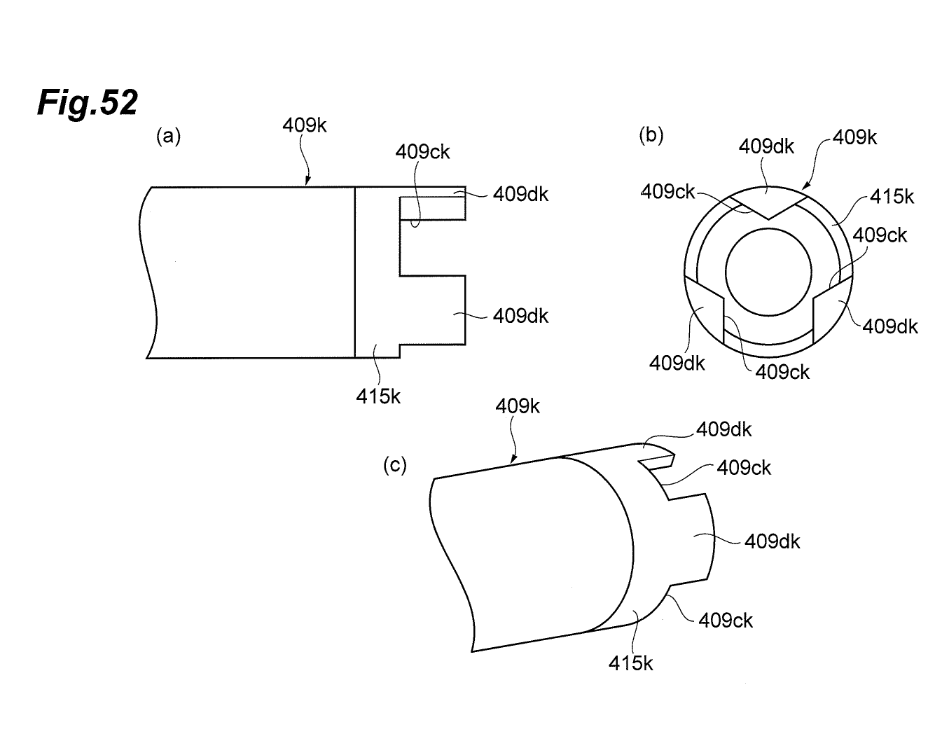

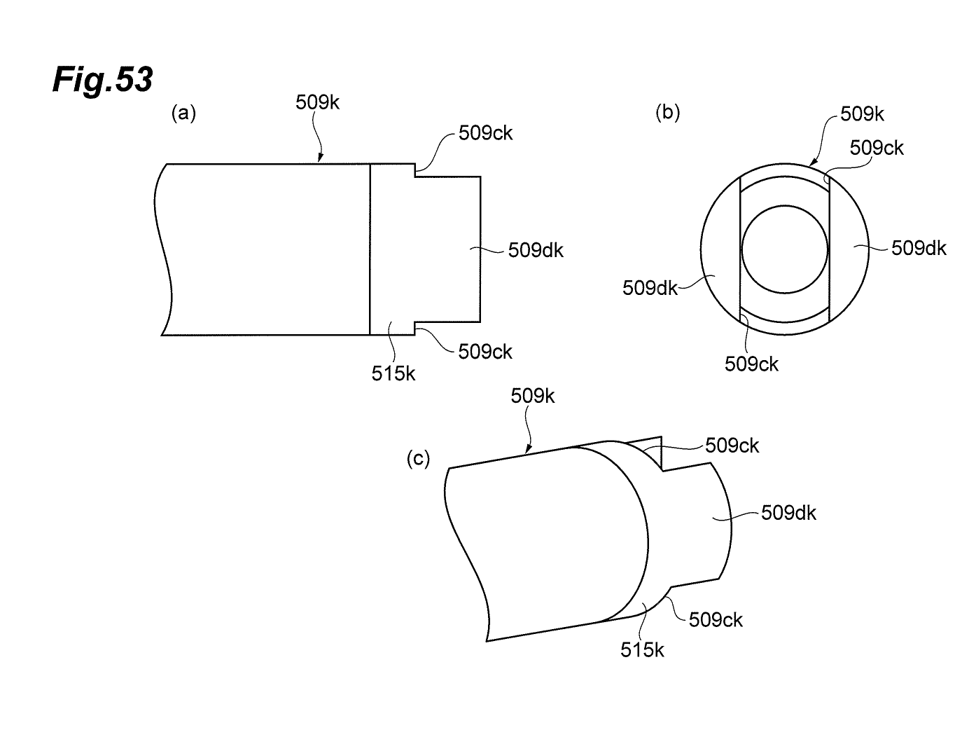

For example, FIGS. 52 and 53 show only metal block members as the fixing part to be welded and fixed directly to the fixing ring 8bk of the housing case 8k, out of the metal block members forming the reflective cylinder 309k in FIG. 51, as modification examples of the present invention. As in the case of reflective cylinders 409k, 509k shown in these drawings, the fixing part 415k of stainless steel with apertures 409ck and projections 409dk formed like the apertures 9ck and projections 9dk of the reflective cylinder 9k, or the fixing part 515k of stainless steel with apertures 509ck and projections 509dk formed like the apertures 209ck and projections 209dk of the reflective cylinder 209k can be forced onto and fixed to the main body part of the reflective cylinder 409k and it can be welded to the fixing ring 8bk of the housing case 8k.

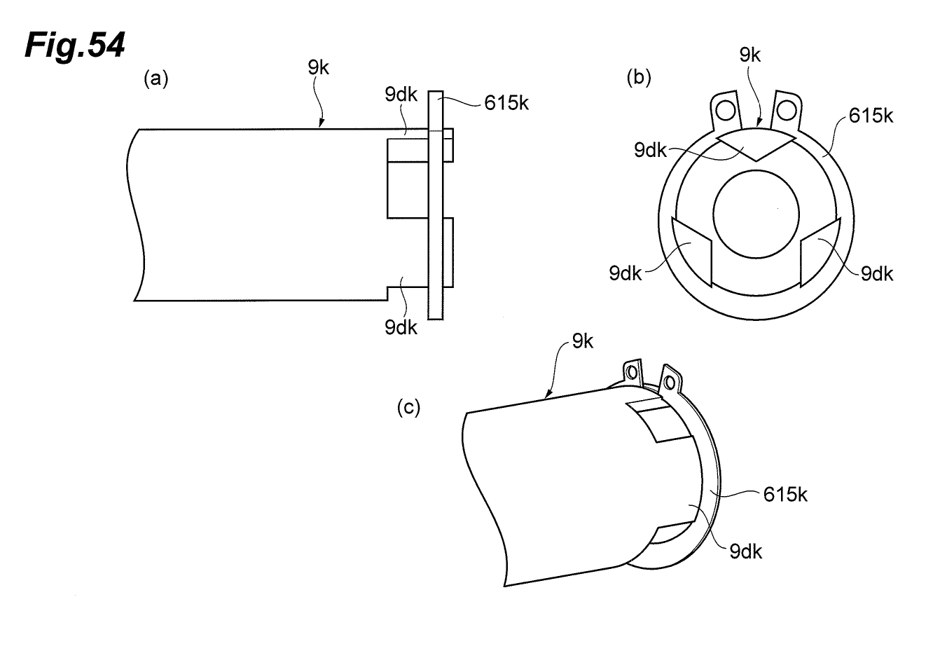

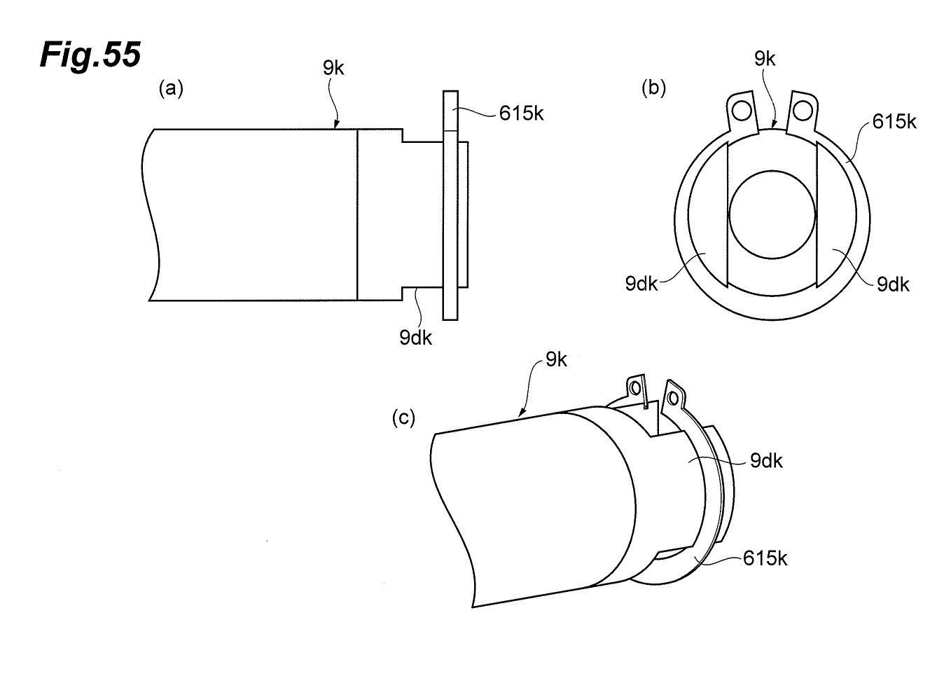

Moreover, as shown in FIGS. 54 and 55, the reflective cylinder 9k may be fixed to the luminescent part 2k by fixing a retaining ring 615k such as a stainless steel C-shaped retaining ring to the outer periphery at the tip of the projections 9dk of the reflective cylinder 9k so that the tip of the projections 9dk projects out, and welding the surface on the projection 9dk side of the retaining ring 615k to the fixing member for the reflective cylinder which is provided in the housing case 8k.

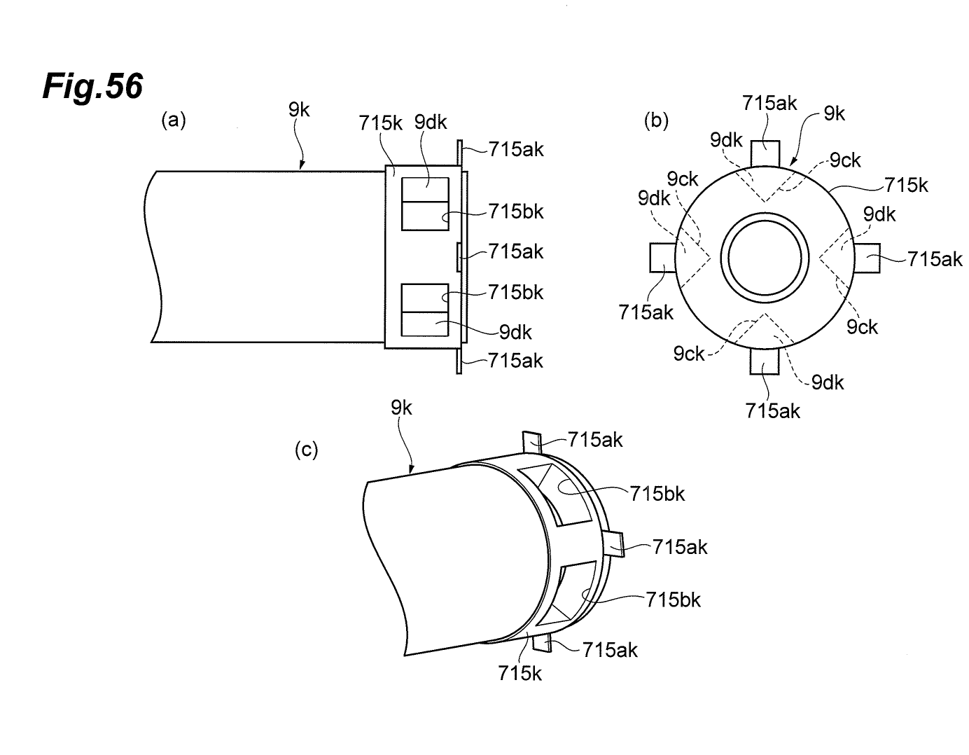

Furthermore, as shown in FIG. 56, it is also possible to adopt a configuration wherein a stainless steel sheet material 715k is wound in a belt shape around the outer periphery of the projections 9dk of the reflective cylinder 9k and their terminal ends are stacked and welded to be fixed. This sheet material 715k is provided with a plurality of flange portions 715ak extending perpendicularly to the central axis of the reflective cylinder 9k, on the tip side of the projections 9dk and the flange portions 715ak and the fixing member for the reflective cylinder in the housing case 8k are welded to fix the reflective cylinder 9k. It is also possible to fix the reflective cylinder 9k by welding proximate portions between the sheet material 715k and the fixing member for the reflective cylinder in the housing case 8k, without provision of the flange portions 715ak. This sheet material 715k is provided with a plurality of holes 715bk capable of discharging the sputtered substance, in alignment with the locations corresponding to the apertures 9ck.

The thermal radiation film 10k is formed in part or in whole of the outer wall surface 9bk or 109bk of the reflective cylinder 9k or 109k in the light source 1k, 101k, or 201k, but, conversely, a material with the thermal emissivity lower than that of the material of the reflective cylinder 9k or 109k may be formed on the other end side of the outer wall surface 9bk or 109bk. This configuration relatively enhances heat radiation on the one end side and is expected to provide the same effect as the thermal radiation film 10k. The material of the metal block member forming the one end side of the reflective cylinder 9k or 109k may be comprised of a material with the thermal emissivity larger than that of the material of the metal block member forming the other end side.

It is noted herein that the outer wall surface of the cylindrical member is preferably separated from the inner wall surface of the second housing. In this case, it is feasible to prevent the positional deviation of the cylindrical member and the breakage of the cylindrical member or the second housing, because of the difference of coefficients of thermal expansion between the cylindrical member and the second housing, whereby the extraction efficiency of light from the exit window can be improved on a stable basis.

The reflective surface on the first housing side of the cylindrical member is preferably formed in the taper shape. In this case, the reflection angles of the light on the reflective surface become large, so as to reduce the number of reflections, whereby the extraction efficiency of the light from the exit window can be improved on a stable basis.

It is also preferred to further provide the positioning member for positioning of the cylindrical member. With provision of this positioning member, the position of the cylindrical member becomes stabilized relative to the first housing and the second housing, whereby the extraction efficiency of the light from the exit window can be improved on a stable basis.

Another preferred configuration is such that the positioning member includes the spring member to urge the cylindrical member from the other end side toward the one end side of the second housing, and the fixing member against which the cylindrical member urged by the spring member is pressed. By adopting this configuration, the cylindrical member can be stably fixed relative to the first housing and the second housing, whereby the extraction efficiency of the light from the exit window can be improved on a stable basis.

Furthermore, still another preferred configuration is such that the positioning member is provided on the connection member connecting the first housing and the second housing. This configuration also allows the cylindrical member to be stably fixed relative to the first housing and the second housing, whereby the extraction efficiency of the light from the exit window can be improved on a stable basis.

Still another preferred configuration is as follows: the light source of the present invention further comprises the deuterium gas enclosed in the first housing and the second housing; the luminescent part has the cathode, the anode, and the discharge path limiter and generates light by discharge; the second housing is connected so as to be in communication with the first housing on the one end side; the cylindrical member is in contact with the luminescent part in the first housing on the one end side and is inserted in the second housing on the other end side; at least a part of the reflective surface of the cylindrical member is formed in the taper shape.

In the light source of this configuration, the discharge path limiter narrows the discharge caused between the cathode and the anode of the luminescent part in the first housing to generate light, and the light generated in the luminescent part is guided into the cylindrical member inserted from the exit window of the second housing in communication with the first housing to the luminescent part, to be emitted from the exit window. Since the reflective surface is formed on the inner wall surface of the cylindrical member herein, the light emitted from the luminescent part is guided from the one end side to the other end side of the second housing while being reflected by the reflective surface inside the cylindrical member, so that the light generated from the luminescent part can be guided to the exit window of the second housing, without loss. In addition, since at least a part of the reflective surface is formed in the taper shape, the light can be converged at the predetermined position outside the exit window. As a result, the generated light can be extracted efficiently.

The cylindrical member is preferably comprised of the metal material. With provision of this cylindrical member, it becomes easier to process the reflective surface with high mirror accuracy, and the generated light can be extracted more efficiently.

Another preferred configuration is such that the one end side and the other end side of the reflective surface of the cylindrical member are formed in the taper shape. In this case, the irradiation intensity of light can be further enhanced at the desired position and the generated light can be extracted more efficiently.

Another preferred configuration is such that the light source further comprises the spring member of the metal material to urge the cylindrical member from the other end side to the one end side of the second housing, and the fixing member in which the cylindrical member urged by the spring member is fitted, and which is provided so as to surround the aperture of the luminescent part. By adopting this configuration, the cylindrical member can be stably fixed relative to the first housing and the second housing, without deterioration due to the generated ultraviolet light. Furthermore, since the cylindrical member is fitted in the fixing member of the luminescent part, the light from the luminescent part is certainly guided into the cylindrical member, whereby the generated light can be extracted more efficiently.

Furthermore, another preferred configuration is such that the hole in which the end of the cylindrical member is inserted is formed in the luminescent part. With provision of the hole, the cylindrical member is arranged in closer proximity to the interior of the luminescent part, so that the generated light can be extracted more efficiently.

Furthermore, another preferred configuration is such that the aperture to penetrate to the reflective surface is formed in the side face on the one end side of the cylindrical member. This configuration allows the sputtered substance generated in the luminescent part to be discharged to the outside of the cylindrical member, whereby the sputtered substance can be prevented from adhering to the reflective surface of the cylindrical member and to the exit window. As a result, the generated light can be extracted more efficiently.

Another preferred configuration is such that the outer wall surface of the cylindrical member is comprised of the material with the thermal emissivity larger than that of the material of the cylindrical member. By adopting this configuration, the cylindrical member becomes likely to dissipate more heat, so as to further prevent the adhesion of the sputtered substance on the exit window, whereby the generated light can be extracted more efficiently. Furthermore, the thermal radiation film containing the material with the thermal emissivity larger than that of the material of the cylindrical member may be formed on the substantially entire area of the outer wall surface of the cylindrical member, and in this case, it is easy to enhance the thermal emissivity of the outer wall surface of the cylindrical member and the cylindrical member becomes more likely to dissipate heat; it can further prevent the adhesion of the sputtered substance on the exit window, whereby the generated light can be extracted more efficiently.

Another preferred configuration is such that the thermal emissivity on the one end side of the cylindrical member is larger than that on the other end side of the cylindrical member. By adopting this configuration, the sputtered substance can be captured on the portion closer to the luminescent part, so as to further prevent the adhesion of the sputtered substance on most of the reflective surface in the cylindrical member and on the exit window, whereby the generated light can be extracted more efficiently. Furthermore, the thermal radiation film containing the material with the thermal emissivity larger than that of the material of the outer wall surface on the other end side of the cylindrical member may be formed on the outer wall surface on the one end side of the cylindrical member, and in this case, it is easy to make the thermal emissivity of the outer wall surface on the one end side larger than that of the outer wall surface on the other end side and the sputtered substance can be captured on the portion closer to the luminescent part; therefore, it is feasible to further prevent the adhesion of the sputtered substance on most of the reflective surface in the cylindrical member and on the exit window, whereby the generated light can be extracted more efficiently.

Another preferred configuration is as follows: in the light source of the present invention, the luminescent part has the cathode and the anode with their respective apertures, and the capillary part arranged between the cathode and the anode, and generates light by discharge; the first housing holds the luminescent part inside so that the apertures of the cathode and the anode and the capillary part are coaxially arranged; the second housing is connected so as to be in communication with the first housing on the one end side; the cylindrical member is in contact with the cathode in the first housing on the one end side and is inserted in the second housing on the other end side; at least a part of the reflective surface of the cylindrical member is formed in the taper shape.

In the light source of this configuration, the capillary part narrows the discharge caused between the cathode and the anode of the luminescent part in the first housing to generate light, and the light emitted through the aperture of the cathode from the luminescent part is guided into the cylindrical member inserted from the exit window of the second housing in communication with the first housing to the luminescent part, to be emitted from the exit window. Since the reflective surface is formed on the inner wall surface of the cylindrical member herein, the light emitted from the luminescent part is guided from the one end side to the other end side of the second housing while being reflected by the reflective surface inside the cylindrical member, so that the light generated from the luminescent part can be guided to the exit window of the second housing, without loss. In addition, since at least a part of the reflective surface is formed in the taper shape, the light can be converged at the predetermined position outside the exit window. As a result, the generated light can be extracted more efficiently.

The cylindrical member is preferably comprised of the metal material. With provision of this cylindrical member, it becomes easier to process the reflective surface with high mirror accuracy and the light from the luminescent part can be effectively converged.

A preferred configuration is such that the one end side and the other end side of the reflective surface of the cylindrical member are formed in the taper shape. In this case, the irradiation intensity of light can be further enhanced at the desired position and the generated light can be efficiently extracted.

Furthermore, another preferred configuration is such that the light source further comprises the spring member to urge the cylindrical member from the other end side to the one end side of the second housing. By adopting this configuration, the cylindrical member can be stably fixed relative to the cathode. As a result, the light from the luminescent part is certainly guided to the interior of the cylindrical member and the generated light can be extracted more efficiently.

Still another preferred configuration is such that the hole in which the end of the cylindrical member is inserted is formed in the luminescent part. With provision of this hole, the cylindrical member is arranged in closer proximity to the interior of the luminescent part, whereby the generated light can be extracted more efficiently.

Furthermore, still another preferred configuration is such that the aperture to penetrate to the reflective surface is formed in the side face on the one end side of the cylindrical member. This allows the sputtered substance generated in the luminescent part to be discharged to the outside of the cylindrical member, so as to prevent the adhesion of the sputtered substance on the reflective surface of the cylindrical member and on the exit window. As a result, the generated light can be extracted more efficiently.

The outer wall surface of the cylindrical member is preferably comprised of the material with the thermal emissivity larger than that of the material of the cylindrical member. By adopting this configuration, the cylindrical member becomes likely to dissipate more heat, so as to further prevent the adhesion of the sputtered substance on the exit window, whereby the generated light can be extracted more efficiently. Furthermore, the thermal radiation film containing the material with the thermal emissivity larger than that of the material of the cylindrical member may be formed on the substantially entire area of the outer wall surface of the cylindrical member, and in this case, it is easy to enhance the thermal emissivity of the outer wall surface of the cylindrical member and the cylindrical member becomes more likely to dissipate heat; it can further prevent the adhesion of the sputtered substance on the exit window and the generated light can be extracted more efficiently.

Another preferred configuration is such that the thermal emissivity on the one end side of the cylindrical member is larger than that on the other end side of the cylindrical member. By adopting this configuration, the sputtered substance can be captured on the portion closer to the luminescent part, so as to further prevent the adhesion of the sputtered substance on most of the reflective surface in the cylindrical member and on the exit window, whereby the generated light can be extracted more efficiently. Furthermore, the thermal radiation film containing the material with the thermal emissivity larger than that of the material of the outer wall surface on the other end side of the cylindrical member may be formed on the outer wall surface on the one end side of the cylindrical member, and in this case, it is easy to make the thermal emissivity of the outer wall surface on the one end side larger than that of the outer wall surface on the other end side, and the sputtered substance can be captured on the portion closer to the luminescent part, so as to further prevent the adhesion of the sputtered substance on most of the reflective surface in the cylindrical member and on the exit window, whereby the generated light can be extracted more efficiently.

Still another preferred configuration is as follows: in the light source of the present invention, the luminescent part generates light by discharge; the second housing is connected so as to be in communication with the first housing on the one end side; the cylindrical member is in contact with the luminescent part in the first housing on the one end side and is inserted in the second housing on the other end side; the aperture to penetrate to the reflective surface is formed in the side face on the one end side of the cylindrical member.

In the light source of this configuration, the light generated from the luminescent part in the first housing is guided into the cylindrical member inserted from the interior of the second housing in communication with the first housing to the luminescent part, so as to be emitted from the exit window provided in the second housing. Since the reflective surface is formed on the inner wall surface of the cylindrical member herein, the light emitted from the luminescent part is guided from the one end side to the other end side of the second housing while being reflected by the reflective surface inside the cylindrical member, so that the light generated from the luminescent part can be guided to the exit window of the second housing, without loss. In addition, since the aperture is formed in the side face on the one end side of the cylindrical member, the sputtered substance generated in the luminescent part can be discharged to the outside of the cylindrical member, so as to prevent the adhesion of the sputtered substance on the reflective surface of the cylindrical member and on the exit window. As a result, the extraction efficiency of light from the exit window can be improved while achieving extension of service life.

The aperture of the cylindrical member is preferably arranged in the first housing. In this case, the sputtered substance generated in the luminescent part is discharged to the interior of the first housing, so as to further prevent scattering thereof to the exit window, whereby the service life can be further extended.

The aperture of the cylindrical member is also preferably formed by cutting the edge region on the one end side of the cylindrical member. With provision of this aperture, the sputtered substance can be discharged in the portion closer to the luminescent part, so as to further prevent the adhesion of the sputtered substance on most of the reflective surface in the cylindrical member and on the exit window, whereby the service life can be further extended.

Another preferred configuration is such that a plurality of apertures are formed at equal intervals along the peripheral edge on the one end side of the cylindrical member. By adopting this configuration, the sputtered substance can be efficiently discharged, so as to further prevent the scattering thereof to the exit window, whereby the service life can be further extended.

Another preferred configuration is such that the outer wall surface of the cylindrical member is comprised of the material with the thermal emissivity larger than that of the material of the cylindrical member. By adopting this configuration, the cylindrical member becomes likely to dissipate more heat, so as to further prevent the adhesion of the sputtered substance on the exit window, whereby the service life can be further extended. Furthermore, the thermal radiation film containing the material with the thermal emissivity larger than that of the material of the cylindrical member may be formed on the substantially entire area of the outer wall surface of the cylindrical member, and in this case, it is easy to enhance the thermal emissivity of the outer wall surface of the cylindrical member, and the cylindrical member becomes more likely to dissipate heat, so as to further prevent the adhesion of the sputtered substance on the exit window, whereby the service life can be further extended.

Another preferred configuration is such that the thermal emissivity on the one end side of the cylindrical member is larger than that on the other end side of the cylindrical member. By adopting this configuration, the sputtered substance can be captured on the portion closer to the luminescent part, so as to further prevent the adhesion of the sputtered substance on most of the reflective surface in the cylindrical member and on the exit window, whereby the service life can be further extended. Furthermore, the thermal radiation film containing the material with the thermal emissivity larger than that of the material of the outer wall surface on the other end side of the cylindrical member may be formed on the outer wall surface on the one end side of the cylindrical member, and in this case, it is easy to make the thermal emissivity of the outer wall surface on the one end side larger than that of the outer wall surface on the other end side, and the sputtered substance can be captured on the portion closer to the luminescent part, so as to further prevent the adhesion of the sputtered substance on most of the reflective surface in the cylindrical member and on the exit window, whereby the service life can be further extended.

### INDUSTRIAL APPLICABILITY

The present invention is applicable to the light sources to emit light generated inside, with stable improvement in extraction efficiency of light from the exit window.

### LIST OF REFERENCE SIGNS

1, 101, 201, 301, 401, 501, 601, 701 light source; 2, 202, 302 luminescent part; 3A, 203A, 303A, 403A, 503A, 603A, 703A luminescent cylinder (first housing); 3B, 203B, 303B, 403B, 503B, 603B, 703B light guide cylinder (second housing); 8b, 205A, 308A, 408A, 508B fixing ring member (positioning member or fixing member); 9, 109, 609 reflective cylinder (metal member); 9a, 609a reflective surface; 9b, 109b, 609b outer wall surface; 12 spring member (positioning member); 13 inner wall surface; 112 metal band (positioning member);
1i, 101i, 201i, 301i, 401i, 501i deuterium lamp; 2i, 202i luminescent part; 3Ai, 303Ai, 403Ai luminescent cylinder (first housing); 3Bi, 303Bi, 403Bi light guide cylinder (second housing); 4i exit window; 5i cathode; 6i anode; 7i discharge path limiter; 8ai light passage port; 8bi fixing ring (fixing member); 208bi claws (fixing member); 9i, 109i, 309i reflective cylinder (cylindrical member); 9ai, 109ai reflective surface; 9bi, 109bi outer wall surface (side face); 9ci apertures; 10i thermal radiation film; 12i, 112i spring member; 308ei hole;
1j, 101j light source; 2j luminescent part; 3Aj luminescent cylinder (first housing); 3Bj light guide cylinder (second housing); 4j exit window; 5j cathode; 6j anode; 5aj, 6aj apertures; 7j capillary part; 9j, 109j, 209j, 309j reflective cylinder (cylindrical member); 9aj, 109aj reflective surface; 9bj, 109bj outer wall surface (side face); 9cj, 109cj, 209cj, 309cj apertures; 10j thermal radiation film; 12j, 112j, 112aj spring member; X optical axis;
1k, 101k, 201k, 301k light source; 2k, 202k luminescent part; 3Ak, 203Ak, 303Ak luminescent cylinder (first housing); 3Bk, 203Bk, 303Bk light guide cylinder (second housing); 4k exit window; 9k, 109k, 209k, 309k, 409k, 509k reflective cylinder (cylindrical member); 9ak, 109ak reflective surface; 9bk, 109bk outer wall surface (side face); 9ck, 109ck, 209ck, 309ck, 409ck, 509ck apertures; 10k thermal radiation film.

1. A light source comprising:
a first housing which houses a luminescent part to generate light;
a second housing which is connected to the first housing on a one end side and configured to guide the light generated from the luminescent part, to an exit window provided on the other end side; and
a cylindrical member which is inserted and fixed between the exit window of the second housing and a portion connecting the first housing and the second housing, and which has an inner wall surface formed as a reflective surface to reflect the light.

2. The light source according to claim 1, wherein an outer wall surface of the cylindrical member is separated from an inner wall surface of the second housing.

3. The light source according to claim 1 2, wherein the reflective surface on the first housing side of the cylindrical member is formed in a taper shape.

4. The light source according to claim 1, further comprising a positioning member for positioning of the cylindrical member.

5. The light source according to claim 4, wherein the positioning member includes:
a spring member which urges the cylindrical member from the other end side to the one end side of the second housing; and
a fixing member against which the cylindrical member urged by the spring member is pressed.

6. The light source according to claim 4, wherein the positioning member is provided on a connection member connecting the first housing and the second housing.

7. The light source according to claim 1, further comprising a deuterium gas enclosed in the first housing and the second housing,
wherein the luminescent part has a cathode, an anode, and a discharge path limiter and generates light by discharge,
wherein the second housing is connected so as to be in communication with the first housing on the one end side,
wherein the cylindrical member is in contact with the luminescent part in the first housing on the one end side and is inserted in the second housing on the other end side, and
wherein at least a part of the reflective surface of the cylindrical member is formed in a taper shape.

8. The light source according to claim 7, wherein the cylindrical member is comprised of a metal material.

9. The light source according to claim 7, wherein the one end side and the other end side of the reflective surface of the cylindrical member are formed in a taper shape.

10. The light source according to claim 7, further comprising:
a spring member of a metal material which urges the cylindrical member from the other end side to the one end side of the second housing; and
a fixing member in which the cylindrical member urged by the spring member is fitted, and which is provided so as to surround an aperture of the luminescent part.

11. The light source according to claim 7, wherein a hole in which an end of the cylindrical member is inserted is formed in the luminescent part.

12. The light source according to claim 7, wherein an aperture to penetrate to the reflective surface is formed in a side face on the one end side of the cylindrical member.

13. The light source according to claim 7, wherein an outer wall surface of the cylindrical member is comprised of a material with a thermal emissivity larger than that of a material of the cylindrical member.

14. The light source according to claim 13, wherein a thermal radiation film containing the material with the thermal emissivity larger than that of the material of the cylindrical member is formed on a substantially entire area of the outer wall surface of the cylindrical member.

15. The light source according to claim 7, wherein a thermal emissivity on the one end side of the cylindrical member is larger than a thermal emissivity on the other end side of the cylindrical member.

16. The light source according to claim 15, wherein a thermal radiation film containing a material with the thermal emissivity larger than that of a material of the outer wall surface on the other end side of the cylindrical member is formed on the outer wall surface on the one end side of the cylindrical member.

17. The light source according to claim 1, wherein the luminescent part has a cathode and an anode with their respective apertures, and a capillary part arranged between the cathode and the anode, and generates light by discharge,
wherein the first housing holds the luminescent part inside so that the apertures of the cathode and the anode and the capillary part are coaxially arranged,
wherein the second housing is connected so as to be in communication with the first housing on the one end side,
wherein the cylindrical member is in contact with the cathode in the first housing on the one end side and is inserted in the second housing on the other end side, and
wherein at least a part of the reflective surface of the cylindrical member is formed in a taper shape.

18. The light source according to claim 17, wherein the cylindrical member is comprised of a metal material.

19. The light source according to claim 17, wherein the one end side and the other end side of the reflective surface of the cylindrical member are formed in a taper shape.

20. The light source according to claim 17, further comprising a spring member to urge the cylindrical member from the other end side to the one end side of the second housing.

21. The light source according to claim 17, wherein a hole in which an end of the cylindrical member is inserted is formed in the luminescent part.

22. The light source according to claim 17, wherein an aperture to penetrate to the reflective surface is formed in a side face on the one end side of the cylindrical member.

23. The light source according to claim 17, wherein an outer wall surface of the cylindrical member is comprised of a material with a thermal emissivity larger than that of a material of the cylindrical member.

24. The light source according to claim 23, wherein a thermal radiation film containing the material with the thermal emissivity larger than that of the material of the cylindrical member is formed in a substantially entire area of the outer wall surface of the cylindrical member.

25. The light source according to claim 17, wherein a thermal emissivity on the one end side of the cylindrical member is larger than a thermal emissivity on the other end side of the cylindrical member.

26. The light source according to claim 25, wherein a thermal radiation film containing a material with the thermal emissivity larger than that of a material of an outer wall surface on the other end side of the cylindrical member is formed on the outer wall surface on the one end side of the cylindrical member.

27. The light source according to claim 1, wherein the luminescent part generates light by discharge,
wherein the second housing is connected so as to be in communication with the first housing on the one end side,
wherein the cylindrical member is in contact with the luminescent part in the first housing on the one end side and is inserted in the second housing on the other end side, and
wherein an aperture to penetrate to the reflective surface is formed in a side face on the one end side of the cylindrical member.

28. The light source according to claim 27, wherein the aperture of the cylindrical member is arranged in the first housing.

29. The light source according to claim 27, wherein the aperture of the cylindrical member is formed by cutting an edge region on the one end side of the cylindrical member.

30. The light source according to claim 27, wherein a plurality of said apertures are formed at equal intervals along a peripheral edge on the one end side of the cylindrical member.

31. The light source according to claim 27, wherein an outer wall surface of the cylindrical member is comprised of a material with a thermal emissivity larger than that of a material of the cylindrical member.

32. The light source according to claim 31, wherein a thermal radiation film containing the material with the thermal emissivity larger than that of the material of the cylindrical member is formed in a substantially entire area of the outer wall surface of the cylindrical member.

33. The light source according to claim 27, wherein a thermal emissivity on the one end side of the cylindrical member is larger than a thermal emissivity on the other end side of the cylindrical member.

34. The light source according to claim 33, wherein a thermal radiation film containing a material with the thermal emissivity larger than that of a material of an outer wall surface on the other end side of the cylindrical member is formed on the outer wall surface on the one end side of the cylindrical member.
